(19) United States
(12) Patent Application Publication
(10) Pub. No.: US 2026/0208479 A1
(43) Pub. Date: Jul. 23, 2026

(54) PRINTER AND ASSOCIATED METHOD

(71) Applicant: VIDEOJET TECHNOLOGIES INC., Wood Dale, IL (US)

(72) Inventors: David Andrew Horsnell, Cambridgeshire (GB); Samuel Lorenz, Cambridgeshire (GB); Robert Smith, Cambridgeshire (GB)

(21) Appl. No.: 19/138,883

(22) PCT Filed: Dec. 14, 2023
(86) PCT No.: PCT/GB2023/053246

§ 371 Date: Jun. 13, 2025

(30) Foreign Application Priority Data
Dec. 15, 2022 (GB) 2218971.6

(51) Int. Cl. B41J 2/02; B41J 2/09; B41J 2/125; B41J 2/185

(52) U.S. Cl. CPC B41J 2/02; B41J 2/09; B41J 2/125; B41J 2/185; B41J 2002/1853

(57) ABSTRACT

A sealing mechanism for sealing a print head of a continuous inkjet printer is disclosed. The sealing mechanism comprises a rotatable body and a casing. The rotatable body is rotatable about an axis of rotation between a first configuration and a second configuration. The casing defines an ink aperture. In the first configuration, an ink path is defined across the rotatable body through the ink aperture. In the second configuration, the rotatable body closes the ink aperture.

The present invention relates to a sealing mechanism for a print head of a continuous inkjet (CIJ) printer, a self-cleaning print head for a continuous inkjet printer, a continuous inkjet printer, a cap assembly for a print head of a CIJ printer, a modular print head for a CIJ printer, and associated methods.

In inkjet printing systems, the print is made up of individual droplets of ink generated at a nozzle and propelled towards a substrate. There are two principal systems: droplet on demand, where ink droplets for printing are generated as and when required; and continuous inkjet (CIJ) printing, in which droplets are continuously produced and only selected ones are directed towards the substrate, the others being recirculated to an ink system.

CIJ printers supply pressurised ink to a print head droplet generator where a continuous stream of ink emanating from a nozzle is broken up into individual regular droplets by, for example, an oscillating piezoelectric element. The droplets are directed past a charge electrode, where they are selectively and separately given a predetermined charge, before passing through a transverse electric field provided across a pair of deflection plates, the pair comprising a high voltage (or extra high tension (EHT)) plate and a zero or negative voltage plate (the ‘ground’ plate). Each charged droplet is deflected by the field by an amount that is dependent on its charge magnitude before impinging on the substrate, whereas the uncharged droplets proceed without deflection and are collected at a gutter from where they are recirculated to the ink system. The charged droplets bypass the gutter and hit the substrate at a position determined by the charge on the droplet and the position of the substrate relative to the print head. Typically the substrate is moved relative to the print head in one direction and the droplets are deflected in a direction generally perpendicular thereto, although the deflection plates may be oriented at an inclination to the perpendicular to compensate for the speed of the substrate (the movement of the substrate relative to the print head between droplets arriving means that a line of droplets would otherwise not quite extend perpendicularly to the direction of movement of the substrate). The various components of the print head are typically contained within a cover tube or print head casing.

In CIJ printing, a character is printed from a matrix comprising a regular array of potential droplet positions. Each matrix comprises a plurality of columns (strokes), each being defined by a line comprising a plurality of potential droplet positions (e.g. seven) determined by the charge applied to the droplets. Thus, each usable droplet is charged according to its intended position in the stroke. If a particular droplet is not to be used then the droplet is not charged and it is captured at the gutter for recirculation. This cycle repeats for all strokes in a matrix and then starts again for the next character matrix.

Ink is delivered under pressure to the print head by an ink system that is generally housed within a sealed compartment of a cabinet that includes a separate compartment for control circuitry and a user interface panel. The ink system includes a main pump that draws the ink from a reservoir or tank (often referred to as a mixing tank) via a filter and delivers it under pressure to the print head. As ink is consumed, the reservoir is refilled as necessary from a replaceable ink cartridge that is releasably connected to the reservoir by a supply conduit. The ink is fed from the reservoir via a flexible delivery conduit to the print head. The unused ink droplets captured by the gutter are recirculated to the reservoir via a return conduit by a pump. The flow of ink in each of the conduits is generally controlled by solenoid valves and/or other like components.

As the ink circulates through the system, there is a tendency for it to thicken because of solvent evaporation, particularly in relation to the recirculated ink that has been exposed to air in its passage between the nozzle and the gutter. In order to compensate for this, “make-up” solvent is added to the ink as required from a replaceable solvent cartridge to maintain the ink viscosity within desired limits. The ink and solvent cartridges are filled with a predetermined quantity of fluid and generally releasably connected to the reservoir, or mixing tank, of the ink supply system so that the reservoir can be intermittently topped-up by drawing ink and/or solvent from the cartridges as required.

CIJ printers generally operate in high throughput environments for which the printers, and inks, need to be able to keep up with high production line speeds, fast drying time requirements and virtually non-stop production.

A problem faced by operators of existing continuous inkjet printers is that of undesirable build-up of deposits within, and around, the print head. Deposits include ink ‘fur’, created by ink pigment which remains after the fluid component of the ink (and solvent mixture) has evaporated. Such deposits risk the accuracy of printing, the operation of the print head, and, in extreme circumstances, may result in the blocking of an ink ejection aperture of the print head (e.g. rendering the print head non-operational for at least a period of time). Presently, the print head must manually cleaned, sometimes requiring at least partial disassembly of the print head, to remove the aforementioned deposits. This is undesirable for reasons of complexity, operator intervention, print head downtime and the quality of the cleaning.

There exists a need to provide an alternative continuous inkjet (CIJ) printer that overcomes one or more of the disadvantages of known systems, whether mentioned in this document or otherwise.

According to a first aspect of the invention there is provided a sealing mechanism for a print head of a continuous inkjet printer, comprising:
a rotatable body rotatable about an axis of rotation between a first configuration and a second configuration; and
a casing defining an ink aperture;
wherein:
in the first configuration, an ink path is defined across the rotatable body through the ink aperture; and
in the second configuration, the rotatable body closes the ink aperture.

The sealing mechanism may otherwise be described as a shutter mechanism. The rotatable body may be described as a rotor. The rotatable body may be described as a shutter. The sealing mechanism may be for sealing an internal chamber of a print head of a continuous inkjet printer

The casing may otherwise be described as a housing. The casing may define an outer geometry of the print head itself in some embodiments, or may be substantially enclosed by other components when installed as part of a print head. The ink aperture may form part of an ink channel, such as an ink slot.

In the first configuration, the rotatable body may be said to open the ink aperture. The rotatable body may be configured to open the ink aperture. The first configuration may be described as an open configuration. The ink path defined across the rotatable body may be by way of the rotatable body comprising a recess, or a geometry of the rotatable body, such that rotation of the rotatable body changes the footprint of the rotatable body with respect to the ink aperture. The ink aperture may be upstream of the rotatable body or may be downstream of the rotatable body, or a combination of the two. It will be appreciated that there may exist part of a casing and/or housing, defining an ink aperture, further downstream of the rotatable body.

In the second configuration the rotatable body closing the ink aperture may otherwise be described as the rotatable body preventing an ink path being defined across the rotatable body through the ink aperture. The first and second configurations of the rotatable body may differ from one another by around 90°.

The ink aperture is preferably an external ink aperture. Put another way, ink droplets may pass through the ink aperture as they exit (e.g. are ejected from) the print head. Described another way, the ink aperture may be defined in, or define part of, an exterior of the print head. The rotatable body, which closes the ink aperture, may be described as an external component. Put another way, the rotatable body may define at least part of an exterior of the print head (at least in the second configuration).

Advantageously, incorporation of the sealing mechanism in a print head facilitates the sealed washing and drying of the print head. Specifically, incorporation of the sealing mechanism facilitates the sealed washing and drying of a chamber within the print head. The sealing mechanism can therefore be used as part of a self-cleaning print head in which the build-up of ink fur and other debris can be intermittently removed by operation of a cleaning and drying cycle. Furthermore, this can be achieved without needing to remove the print head from a printing or production line, and without having to place the print head in a cleaning station. The invention therefore overcomes the disadvantages associated with known cleaning methods including: production downtime, required operator skill and training, the cost of handling hazardous fluids, the cost of safety precautions and time to prepare the necessary personal protective equipment, the cost of any cleaning fluids used which are not recycled and are discarded, and the cost of hazardous waste disposal. The invention thus: reduces downtime, avoids the need for the print head to be removed from a printing or production line, does not require a skilled operator, provides consistent and repeatable results, avoids the need to handle any hazardous waste owing to the washing fluids being recycled back into the ink system, and reduces environmental impact and running costs.

The rotatable body may comprise a recess which, in the first configuration, overlaps the ink aperture to define the ink path.

The recess may extend along at least part of an extent of the rotatable body. For example, the rotatable body may be generally cylindrical and the recess may extend along a portion of the rotatable body to define a minor segment across the rotatable body.

The recess overlapping the ink aperture in the first configuration may otherwise be described as the ink path being able to extend through the recess and through the ink aperture. Described another way, the recess and ink aperture cooperate to define an ink path.

Advantageously, providing a recess in the rotatable body provides a convenient means of being able to open and close the rotatable body to open or close the sealing mechanism.

The recess may be a slot which extends through the rotatable body.

The slot may be referred to as an ink slot. The slot may extend through the rotatable body in a diametric manner. Described another way, the slot may extend from one side of the rotatable body to another.

Advantageously, where the recess is a slot, the robustness of the rotatable body is maintained in that material extends on either side of the slot. The risk of the rotatable body becoming damaged in use is therefore reduced as a result.

In the second configuration the rotatable body may seal the ink aperture.

The rotatable body sealing the ink aperture is intended to encompass the prevention of any fluid escaping through the ink aperture. The rotatable body may thus be said to define part of the chamber which is sealed when the rotatable body is in the second configuration.

The rotatable body may be generally cylindrical.

The rotatable body being generally cylindrical is intended to encompass the rotatable body having a major dimension which is consistent diametrically across the rotatable body. The rotatable body may be generally cylindrical while still comprising a recess.

The casing may comprise an end cap.

End cap is intended to encompass a longitudinally outermost component of the print head. The end cap may thus define the last component through which ink droplets pass before they exit the print head. The casing may be an end cap. The casing may comprise an end cap. Where the casing comprises an end cap, the casing may also comprise other discrete components which are coupled to the end cap. The casing may be described as a fixed casing insofar as it does not move in operation. The rotatable body may thus rotate with respect to the casing, and specifically the end cap.

The casing may comprise a polymer casing. The sealing mechanism may further comprise a conductive end cap receivable over at least part of the casing, the end cap defining an aperture which extends around the ink aperture. The end cap may be grounded.

The rotatable body may comprise an end cap.

The end cap may be described as a rotatable end cap. The end cap may be described as moveable. The arrangement may be described as a rotating keyhole cover. The end cap may comprise an ink aperture. The axis of rotation may be generally parallel to the ink path. The axis of rotation may be generally parallel to a longitudinal extent of the print head.

In the first configuration the ink aperture of the end cap may at least partly overlap the ink aperture of the casing to define the ink path. In the first configuration the ink aperture of the end cap may entirely overlap the ink aperture of the casing, to define the ink path, such that the ink aperture of the casing is entirely open.

In the second configuration, the end cap may cover, or overlap, the ink aperture of the casing to close the ink aperture of the casing.

Rotation of the end cap may provide a sealing effect between the end cap and an adjacent component (e.g. a chamber housing). Sealing may be affected by a threaded engagement between the end cap and the adjacent component (e.g. a chamber housing).

The ink aperture may be an ink slot.

The ink aperture being an ink slot is intended to encompass a lozenge-shaped ink aperture. The ink aperture may be defined by an end cap where the casing comprises an end cap. Alternatively, the ink aperture may be entirely defined by a non-end cap casing.

The sealing mechanism may further comprise a sealing collar.

The sealing collar may otherwise be described as a sealing interface. The casing or rotatable body may be said to comprise a sealing interface. The sealing interface may be manufactured from a different material to that of one or more of the rotatable body and the casing. The sealing interface is preferably manufactured from a polymer such as PTFE or PCTFE. The sealing collar is intended to refer to a discrete component which is received in a recess, or seat, in the casing where the rotatable body is received. The sealing collar thus interposes the rotatable body and the casing.

Advantageously, the incorporation of a sealing collar reduces the risk of leakage across the sealing mechanism, specifically the rotatable body thereof. The sealing collar may also assist with reducing issues associated with the different coefficients of thermal expansion of the rotatable body and surrounding casing where they are not manufactured from the same component. The sealing collar can also assist with the easy running of the rotatable body with respect to the casing.

The sealing collar may be manufactured from a different material than the casing.

The sealing collar may be PTFE. The rotatable body may be manufactured from stainless steel. The casing may be manufactured from stainless steel. The rotatable body and the casing may be manufactured from the same material. Alternatively, the rotatable body and the casing may be manufactured from different materials. One or more of the rotatable body and the casing may be manufactured from a polymer such as PTFE.

The sealing collar being manufactured from a different material than the casing means that both the casing and rotatable body can be manufactured from the same material, reducing the risk of leakage due to different coefficients of thermal expansion of different materials, whilst still providing an easy running sealing interface, by way of the collar, which reduces the risk of stiction of the sealing mechanism in use.

The axis of rotation may be generally perpendicular to the ink path.

The axis of rotation may otherwise be described as a rotatable body axis. The axis of rotation being generally perpendicular to the ink path is advantageous for at least the reason of avoiding unduly reducing the throw distance between an end of the print head and the substrate to be printed. Described another way, the rotation of the rotatable body is in a direction which means the sealing mechanism can be incorporated in the print head without significantly reducing throw distance between the end of the print head and the substrate to be printed. The axis of rotation being generally perpendicular to the ink path is thus advantageous in providing a more compact self-cleaning print head.

It will be appreciated that the angle of the axis of rotation, with respect to the ink path, could change dependent upon the orientation of the rotatable body and/or any gearing mechanism used to drive the rotatable body.

The rotatable body may be rotatably coupled to a gear.

The gear may be a gear of a worm gear. The rotatable body may be coupled to the gear by way of another component or it may be directly coupled to the gear. The gear may be integrally formed with the rotatable body.

Advantageously, incorporation of a rotatably coupled gear to the rotatable body provides a convenient drive mechanism by which the rotatable body can be rotated between the first and second configurations.

The rotatable body may be rotatably coupled to a segmented gear, the segmented gear comprising a non-toothed portion extending between first and second end stops.

A gutter may be rotatably coupled to the rotatable body.

The gutter being rotatably coupled to the rotatable body may otherwise be described as the gutter rotating with the rotatable body.

By having the gutter rotatably coupled to the rotatable body, a loss of throw distance can be reduced or eliminated entirely. Rotatably coupling the gutter to the rotatable body thus provides a more compact print head. In other embodiments, the gutter may be fixed in position (e.g. not movable).

The first and second ports (and third port, if present) of the chamber may also define separate ports to the nozzle. Put another way, in preferred embodiments the nozzle and gutter are separate to the first and second (and third, if appropriate) ports of the chamber.

The gutter may be integrally formed with the rotatable body.

The gutter being integrally formed with the rotatable body may otherwise be described as the rotatable body comprising a gutter (e.g. a gutter aperture). The rotatable body may further comprise at least part of a gutter conduit which extends from the gutter aperture. The gutter conduit may extend through at least part of an axial extent of the rotatable body such that a conduit be defined through the rotatable body.

Advantageously, integrally forming the gutter with the rotatable body reduces the loss of throw distance of the print head.

A gutter conduit, in fluid communication with the gutter, may extend at least partway through the rotatable body.

The gutter conduit may otherwise be described as a channel. The gutter conduit may specifically be in fluid communication with the gutter aperture. The gutter conduit may extend at least partway through the rotatable body so that ink droplets which are not to be used for printing, and which are received by the gutter, pass through the rotatable body via the gutter conduit.

The sealing mechanism may further comprise a rotation limiting feature.

The rotation limiting feature may take the form of a pin and slot arrangement. The pin may be fixed with respect to the casing. The slot may be defined in the rotatable body. The pin may be received in the slot such that the rotatable body can rotate about the axis of rotation by a rotational extent defined by the travel of the pin within the slot. The rotation limiting feature may be electromechanical in that it produces a signal indicative of the rotational position of the rotatable body. This may be referred to as an integrated position sensor.

Advantageously, incorporating such rotational limiting features can be used to reduce the risk that the rotatable body contact, and displace, the gutter, and more specifically the gutter aperture. Where the rotation limiting feature is electromechanical, it advantageously improves reliability of the sealing mechanism by providing feedback to the controller to indicate whether the rotatable body is in the first or second configurations. Cost can also be reduced by making the rotation limiting feature multipurpose.

The sealing mechanism may further comprise a sensor.

The sensor may be configured to detect the rotational position of the rotatable body. The sensor may be one or more of a magnetic, optical or pressure sensor, or a potentiometer. Motor current may also be monitored to ascertain when/if the motor/rotatable body is stuck. The motor may be overdriven for short periods of time in an effort to unstick the motor and/or rotatable body. An extended cleaning cycle may be used in an effort to free a stuck rotatable body.

The sensor advantageously improves reliability of the sealing mechanism by providing feedback to the controller to indicate whether the rotatable body is in the first or second configurations.

According to a second aspect of the invention there is provided a self-cleaning print head for a continuous inkjet printer, comprising:
a chamber selectively sealable by a rotatable body rotatable about an axis of rotation between a first configuration and a second configuration;
a casing defining an ink aperture, the casing at least partly defining the chamber;
a nozzle for generating and ejecting a stream of ink droplets for printing;
at least one electrode for guiding the stream of ink droplets; and
a gutter for receiving droplets of ink which are not used for printing;
   wherein
the at least one electrode is disposed in the chamber; and
in a first configuration, an ink path for the stream of droplets for printing is defined through the chamber, across the rotatable body and through the ink aperture such that the chamber is in communication with atmosphere via at least the ink aperture; and
in the second configuration the rotatable body closes the ink aperture such that the chamber is sealed by the rotatable body.

Self-cleaning print head is intended to encompass a print head which can be cleaned without the need to remove the print head from a production line or place the print head at a cleaning or waste station or similar. Self-cleaning print head therefore encompass a print head which can undergo a cleaning, and optionally a drying, cycle in-situ in an automated manner.

The continuous inkjet printer may be for printing onto a substrate that moves past the printer. The substrate may be described as an external substrate. The continuous inkjet printer may be configured to print on a series of discrete products that move past the printer on a processing line (e.g. a production or packaging line).

The nozzle may otherwise be described as an aperture of a droplet generator, or a jewel. At least some of the ink droplets of the stream of ink droplets may be deflected in operation to apply a printed pattern to the external substrate. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. The EHT plate may be described as a deflection electrode. A (transverse) electric field is generated across the plates and a charged droplet is deflected by the field by an amount dependent upon the charge and the electric field.

The chamber may be defined by a chamber housing. The chamber may be entirely defined by a chamber housing. The chamber may be defined by a combination of a chamber housing and the casing. The rotatable body may define a downstream end of the chamber. The ink aperture may be described as being downstream of the at least one (e.g. deflection) electrode. The nozzle may be disposed proximate an upstream end of the chamber. The chamber may be described as interposing the nozzle and the rotatable body. The nozzle may be disposed proximate a first end of the chamber. The rotatable body may be disposed proximate a second end of the chamber. The first end of the chamber may oppose the second end of the chamber.

The chamber may be described as containing one or more components. Put another way, one or more components may be disposed in the chamber. The chamber may be described as containing one or more of a pair of deflection electrodes (e.g. a high voltage electrode and/or a low voltage electrode). Put another way, one or more of a pair of deflection electrodes (e.g. a high voltage electrode and/or a low voltage electrode) may be disposed in the chamber. A charge electrode and nozzle may be described as being in fluid communication with the chamber. The charge electrode and nozzle may be described as being in fluid communication with the chamber via a channel.

As well as the at least one electrode for guiding the stream of ink droplets being disposed in the chamber, at least part of a charge electrode may also be disposed in the chamber. The chamber may be described as a cleaning chamber. Any component disposed in the chamber may be cleaned as part of a cleaning cycle when the chamber is sealed by the sealing mechanism.

The nozzle may be described as in fluid communication with the chamber. The nozzle may be described as in (fluid) communication with the chamber via a charge electrode. The nozzle may be described as in fluid communication with the chamber independent of the configuration of the rotatable body. Put another way, the position of the rotatable body does not affect a fluid communication path between the chamber and the nozzle. Described a further different way, the nozzle may always be open to the chamber (e.g. permanently open to, or in fluid communication with, the chamber). The chamber may be described as being disposed downstream of the nozzle, and downstream of the charge electrode.

The nozzle is preferably fixed in position (e.g. not movable). The gutter is preferably fixed in position (e.g. not movable). The nozzle and gutter are preferably separate components to ports of the chamber. Put another way, the nozzle and gutter are preferably not ports of the chamber (e.g. are not used for providing, or draining, cleaning fluid from the chamber). That said, it may be advantageous to drain at least some of the cleaning fluid through the gutter to clear ink from the gutter line. Otherwise, ink may diffuse into the cleaning fluid. The chamber being in communication with atmosphere via at least the ink aperture may otherwise be described as the chamber being open or non-sealed. The rotatable body closing the ink aperture in the second configuration, such that the chamber is sealed by the rotatable body, may completely seal the chamber. In the second configuration the chamber may therefore be filled with cleaning fluid, which is subsequently drained, which effectively flushes the chamber and any components disposed therein. This may be described as a cleaning cycle which advantageously cleans components of the ink and/or solvent mixture (e.g. binder in the ink) which otherwise risks the build-up of ink fur within the print head which could lead to costly downtime.

Advantageously, a self-cleaning print head avoids the disadvantages of disconnecting the print head for cleaning and having to use a separate cleaning station.

The print head may further comprise a motor in power communication with the rotatable body.

The motor may be a stepper motor. In other embodiments an actuator that drives rotation of the rotatable body may otherwise comprise a brushless DC motor, a linear motor, a solenoid or other suitable actuator.

The motor may be directly connected to the rotatable body. The motor is preferably indirectly connected to the rotatable body via a gearing mechanism. The motor being in power communication with the rotatable body may otherwise be described as the motor being in driving communication with the rotatable body or that the motor is the actuator of the rotatable body.

The motor may be disposed outside of the chamber.

The motor being disposed outside of the chamber is intended to mean that the motor is not disposed in the chamber. Advantageously, the motor thus remains protected from the cleaning cycle within the chamber whilst still being able to drive rotation of the rotatable body.

The motor may be in power communication with the rotatable body via a worm gear.

Worm gear is intended to encompass the combination of a worm and a gear. The motor being in power communication with the rotatable body via a worm gear means that a direction of rotation of the motor is thus changed by incorporation of the worm gear.

The worm gear is advantageous for being able to change the direction of rotation and increase the torque outputted by the motor and which is communicated to the rotatable body. Incorporation of the worm gear is also advantageous in being able to accurately control the position of the rotatable body. Worm gears can also advantageously be self-locking insofar as the rotational position is maintained when stationary. This can prevent the rotatable body being undesirably forced open.

For completeness, an alternative gear could otherwise be used, likely with a higher torque motor. However, the high gear ratio of worm gears is desirable for the high torque, but compact packaging, requirements of the present invention.

The motor may be in power communication with the rotatable body via a shaft that extends along an extent of the chamber outside of the chamber.

The shaft extending along an extent of the chamber outside of the chamber encompasses the shaft extending along an entire extent of the chamber whilst being disposed outside of the chamber. Described another way, the shaft may be able to transmit the motor drive effectively along an extent of the chamber but whilst being protected from the cleaning cycle which occurs within the chamber.

In other embodiments a belt could be used to transmit the motor torque to the rotatable body.

Distancing the motor from the rotatable body, by the shaft, has advantageously been found to simplify the sealing arrangement between the chamber housing and the in comparison to if the motor were to be mounted proximate the rotatable body. This is desirable for at least the reason that the seal may be a serviceable item, and it is therefore desirable to avoid a complex seal. Incorporating a local motor, possibly with a gearing arrangement, was also found to be comparatively expensive and difficult to mount, with limited power in comparison to offsetting the motor from the rotatable body by the shaft.

The shaft may be coupled to the rotatable body via a shaft adapter. The shaft adapter may comprise a socket for ease of maintainability. At least part of the shaft may be received by the socket. For example, a hex head facilitates the easy removal/detachment of the shaft should the sealing mechanism need servicing.

The motor may be in power communication with the shaft via a first worm gear, and shaft may be in power communication with the rotatable body by a second worm gear.

The motor may thus be said to be in power communication with the rotatable body by two worm gears. This is advantageous for the reason that the direction of motor axis of rotation can be changed twice with a favourable torque transfer and that the motor can be disposed in a different location of the print head to that of the rotatable body.

The rotatable body may define a downstream-most end of the ink path.

The rotatable body defining a downstream-most end of the ink path is intended to mean that the rotatable body is the final component which the ink droplets for printing pass through as they leave the print head. This is advantageous for the reason that, when the rotatable body is changed in configuration, and the chamber is cleaned, the rotatable body is also cleaned. This therefore means that the downstream-most end of the ink path is also cleaned, reducing the risk of ink fur build-up, and other debris building up, at the downstream end of the ink path.

The print head may extend in a longitudinal direction which corresponds, at least in part, to a direction which the ink path extends in; and
the axis of rotation may be substantially perpendicular to the longitudinal direction.

Providing the axis of rotation substantially perpendicular to the longitudinal direction: i) reduces the increase in longitudinal extent of the print head attributable to the sealing mechanism; and ii) allows for a compact gearing mechanism to be incorporated. A comparatively lower torque is also needed to rotate the rotatable body (e.g. actuate the sealing mechanism) due to lower inertia and a reduced risk of sticking of the rotatable body (than if, for example, the rotatable body extended in the longitudinal direction).

According to a third aspect of the invention there is provided a continuous inkjet printer comprising:
an ink system for storing ink and supplying ink to a print head;
the print head comprising:
   a chamber selectively sealable by a rotatable body rotatable about an axis of rotation between a first configuration and a second configuration;
   a casing defining an ink aperture, the casing at least partly defining the chamber;
   a nozzle for generating and ejecting a stream of ink droplets for printing;
   at least one electrode for guiding the stream of ink droplets; and
   a gutter for receiving droplets of ink which are not used for printing;
      wherein
   the at least one electrode is disposed in the chamber; and
in a first configuration, an ink path for the stream of droplets for printing is defined through the chamber, across the rotatable body and through the ink aperture such that the chamber is in communication with atmosphere via at least the ink aperture; and
in the second configuration the rotatable body closes the ink aperture such that chamber is sealed by the rotatable body.

The continuous inkjet printer may be for printing onto a substrate that moves past the printer. The substrate may be described as an external substrate. The continuous inkjet printer may be configured to print on a series of discrete products that move past the printer on a processing line (e.g. a production or packaging line).

The nozzle may otherwise be described as an aperture of a droplet generator, or a jewel. At least some of the ink droplets of the stream of ink droplets may be deflected in operation to apply a printed pattern to the external substrate. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. A (transverse) electric field is generated across the plates and a charged droplet is deflected by the field by an amount dependent upon the charge and the electric field.

The ink system may comprise a number of components including, but not limited to, a mixing tank, a plurality of pumps, a cartridge, a plurality of filters and a plurality of valves. The ink system may be described as being a closed system in which ink and solvent are received by way of a cartridge, and an appropriate mixture is prepared in the mixing tank ready for printing. Ink is supplied from the mixing tank to the print head. The ink system may further comprise a solvent reservoir.

According to a fourth aspect of the invention there is provided a method of sealing a print head for a continuous inkjet printer, the method comprising:
rotating a rotatable body of a sealing mechanism of the print head from a first configuration, in which a chamber of the print head is in communication with atmosphere via at least an ink aperture, to a second configuration in which the chamber is sealed by the rotatable body.

The method may be described as a method of sealing a chamber of a print head. Sealing is intended to encompass the chamber being in fluid communication with one or more conduits, preferably a plurality of conduits. At least one conduit may be for supplying the chamber with cleaning fluid. At least one conduit may be for draining used/spent/dirty cleaning fluid from the chamber. Each of the conduits is preferably closeable under action of a respective valve. Each of the conduits is preferably bidirectional insofar as the conduit can either supply cleaning fluid, or drain used cleaning fluid, depending upon the configuration. The rotatable body may comprise an end cap. Sealing the print head may comprise rotating the end cap. The end cap may be fixed. Sealing the print head may comprise rotating the rotatable body with respect to a fixed end cap.

Advantageously, the chamber is sealed and can be cleaned in an automated manner, along with any components disposed within the chamber (e.g. deflection electrode).

According to a fifth aspect of the invention there is provided a method of cleaning a print head for a continuous inkjet printer, comprising:
sealing the print head according to the fourth aspect of the invention; and
directing a cleaning fluid into the chamber to clean the chamber.

The chamber may be referred to as a cleaning chamber. The cleaning fluid may be solvent. The cleaning fluid may be a blend of solvents.

Directing the cleaning fluid into the chamber may comprise pumping cleaning fluid into the chamber (e.g. under a positive pressure).

Directing the cleaning fluid into the chamber may comprise sucking (e.g. drawing) cleaning fluid into the chamber, under a negative pressure. Cleaning fluid may subsequently be drawn out of the chamber, again under a negative pressure. Advantageously, the gutter pump can be used to draw the cleaning fluid in this manner. Drawing cleaning fluid under a negative pressure is advantageously failsafe insofar as if the sealing mechanism were to fail, no cleaning fluid would be drawn into the chamber owing to the negative pressure drawing in only air via the open sealing mechanism. Such an arrangement is therefore inherently failsafe in mitigating the risk that pressurised cleaning fluid be inadvertently ejected from the print head onto a printing line.

The method may further comprise draining used cleaning fluid from the chamber. Used cleaning fluid may be drained contemporaneously as (new/fresh) cleaning fluid is pumped into the chamber. That is to say, cleaning fluid may be actively pumped or drawn through the chamber. Alternatively, the cleaning fluid may occupy the chamber for a period of time before being subsequently drained (e.g. a dwell time, or dwell period, such as around 5 seconds). That is to say, cleaning fluid may reside in the chamber in a stagnant manner for a period of time. The cleaning fluid may therefore dwell in the cleaning chamber for a time. Cleaning fluid drained from the chamber may be stored in a separate fluid reservoir (e.g. separate to the mixer tank). The separate fluid reservoir may be selectively connectable to the mixer tank to maintain viscosity.

The cleaning fluid may be directed into the chamber from a solvent reservoir (e.g. a solvent tank). The solvent reservoir may contain solvent which has previously been used in the ink system. The cleaning fluid may be directed into the chamber from a solvent cartridge. The solvent cartridge may contain fresh, or virgin, solvent. A cleaning cycle may first be carried out using cleaning fluid from the solvent reservoir. The cleaning cycle may then be carried out using fresh cleaning fluid from the solvent cartridge. This may be described as pre-cleaning with dirty solvent, and finishing the cleaning cycle with a virgin solvent rinse. Cleaning the chamber may comprise agitating the cleaning fluid, in the chamber, by directing a flow of air through the chamber. This may be described as bubbling air through the chamber to agitate the cleaning fluid in the chamber.

Where the chamber is in fluid communication with a plurality of conduits, the conduits are preferably connected to the chamber at different locations. For example, a first conduit may be connected to an upstream end of the chamber (e.g. proximate the nozzle). For example, a second conduit may be connected to a downstream end of the chamber (e.g. proximate the gutter). The ports, to which the conduits are connected, are preferably provided at diametrically opposed locations with respect to one another in the chamber. For example, a first port may be disposed in a first corner of a cuboidal chamber, and the second port may be disposed at a diagonally opposed second corner of the cuboidal chamber.

According to a sixth aspect of the invention there is provided a cap assembly for a print head of a continuous inkjet printer, comprising:
a polymer casing which defines an ink aperture; and
a conductive end cap receivable over at least part of the casing, the end cap defining an aperture which extends around the ink aperture;
wherein the end cap is grounded.

The casing may comprise a projecting portion which defines the ink aperture, the projecting portion extending at least partway through the aperture of the conductive end cap.

The endcap may comprise a lip around the aperture. The endcap may be engageable with the casing to support the casing.

According to a seventh aspect of the invention there is provided a sealing mechanism for a print head of a continuous inkjet printer, comprising:
the cap assembly according to the sixth aspect of the invention;
a rotatable body rotatable about an axis of rotation between a first configuration and a second configuration; and
wherein:
in the first configuration, an ink path is defined across the rotatable body through the ink aperture; and
in the second configuration, the rotatable body closes the ink aperture.

According to an eighth aspect of the invention there is provided a sealing mechanism for a print head of a continuous inkjet printer, comprising:
a rotatable body rotatable about an axis of rotation between a first configuration and a second configuration; and
a casing defining an ink aperture;
wherein:
in the first configuration, an ink path is defined across the rotatable body through the ink aperture; and
in the second configuration, the rotatable body closes the ink aperture; and
wherein the rotatable body is rotatably coupled to a segmented gear, the segmented gear comprising a non-toothed portion extending between first and second end stops.

The first and second end stops may be described as defining an extent of rotation of the segmented gear and rotatable body.

According to a ninth aspect of the invention there is provided a method of determining a rotational position of a rotatable body of a sealing mechanism for sealing a print head, comprising:
activating a motor, in driving communication with the rotatable body, wherein rotation of the rotatable body is limited by a rotation limiting feature; and
using a position sensing arrangement to determine the position of the rotatable body.

Using the position sensing arrangement to determine the position of the rotatable body may comprise using the position sensing arrangement to determine the position of the rotatable body is a rotational position corresponding to an end stop defined by the rotation limiting feature.

The motor may be in driving communication with the rotatable body via a gearing arrangement, the gearing arrangement comprising a segmented gear with a non-toothed portion defined between first and second end stops;
using the position sensing arrangement may comprise:
   monitoring a motor signal to determine engagement of one of the first and second end stops; and
   determining, based upon the motor signal and a direction of rotation of the motor, which of the first and second end stops is engaged to determine the rotational position of the segmented gear and rotatable body.

Monitoring a motor signal to determine engagement of one of the first and second end stops may comprise monitoring a motor current. Engagement of one of the first and second end stops may comprise one of the first and second end stops fouling on a feature (e.g. a wall) of the gearbox housing.

The motor may be in driving communication with the rotatable body via a gearing arrangement, the gearing arrangement comprising a segmented gear with a non-toothed portion defined between first and second end stops;
using the position sensing arrangement may comprise:
   monitoring a pulse count of an encoder, rotationally coupled to a shaft of the motor, to determine engagement of one of the first and second end stops; and
   determining, based upon the pulse count and a direction of rotation of the motor, which of the first and second end stops is engaged to determine the rotational position of the segmented gear and rotatable body.

The aforementioned method can also advantageously be used to determine whether the rotatable body is stuck (e.g. no pulses in either direction) or obstructed (fewer pulses than expected before stopping).

According to a tenth aspect of the invention there is provided a modular print head for a continuous inkjet printer, comprising:
a sealing mechanism releasably coupled to a housing assembly at an interface, the sealing mechanism comprising:
   a rotatable body rotatable about an axis of rotation between a first configuration and a second configuration; and
   a casing defining an ink aperture, the casing retaining the rotatable body;
the housing assembly comprising:
   a chamber selectively sealable by the rotatable body rotatable about an axis of rotation between a first configuration and a second configuration;
   a nozzle for generating and ejecting a stream of ink droplets for printing;
   at least one electrode for guiding the stream of ink droplets; and
   a gutter for receiving droplets of ink which are not used for printing;
wherein
   the at least one electrode is disposed in the chamber;
wherein at least one fluid pathway, and at least one mechanical coupling, extend across the interface.

According to an eleventh aspect of the invention there is provided a method of disassembling a modular print head according to the tenth aspect of the invention, comprising:
decoupling the sealing mechanism from the housing assembly at the interface, separating the at least one fluid pathway across the interface, and disengaging the mechanical coupling across the interface.

According to a twelfth aspect of the invention there is provided a continuous inkjet printer comprising:
an ink system for storing ink and supplying ink to a print head;
the print head comprising the cap assembly according to the first aspect of the invention, and further comprising:
   a chamber selectively sealable by a rotatable body rotatable about an axis of rotation between a first configuration and a second configuration;
   the casing at least partly defining the chamber;
   a nozzle for generating and ejecting a stream of ink droplets for printing;
   at least one electrode for guiding the stream of ink droplets; and
   a gutter for receiving droplets of ink which are not used for printing;
      wherein
   the at least one electrode is disposed in the chamber; and
in a first configuration, an ink path for the stream of droplets for printing is defined through the chamber, across the rotatable body and through the ink aperture such that the chamber is in communication with atmosphere via at least the ink aperture; and
in the second configuration the rotatable body closes the ink aperture such that the chamber is sealed by the rotatable body.

According to a thirteenth aspect of the invention there is provided a continuous inkjet printer comprising:
an ink system for storing ink and supplying ink to a print head;
the print head comprising the modular print head according to the tenth aspect of the invention.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate. For example, it will be appreciated that each of the sixth, seventh, eighth, ninth, tenth and eleventh aspects of the invention may be combined with one another. Similarly, optional or preferred features of each of the sixth, seventh, eighth, ninth, tenth and eleventh aspects of the invention may be applicable to one another.

Specific embodiments of the present invention will now be described, by way of example only, with reference to the accompanying drawings in which:

FIG. 1 is a schematic illustration of a continuous inkjet (CIJ) printer according to an embodiment of the invention;

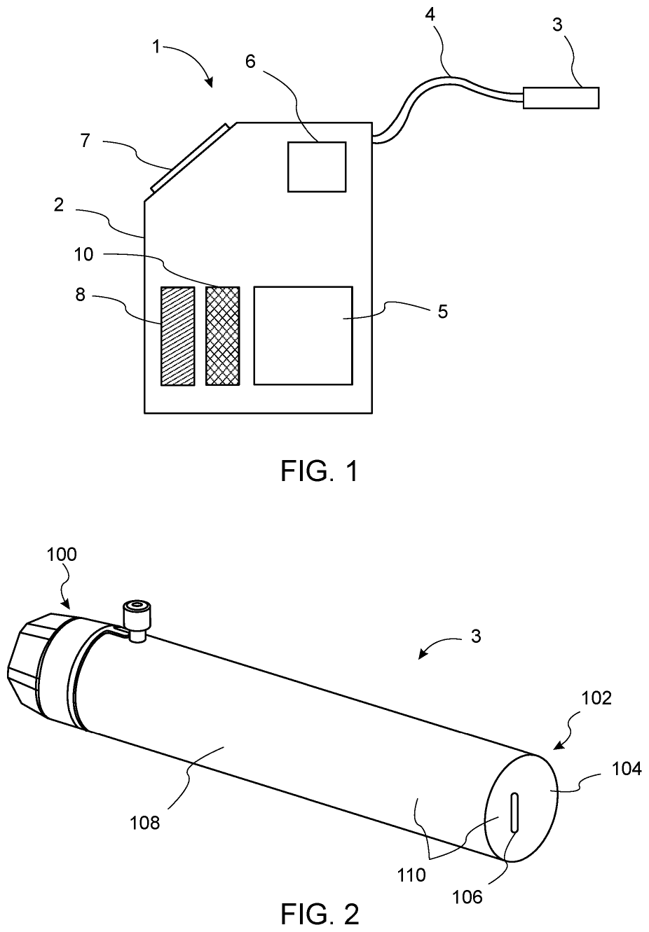

FIG. 2 is a perspective view of a print head, of the printer shown in FIG. 1, in isolation;

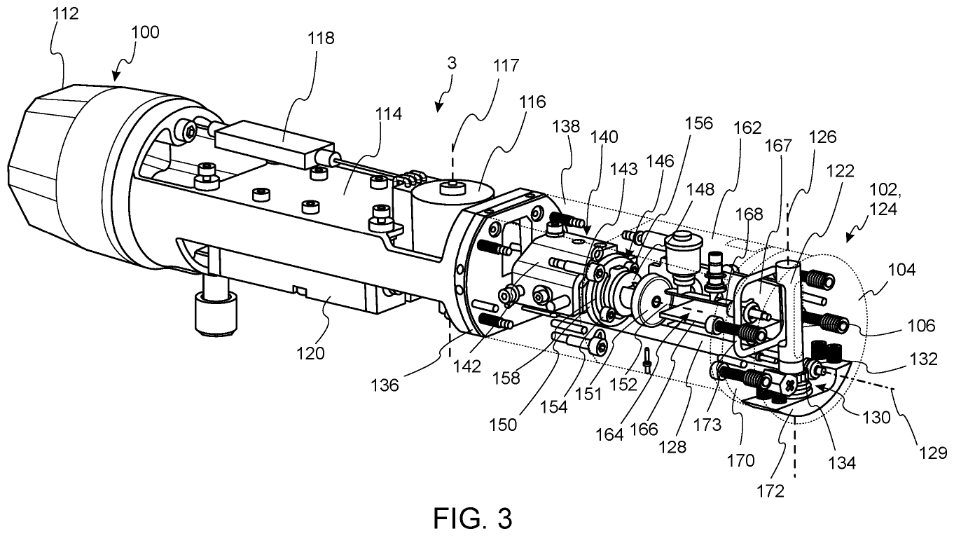

FIG. 3 is an alternative perspective view of the print head of FIG. 2 with an outer casing omitted;

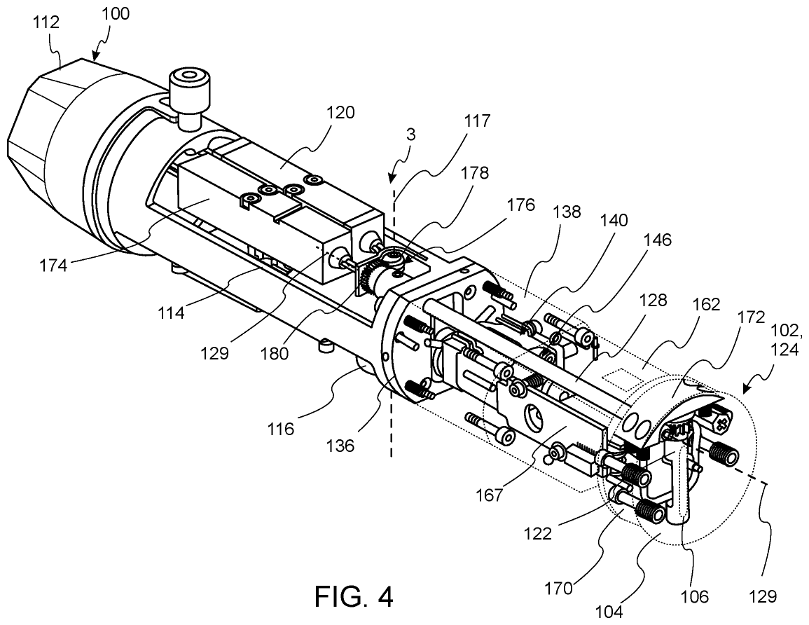

FIG. 4 is an alternative perspective view of the print head of FIG. 3;

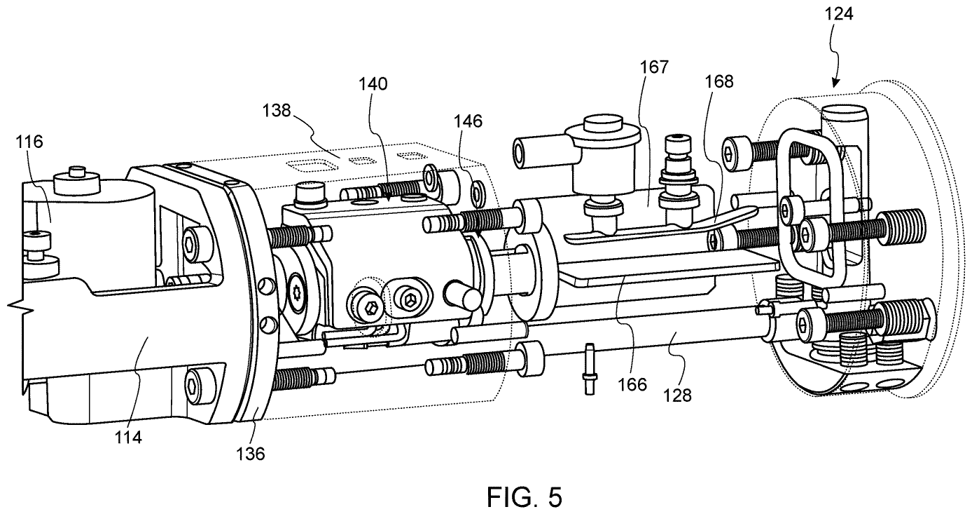

FIG. 5 is a magnified view of part of the print head shown in FIGS. 4 and 5 with a chamber housing omitted;

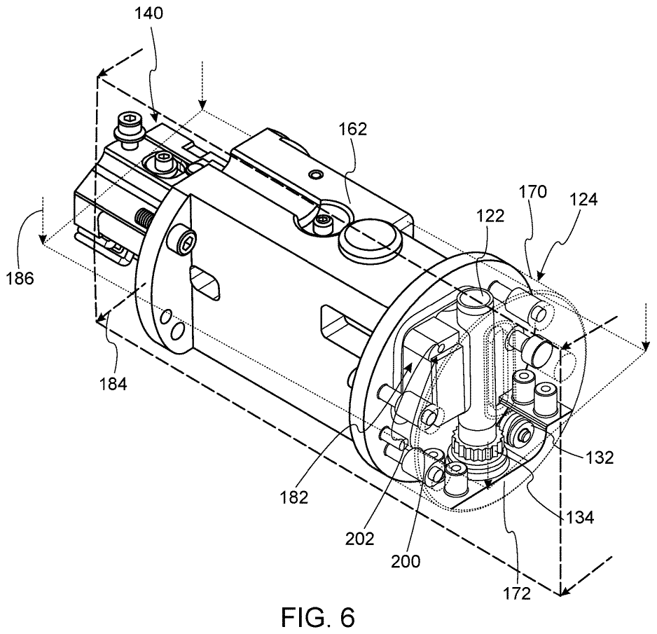

FIG. 6 is a perspective view of a subassembly of the print head of FIGS. 2 to 5;

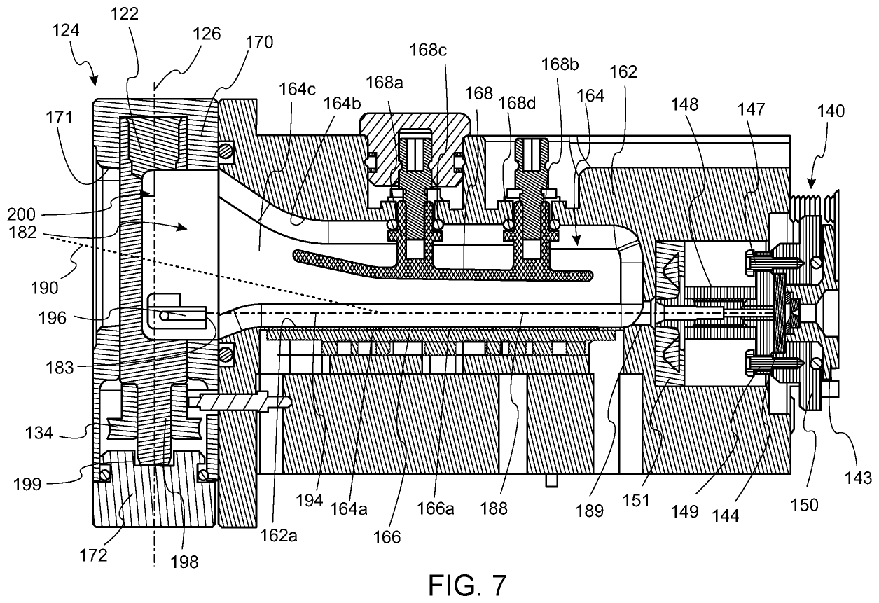

FIG. 7 is a cross-section side view of the subassembly of FIG. 6;

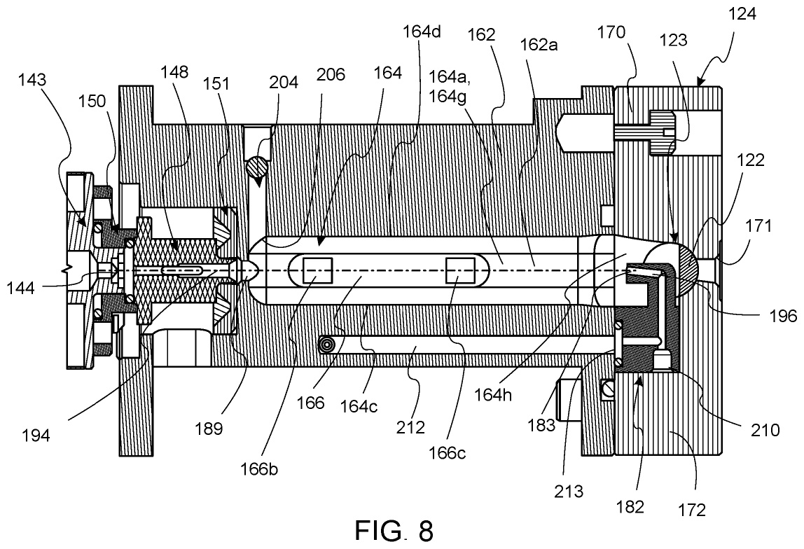

FIG. 8 is an alternative cross-section view of the subassembly of FIGS. 6 and 7;

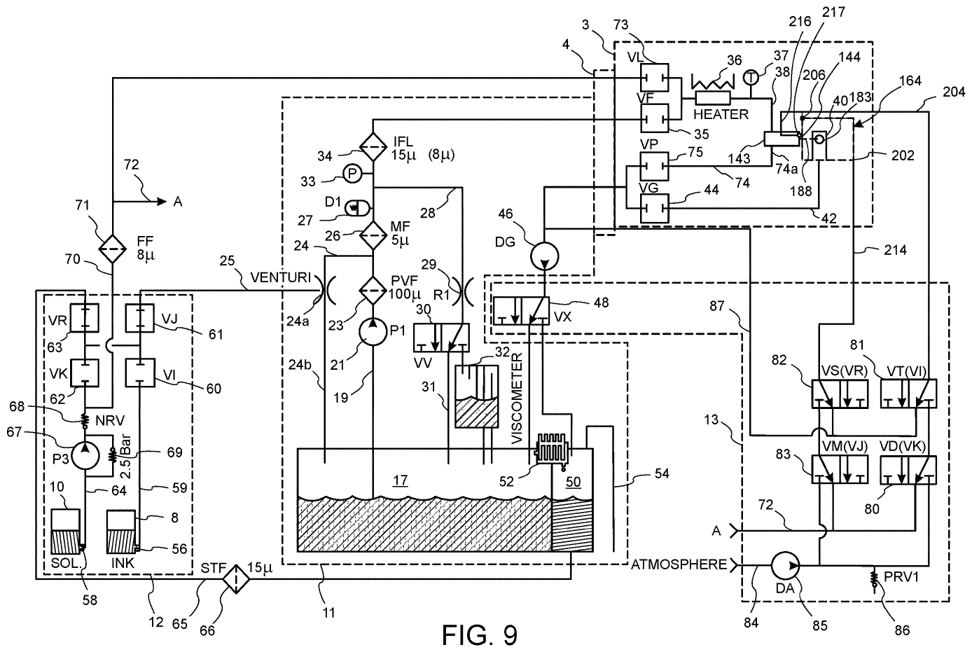

FIG. 9 is a schematic diagram of a fluid system for the printer of FIG. 1, incorporating the print head shown in FIGS. 2 to 7,

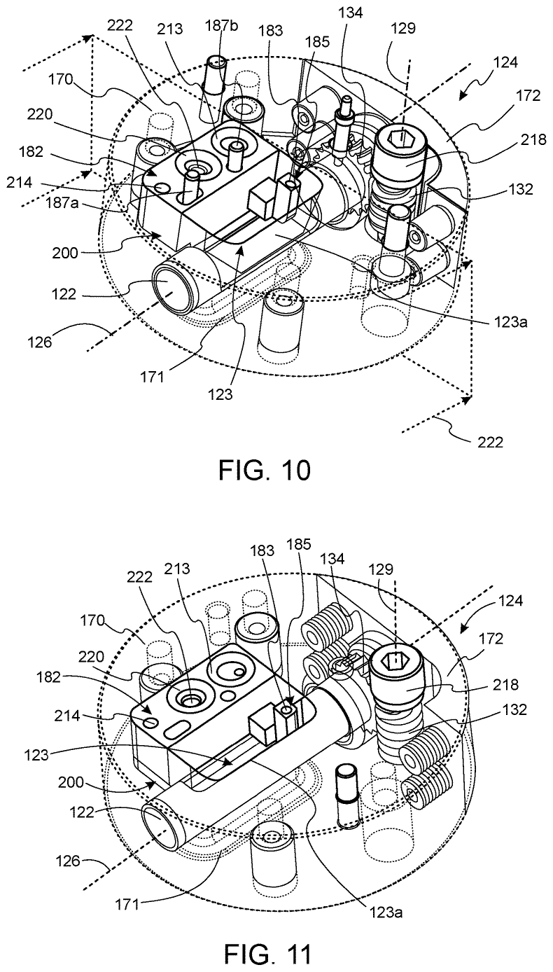

FIG. 10 is a perspective view of a sealing mechanism of the print head of FIGS. 2 to 8 with a rotatable body shown in a second configuration;

FIG. 11 shows the sealing mechanism of FIG. 10 with the rotatable body in a first configuration;

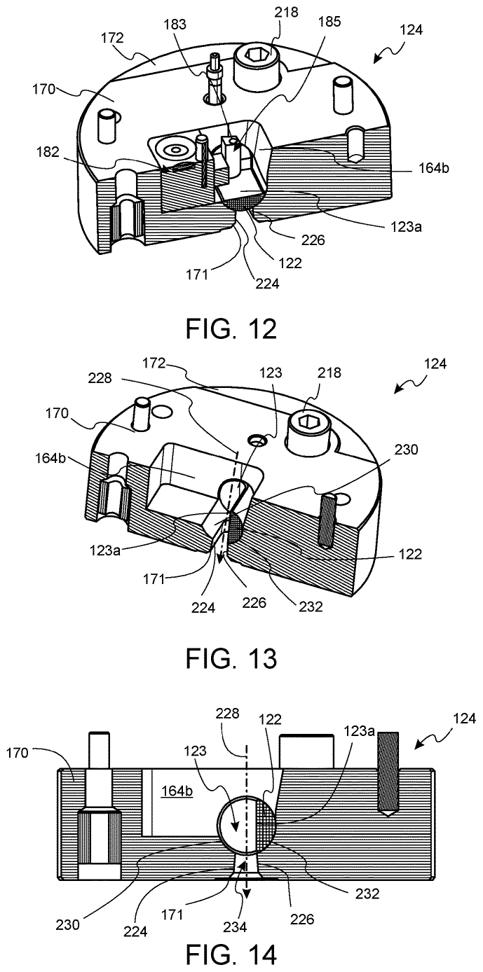

FIG. 12 is a perspective cross-section view of the sealing mechanism of FIG. 10;

FIG. 13 is a perspective cross-section view of the sealing mechanism of FIG. 11 with gutter block omitted;

FIG. 14 is a side cross-section view of the sealing mechanism shown in FIG. 13;

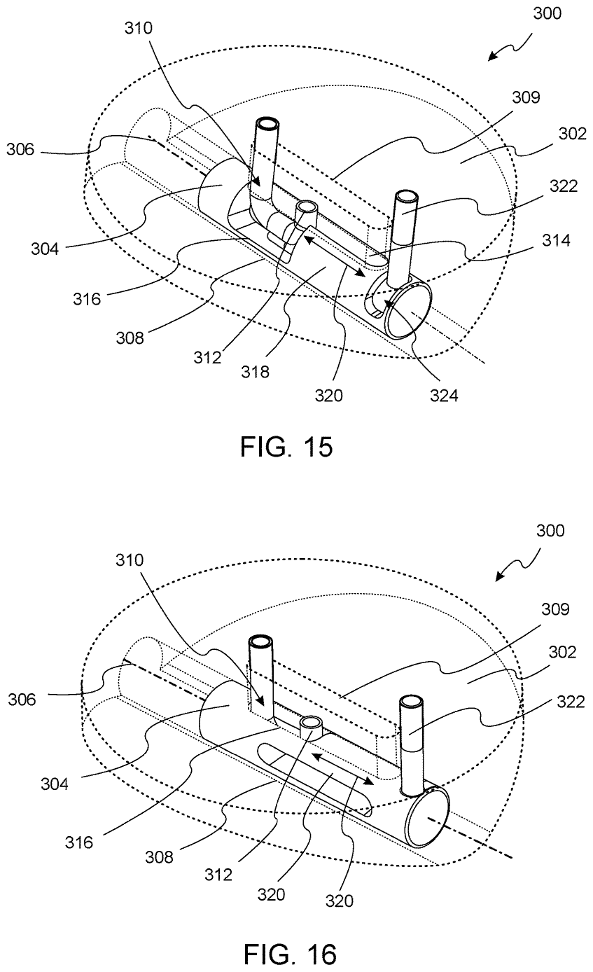

FIG. 15 is a perspective view of a sealing mechanism according to another embodiment, with a rotatable body shown in a first configuration;

FIG. 16 shows the sealing mechanism of FIG. 15 with the rotatable body in a second configuration;

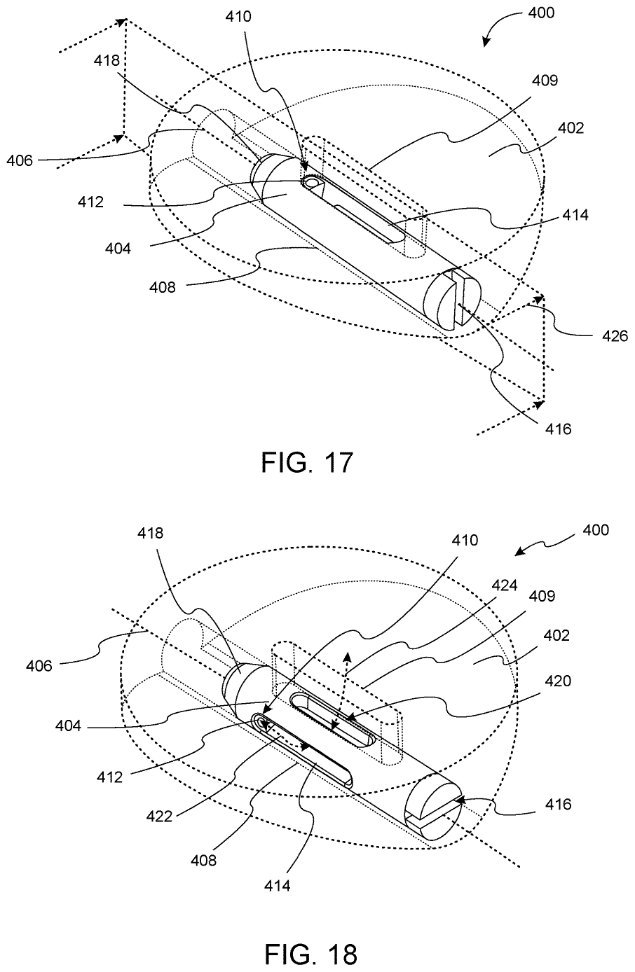

FIG. 17 is a perspective view of a sealing mechanism according to another embodiment, with the rotatable body incorporating an integrated gutter and shown in a first configuration;

FIG. 18 shows the sealing mechanism of FIG. 17 with the rotatable body in a second configuration;

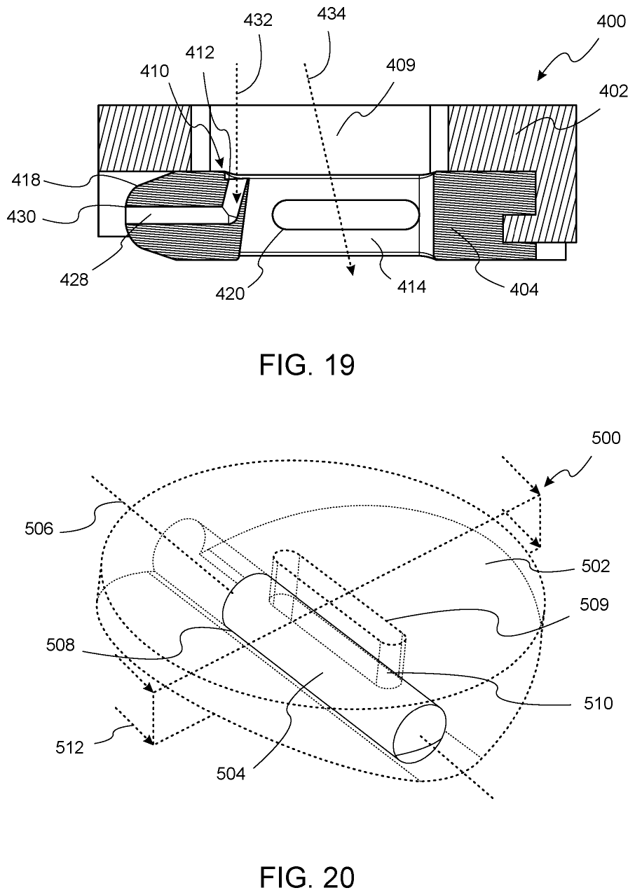

FIG. 19 is a side cross-section view of the sealing mechanism of FIG. 17;

FIG. 20 is a perspective view of a sealing mechanism according to another embodiment with a rotatable body in a first configuration;

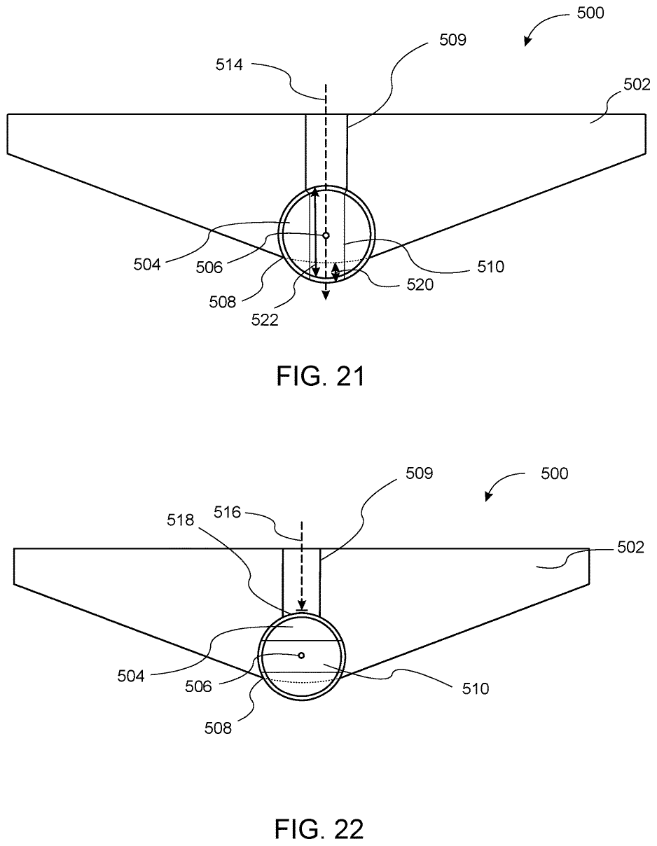

FIG. 21 is a cross-section plan view of the sealing mechanism of FIG. 20 with the rotatable body in the first configuration;

FIG. 22 shows the sealing mechanism of FIG. 21 with the rotatable body in a second configuration;

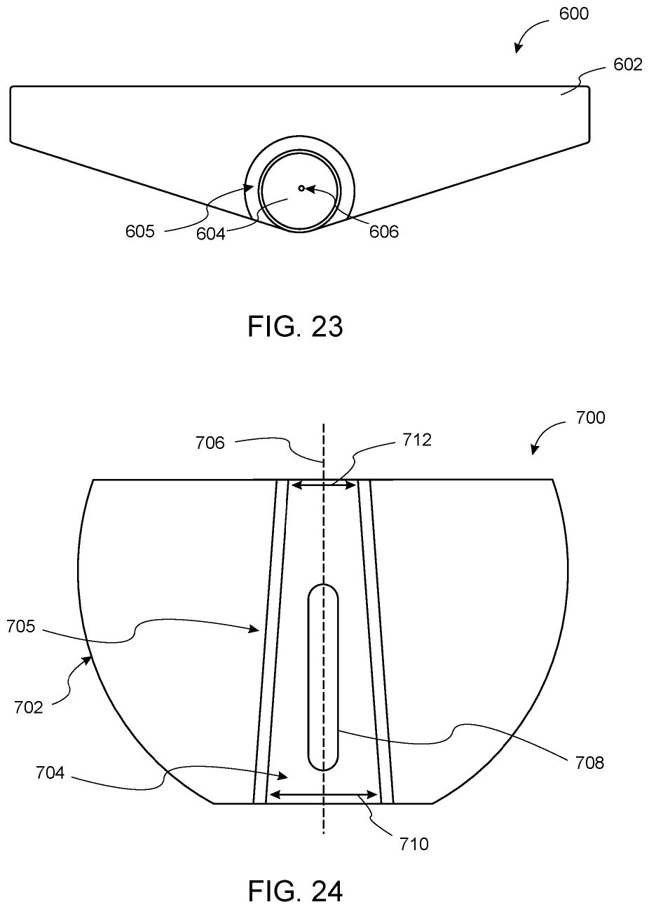

FIG. 23 is a plan view of the sealing mechanism of FIG. 20;

FIG. 24 is a front view of a sealing mechanism according to another embodiment;

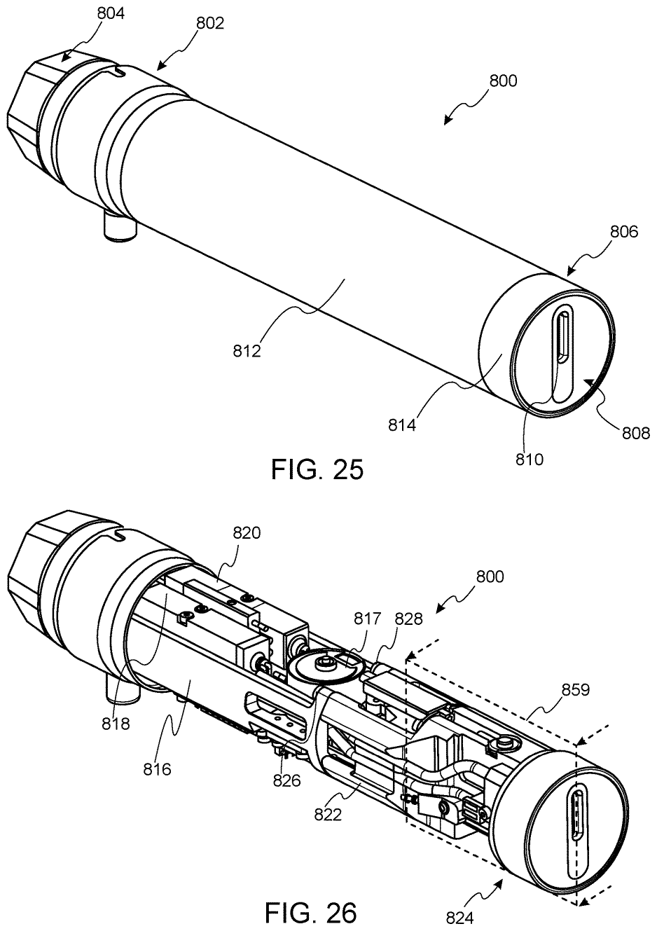

FIG. 25 is a perspective view of a print head according to another embodiment;

FIG. 26 is a perspective view of the print head of FIG. 25 with an outer shell omitted;

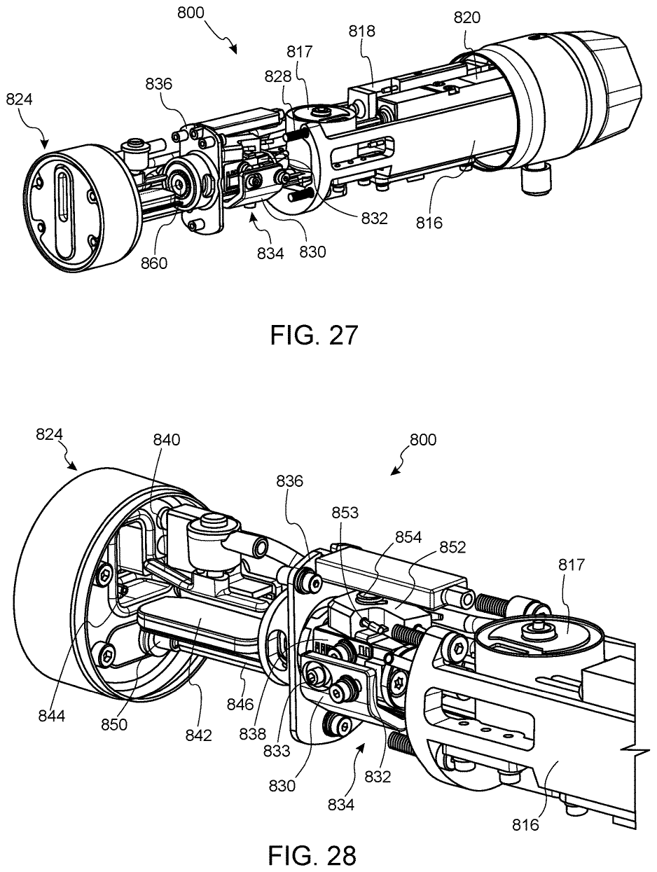

FIG. 27 is an alternative perspective view of the print head of FIGS. 25 and 26, with a chamber housing (and outer shell) omitted;

FIG. 28 is an alternative perspective view of part of the print head shown in FIG. 27;

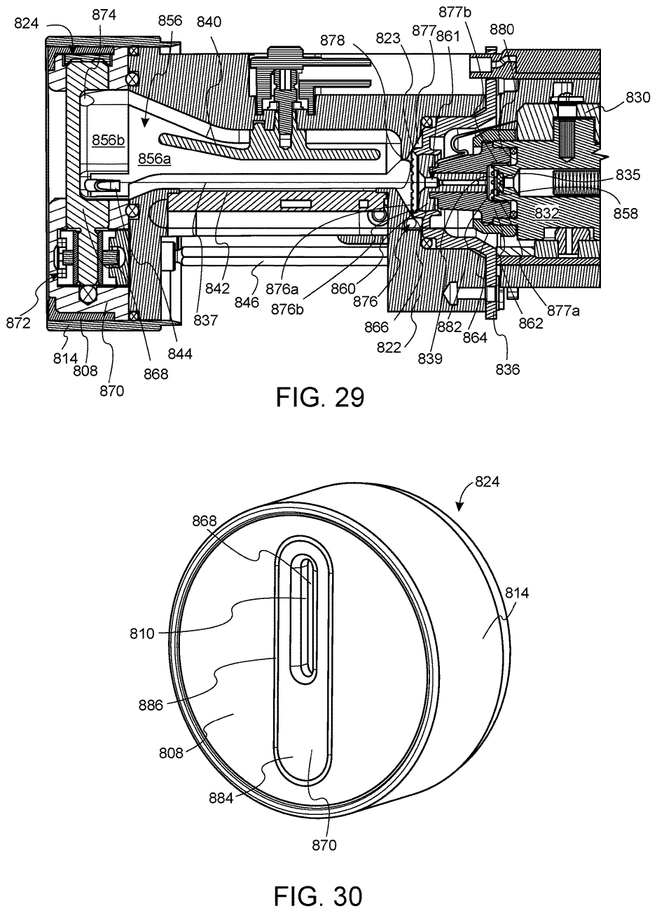

FIG. 29 is a cross-section side view of the print head of FIGS. 25 to 28 with an outer shell omitted;

FIG. 30 is a perspective view of a sealing mechanism, of the print head of FIGS. 25 to 29, in isolation;

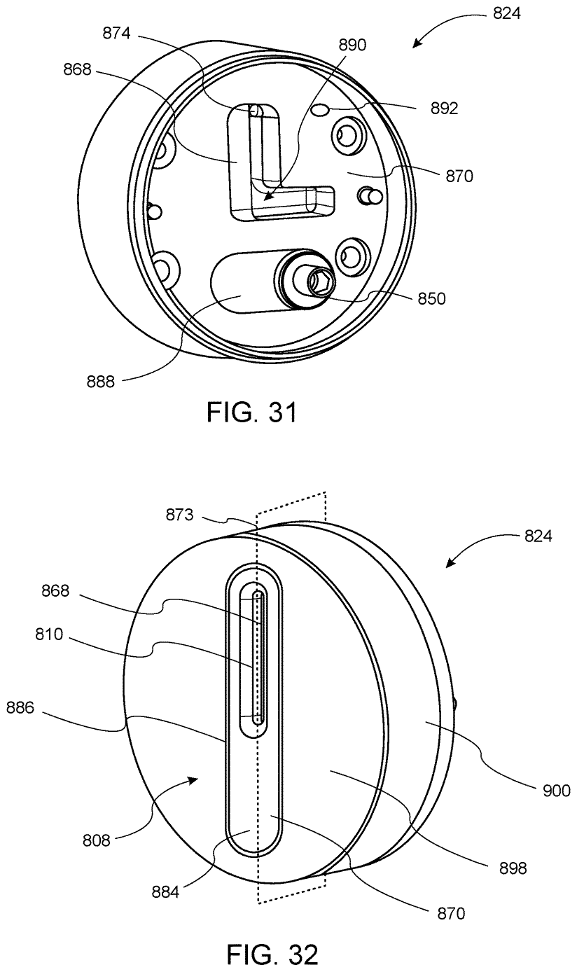

FIG. 31 is an alternative perspective view of the sealing mechanism shown in FIG. 30;

FIG. 32 is a perspective view of the sealing assembly of FIGS. 30 and 31 with a sealing cover omitted;

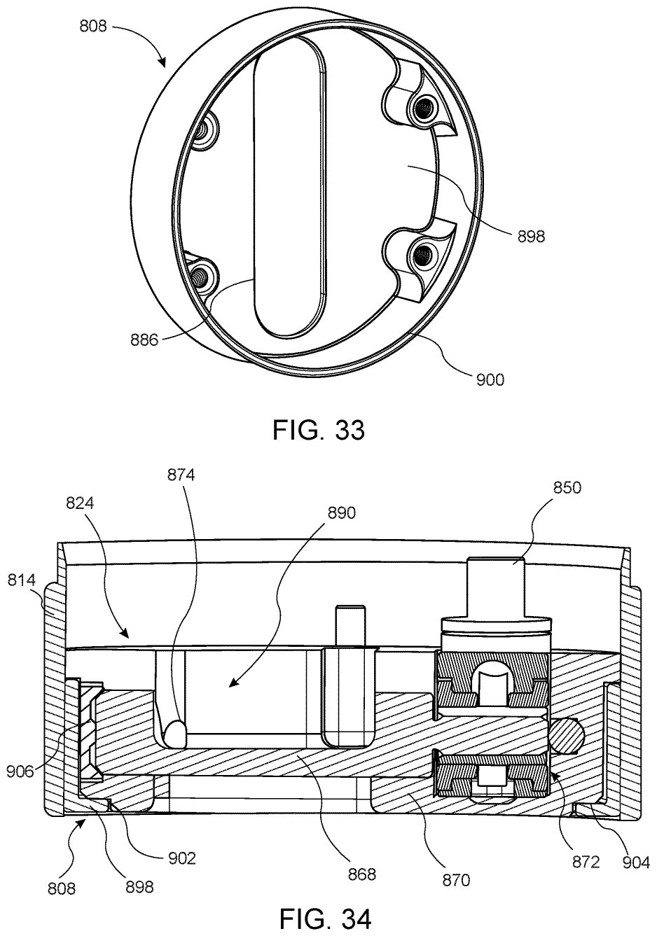

FIG. 33 is a perspective view of an end cap, forming part of the sealing mechanism of FIGS. 30 to 32, shown in isolation and generally taken from an inner side of the end cap;

FIG. 34 is a cross-section side view of the sealing mechanism of FIGS. 30 to 32;

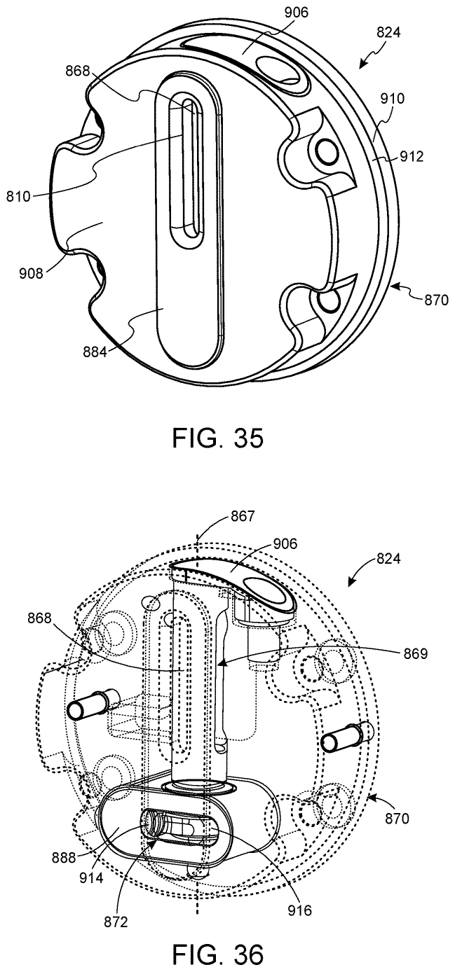

FIG. 35 is a perspective view of the sealing mechanism of FIGS. 30 to 32 and 34 with the end cap omitted;

FIG. 36 corresponds to FIG. 35, but with the casing shown in a semi-transparent view;

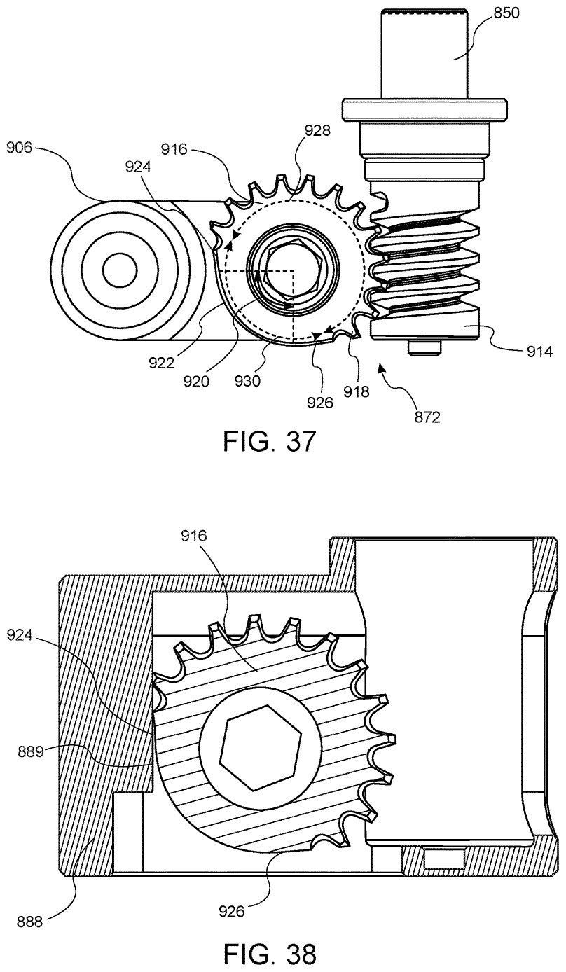

FIG. 37 shows a gearing arrangement, along with some other components, forming part of the sealing mechanism of FIGS. 30 to 32 and 34 to 36;

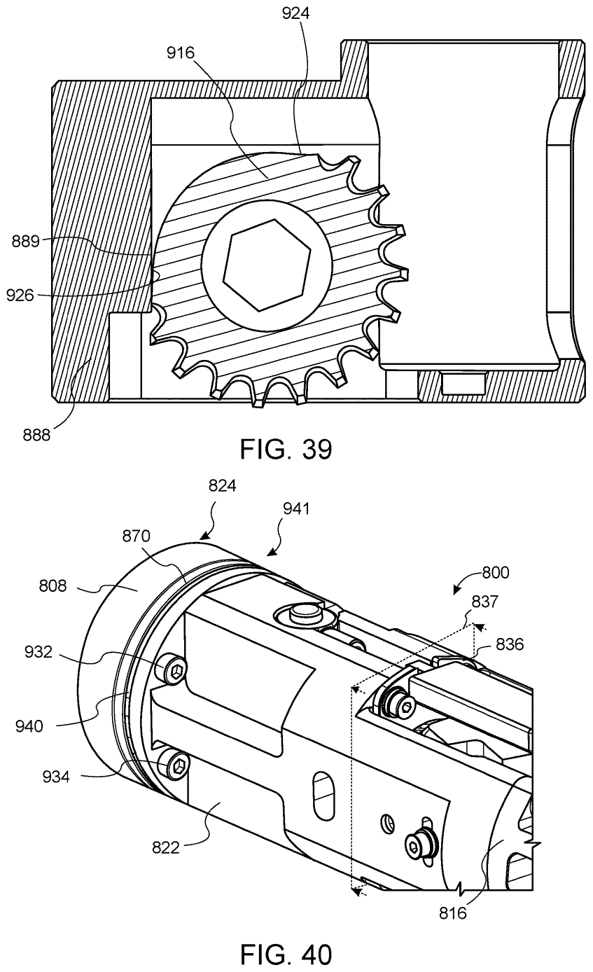

FIGS. 38 and 39 show end stops of a segmented gear engaging a wall of a gearbox housing, the gear and gearbox housing forming part of the gearing arrangement shown in FIG. 37;

FIG. 40 is a perspective view of part of the print head of FIGS. 25 to 29;

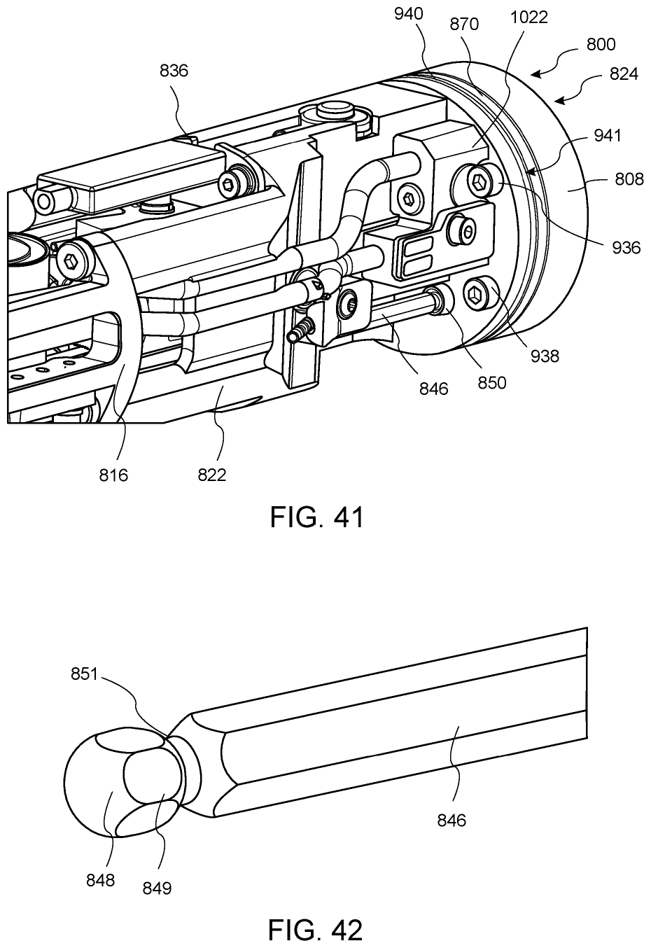

FIG. 41 is an alternative perspective view to that shown in FIG. 40;

FIG. 42 shows part of a shaft of the print head of FIGS. 25 to 29 and 40 to in isolation;

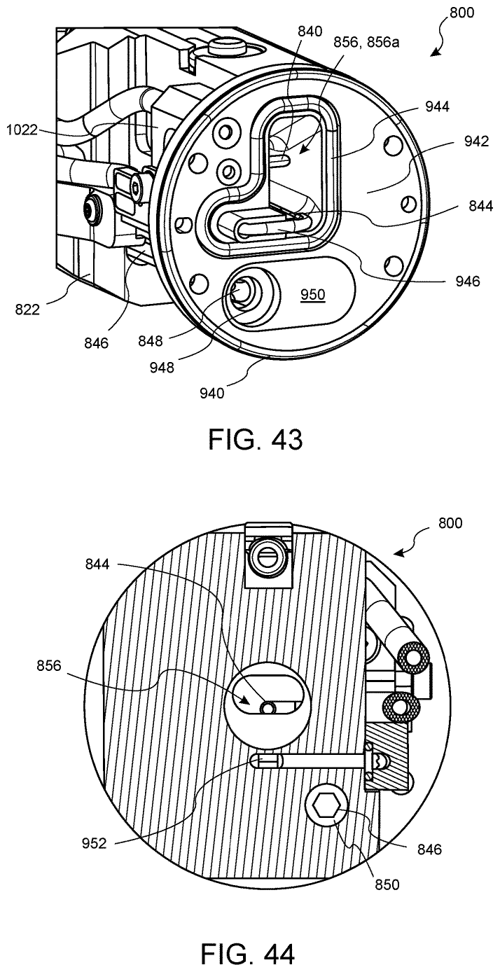

FIG. 43 is a perspective view of part of the print head of FIGS. 25 to 29 and 40 to 41 with the sealing mechanism removed; and

FIG. 44 is a cross-section view of the print head of FIGS. 25 to 29 and 40 to 41 and 43 about a plane schematically indicated in FIG. 40.

FIG. 1 schematically illustrates a continuous inkjet (CIJ) printer 1 according to an embodiment of the invention. The printer 1 comprises a printer body 2 (which may be referred to as a cabinet) connected to a print head 3 by an umbilical cable 4. The printer body 2 houses an ink system 5 and a printer controller 6. The printer body 2 also has an interface 7 (e.g. a display, keypad, and/or touch screen) for use by an operator.

The print head 3 is arranged to print on a substrate provided adjacent to the print head 3. The printer 1 typically comprises two cartridge connections for engagement with respective fluid cartridges. In particular, the printer 1 comprises an ink cartridge connection for engagement with an ink cartridge 8 and a (separate) solvent cartridge connection for engagement with a solvent cartridge 10. The cartridge connections typically each comprise a fluid port arranged to connect to a fluid pathway within the printer 1 to allow fluid to flow between the cartridges 8, 10 and other parts of the inkjet printer 1, such as the ink system 5 and the print head 3 (via the umbilical 4). The solvent cartridge 10 comprises fresh (i.e. virgin, not used) solvent.

In operation, ink from the ink cartridge 8 and solvent from the solvent cartridge 10 can be mixed within the ink system 5 to generate printing ink of a desired viscosity that is suitable for use in printing. This ink is supplied to the print head 3 and unused ink is returned from the print head 3 to the ink system 5 (via the umbilical 4). When unused ink is returned to the ink system 5 from the print head 3, air may be drawn in with ink from a gutter of the print head 3. The air may then become saturated with solvent in the gutter line.

In operation, ink is delivered under pressure from the ink system 5 to the print head 3 and recycled back via flexible tubes which are bundled together with other fluid tubes and electrical wires (not shown) into the umbilical cable 4. In order to maintain correct consistency of the ink, the ink system 5 may be operable to mix ink removed from the cartridge 8 with solvent removed from the cartridge 10 and to mix them together to obtain an ink having the correct viscosity and/or density for a particular printing application.

Of particular relevance to the present application, the print head 3 is a self-cleaning print head. Without operator intervention, the print head 3 can be sealed, and a cleaning fluid (e.g. fresh and/or used solvent, or a fresh and/or used blend of solvents) be flushed through at least part of the print head 3, in order to clean the print head 3. As will be set out in the following description and accompanying figures, this is achieved by incorporation of a sealing mechanism, comprising a rotatable body, in the print head 3.

Turning to FIG. 2, a perspective view of the print head 3 in isolation is provided.

The print head 3 comprises a first end 100 by which the print head 3 is connectable to an umbilical 4 as shown in FIG. 1. The first end 100 may therefore comprise a connector (e.g. a threaded connector in the illustrated embodiment). At an opposing end, the print head 3 comprises a second end 102. Provided at the second end 102 is an end cap 104. The end cap 104 defines an outermost part of the print head 3. The end cap 104 comprises an ink aperture 106, which may be referred to as an ink slot. It is through the ink aperture 106 that deflected ink, in operation, is ejected from the print head 3 onto a substrate (e.g. an external substrate which moves past the print head 3). The print head 3 comprises a single ink aperture 106. In other embodiments the print head 3 may comprise two ink apertures. Extending generally between the first and second ends 100, 102 is an outer shell 108. The outer shell 108 is generally cylindrical in the illustrated embodiment and provides a protective cover for the components which make up the print head 3. In order to expose the components, such as for maintenance, the outer shell 108 is removable. The combination of the end cap 104 and the outer shell 108 may be described as an outer cover 110 of the print head 3.

When the print head 3 is to be cleaned (e.g. by way of the self-cleaning capability of the print head 3), the ink aperture 106 can effectively be closed, and sealed, by a sealing mechanism within the print head 3. That is to say, when cleaning fluid is flushed through a chamber of the print head 3 (which will be described below), cleaning fluid cannot escape from the print head 3 through the ink aperture 106. For the purposes of this application, the closing of the ink aperture 106 may not infer a change in the geometry of the ink aperture 106 geometry itself. That is to say, the ink aperture 106 remains as shown in FIG. 2 regardless of whether it is opened or closed (by operation of the sealing mechanism). However, at least in the illustrated embodiment, the ink aperture 106 can be obscured (e.g. covered, internally) by an upstream rotatable body to define the sealed chamber. This will be described in detail later in this document.

Turning to FIG. 3, a perspective view of the print head 3 is provided with the outer shell 108 omitted. Various components which make up the print head 3 are therefore visible, and a number of components are also shown in a partially cutaway view to improve visibility.

FIG. 3 shows a connector 112, by which the print head 3 is connectable to an umbilical, provided at the first end 100 of the print head. The connector 112 is integral with a chassis 114. The chassis 114 defines a platform of sorts to which various other components are mounted. For example, a motor 116 and high voltage resistor 118 are mounted to the chassis 114 in the illustrated embodiment. The high voltage resistor 118 limits the current and spark energy available to the electrodes (described below). In other embodiments the high voltage resistor 118 may be mounted closer to a deflection electrode 168 to reduce a cable length therebetween. The high voltage resistor 118 may therefore be mounted to a chamber housing 162 or PCB 167, for example. A solenoid valve 120 is also mounted to the chassis 114. In the illustrated embodiment the solenoid valve 120 is mounted to the chassis 114 via a valve manifold. The motor 116 is a stepper motor in the illustrated embodiment, but other varieties of motor may otherwise be used.

A shaft of the motor 116 rotates about an axis of rotation 117, which may be referred to as a motor axis. The motor 116 is provided in power communication with a rotatable body 122 which forms part of a sealing mechanism 124. The sealing mechanism 124 is located at the second end 102 of the print head 3 and, as mentioned above, is a particular focus of the present application. Briefly, the rotatable body 122 is rotatable about an axis of rotation 126. The rotatable body 122 is rotatable between a first configuration, in which an ink path is defined across the rotatable body 122 and through the ink aperture 106, and a second configuration (as shown in FIG. 3) in which the rotatable body 122 closes the ink aperture 106. In the second configuration the sealing mechanism 124, specifically the rotatable body 122 thereof, seals part of the print head 3 (i.e. a chamber) to allow that part to be flushed with cleaning fluid to clean the print head 3.

As previously mentioned, the motor 116 is in power communication with the rotatable body 122 to drive rotation of the rotatable body 122. The motor 116 is in power communication with the rotatable body 122 via a shaft 128. The shaft 128 is disposed outside of a chamber which is selectively sealed by the rotatable body 122 (e.g. see chamber 164 in FIG. 7). The shaft 128 extends along an extent of the chamber. The shaft 128 is in power communication with the rotatable body 122 via a worm gear 130 comprising a worm 132 and a gear 134. The worm 132 is coupled to an end of the shaft 128 (e.g. which is proximate the second end 102 of the print head 3). The gear 134 is rotatably coupled to the rotatable body 122. The worm gear 130 changes the direction of rotation of the shaft 128 from the axis of rotation 129 to the axis of rotation 126. Although not visible in FIG. 3 a further worm gear is used to change a direction of rotation of the motor 116 at an obscured end of the shaft 128 (e.g. located towards the first end 100 of the print head 3). As mentioned above, the shaft 128 rotates about the axis of rotation 129. The axis of rotation 129 extends in a longitudinal direction along the print head 3, and the print head 3 may be described as generally extending in the same longitudinal direction.

The use of the drive assembly including the shaft 128 and the worm gear 130 is advantageous for a number of reasons. Firstly, incorporation of the shaft 128 means that the motor 116 can be disposed in a different part of the print head 3 to that of the rest of sealing mechanism 124. This is desirable for reasons of not increasing the longitudinal extent of the print head 3 at the second end 102 by any more than is needed (e.g. to accommodate the volume of the motor). Increasing the longitudinal extent of the print head 3 at the second end 102 risks reducing a throw distance by which the print head 3 must be offset from a substrate to be printed. The use of the worm gear 130 is also advantageous for at least the reason that the gearing can effectively increase the torque output transmitted by the motor 116 to the rotatable body 122. This is particularly desirable where the rotatable body 122 may be partially stuck in position (e.g. stiction) following a cleaning process and a subsequent drying process. Described another way, the use of the worm gear 130 reduces the risk that the rotatable body 122 is stuck in position such that the drive assembly is unable to rotate the rotatable body 122 about the axis of rotation 126.

Returning to describe other components of the print head 3, coupled to the chassis 114 is a manifold 136. Various fluid and electrical connections extend through the manifold 136.

A nozzle housing 138 (shown in a partially cutaway view in FIG. 3) is coupled to the manifold 136 and houses a nozzle assembly 140. The nozzle housing 138 may otherwise be described as a body forming part of a housing. The nozzle assembly 140 comprises, among other components, a nozzle cradle 142 and a nozzle body 143. The nozzle body 143 defines a nozzle (not visible in FIG. 3) for generating and ejecting a stream of ink droplets for printing. The print head 3 comprises a single nozzle body 143, which defines a single nozzle.

A charge electrode assembly 146 is coupled to the nozzle assembly 140. The charge electrode assembly 146 comprises a charge electrode 148 and a guide 150 to which the charge electrode 148 is coupled. As a stream of ink droplets is directed past the charge electrode 148 in use, they are selectively and separately given a predetermined level of charge by the charge electrode 148. In order to aid the alignment of the charge electrode 148 with respect to the stream of droplets emanating from the nozzle of the nozzle body 143, the charge electrode 148 is rotatably adjustable about axis of rotation 152 (which, for completeness, also generally corresponds to a path of the stream of ink droplets). The adjustment is achieved by loosening fasteners 154, 156, which secure the charge electrode assembly 146 with respect to the nozzle assembly 140, and rotating the charge electrode assembly 146. Movement of the charge electrode assembly 146 is constrained by the passage of the fasteners 154, 156 within tracks 158, 160 (track 160 not being visible in FIG. 3) defined in the guide 150. A grommet 151 is also shown in FIG. 3. As will be appreciated from FIG. 3, the grommet 151 is sandwiched between the charge electrode 148 and a chamber housing 162. The grommet 151 allows the charge electrode 148 to remain sealingly engaged with the chamber housing 162 (see also FIG. 7/8) whilst the charge electrode 148 is adjusted. An O-ring, or other variety of gasket, could otherwise be used, but a grommet has been found to provide for a comparatively larger degree of movement of the charge electrode 148 whilst maintaining the seal.

Returning to FIG. 3, coupled to the nozzle housing 138 is a chamber housing 162 (also shown partially cutaway in FIG. 3). The chamber housing 162 defines a chamber 164. The chamber 164 may otherwise be described as a washing cavity. Although further information in connection with the chamber 164 will be provided in the following Figures (the chamber 164 being visible in FIGS. 7 and 8 in particular), when the rotatable body 122 is in a second configuration in which the ink aperture 106 is closed, the chamber 164 is sealed for cleaning. Directing, or flushing a cleaning fluid into and through the chamber 164 when sealed thus cleans the chamber 164 and the associated components of the print head 3 which are provided in the chamber 164. Directing a cleaning fluid into the chamber 164 may comprise pumping the cleaning fluid (e.g. by action of an upstream pump, and under a positive pressure) and/or drawing the cleaning fluid (e.g. by action of a downstream pump, and under a negative pressure).

Coupled to the chamber housing 162, and mounted within the chamber 164, is a low voltage (e.g. grounded, or negative potential) electrode 166 and a deflection (e.g. high voltage) electrode 168. The electrodes 166, 168 may collectively be referred to as a pair of deflection electrodes. The low voltage electrode 166 may further comprise a phase detector which detects the phase of the charged particles in operation. The low voltage electrode 166 may be coupled to the chamber housing 162 by adhesive. In other embodiments the low voltage electrode 166 may be coupled to the chamber housing 162 by a gasket. The deflection electrode 168 is for guiding the stream of ink droplets, which are ejected by the nozzle and charged by the charge electrode 148, away from a gutter and towards the ink aperture 106 for printing onto a substrate in use. The deflection electrode 168 is disposed within the chamber 164 and can therefore be cleaned when the chamber 164 is sealed and the cleaning process is carried out.

The print head 3 further comprises a casing 170. The casing 170 forms part of the sealing mechanism 124. The casing 170 is coupled to the chamber housing 162. The casing 170 sealingly engages the chamber housing 162 by way of a gasket 173 which interposes the chamber housing 162 and the casing 170. The casing 170 may otherwise be described as a rotatable body mount, or housing. As will be described in detail later in this document, the rotatable body 122 is rotatably mounted within the casing 170 to selectively open and close the ink aperture 106. The casing 170 further comprises a cap 172 which is selectively detachable from the rest of the casing 170 to aid the installation and maintenance of the moving parts of the sealing mechanism 124 (e.g. the rotatable body 122). The casing 170 further comprises the end cap 104, which defines the ink aperture 106. The casing 170 may therefore be said to define the ink aperture 106. Although the ink aperture 106 is specifically defined by end cap 104 in the illustrated embodiment, in other embodiments the end cap 104 may be omitted. The casing 170 may therefore define the ink aperture even in the absence of an end cap. Also of note, the ink aperture 106 is downstream of the rotatable body 122 in the illustrated embodiment. That is to say, a stream of ink droplets first passes across the rotatable body 122 and then passes through the ink aperture 106. In other embodiments the rotatable body may define a downstream-most point of the ink path, such that there is no end cap positioned downstream of the rotatable body. In such embodiments the surrounding casing may be considered to define an ink aperture across the rotatable body.

For the avoidance of doubt, in the illustrated embodiment the end cap 104 is coupled to the chamber housing 162 and does not move in operation. That is to say, the end cap 104 is fixed in position. However, in other embodiments the end cap may define at least part of the rotatable body of the sealing mechanism. For example, the end cap may rotate, about an axis generally parallel to axis 129. The rotational position of the end cap may determine an extent to which an ink aperture of the end cap overlaps an ink aperture of an adjacent casing to ‘open’ the ink aperture of the adjacent casing. Where the ink apertures overlap at least partly, or entirely, the rotatable body (e.g. end cap) may be said to be in a first configuration in which an ink path is defined across the end cap. Where the ink aperture of the end cap does not overlap the ink aperture of the adjacent casing, the rotatable body (e.g. end cap) may said to be in a second configuration in which the ink aperture of the casing is closed.

Although shown in FIG. 3, various fasteners used to couple the chassis 114, the manifold 136, the nozzle housing 138, the chamber housing 162 and the casing 170 together are not annotated or described here in detail for brevity.

As will be appreciated from FIG. 7, the chamber 164 is defined by a combination of the chamber housing 162 and the casing 170. The chamber 164 has a lower surface defined by a combination of the low voltage electrode 166 (e.g. by surface 166a) and the surrounding chamber housing 162 (e.g. surface 162a), an upper surface which extends above the deflection electrode 168 (i.e. such that the deflection electrode 168 is disposed in the chamber 164) and is at least wide enough to contain the deflection electrode 168. Third and fourth surfaces 164c, 164d (which may be referred to as side surfaces) of the chamber 164 extend between the first and second surfaces 164a, 164b to define a perimeter of the chamber 164. The fourth surface 164d is not visible in FIG. 7.

With reference to FIG. 3, the print head 3 further comprises a PCB 167 which is mounted within the chamber housing 164. However, as indicated in FIG. 7, the PCB is not disposed within the chamber 164.

Turning to FIG. 4, an alternative perspective view of the print head 3 is provided. Owing to the different perspective, a number of components not visible, or only partially visible, in FIG. 3 are visible in FIG. 4.

Beginning from the first end 100 of the print head 3, the connector 112 and integral chassis 114 are shown. The solenoid valve 120 is shown mounted to the chassis 114, along with a valve block 174. Also visible in FIG. 4 is a worm gear 176 comprising a worm 178 and a gear 180. The worm 178 is rotatably coupled to the motor 116 which is just visible at the opposing side of the chassis 114 as shown in FIG. 4 (and is more clearly visible in FIG. 3). The worm 178 is driven to rotate about the axis of rotation 117. The worm 178 is provided in driving communication with the gear 180, the gear 180 being rotatably coupled to the shaft 128. The gear 180 and shaft 128 are thus driven to rotate about the axis of rotation 129, which may be referred to as a shaft axis. It will be appreciated that by use of the worm gear 176, the direction of rotation as driven by the motor 116 is effectively translated through 90° which is advantageous for reasons of space constraints within the print head 3. The shaft 128 is shown extending across an entire extent of each of the manifold 136, nozzle housing 138, chamber housing 162 and partially through the casing 170.

As described in connection with FIG. 3, also coupled to the chassis 114 are manifold 136, nozzle housing 138, chamber housing 162 and casing 170. The PCB 167 is also visible in FIG. 4. The nozzle assembly 140, coupled to the nozzle housing 138, and the charge electrode assembly 146 are also partially visible in FIG. 4.

Turning briefly to the sealing mechanism 124 at the second end 102 of the print head 3, as previously described the sealing mechanism 124 comprises the casing 170 (which comprises cap 172 and end cap 104) and the rotatable body 122. The ink aperture 106, defined by the casing 170, is also visible.

Of note, a component that has not yet been described in detail in connection with the print head 3 is that of a gutter. The print head 3 does incorporate a gutter which, in the illustrated embodiment, is a fixed gutter coupled to the casing 170. Details of the gutter will be provided in connection with FIG. 6 onwards.

Turning to FIG. 5, a magnified perspective view of part of the print head 3 is provided. As will be appreciated from FIG. 5, the motor 116 is partially visible, as is the chassis 114, but any components further towards the first/connector end of the print head 3 are not visible. Similarly, the chamber housing 162 as shown in FIGS. 3 and 4 is not shown in FIG. 5 to aid visibility of the components housed therein.

FIG. 5 shows the geometry of the deflection electrode 168 which is used to guide a stream of ink droplets towards a substrate to be printed.

FIG. 6 is a perspective view of a subassembly of the print head 3. FIG. 6 shows the chamber housing 162 with the nozzle assembly 140 and sealing mechanism 124 coupled thereto.

As previously described, various components of the sealing mechanism 124 are visible including the rotatable body 122, the casing 170, including the cap 172, and the worm 132 and gear 134. Also visible in FIG. 6 is gutter block 182. The gutter block 182 will be described in greater detail in connection with later Figures, but briefly the gutter block 182 comprises a gutter aperture (not visible in FIG. 6) through which droplets of ink which are not used for printing are received and subsequently recirculated back to a mixer tank of the ink system (as will be described in detail in connection with FIG. 9). In the illustrated embodiment the gutter block 182 is a separate component to that of the surrounding casing 170 and other components. However, in some embodiments the gutter may be integral with the rotatable body (e.g. see FIGS. 17, 18).

The gutter block 182 further comprises a recess 200 defined in an effective underside of the gutter block 182. The recess 200 leads into a port 202. The port 202, in turn, defines a second conduit (e.g. 214 as shown in FIG. 9). Owing to the presence of the recess 200, the second conduit is still provided in fluid communication with the chamber even when the rotatable body 122 is in the second, closed configuration as shown in FIG. 6. Cleaning fluid can therefore be pumped or drawn into the chamber via the second conduit, or used (e.g. dirty) cleaning fluid be pumped or drawn out of the chamber via the second conduit. Further detail in this regard will be provided below.

Also schematically indicated on FIG. 6 are first and second cross-sectional markers 184, 186. 184 is a vertical cross-section and 186 is a horizontal cross-section. The markers 184, 186 correspond to the cross-section views provided in FIGS. 7 and 8 respectively.

Turning to FIG. 7, a cross-section side view of the subassembly shown in FIG. 6 is provided as indicated by annotation 184 in FIG. 6. FIG. 7 shows the chamber 164 which can be selectively sealed by the sealing mechanism 124.

Beginning from the right hand end of FIG. 7, only part of the nozzle body 143 of the nozzle assembly 140 is visible. Nozzle body 143 defines the nozzle 144 that generates and ejects a stream of ink droplets 188 for printing. Downstream of the nozzle 144 is the charge electrode 148. The charge electrode 148 is rotatably coupled to the guide 150. In the illustrated embodiment the charge electrode 148 is rotatably coupled to the guide 150 by fasteners 147, 149, which are self-tapping screws. The guide 150 (and so the charge electrode 148) is rotatably adjustable with respect to the nozzle body 143. The guide 150 is a plastic insulator which separates the charge electrode 148 from the nozzle body 143 (which is grounded). The charge electrode 148 abuts the grommet 151 such that the grommet 151 is sandwiched between the charge electrode 148 and the chamber housing 162. The grommet 151 also facilitates adjustment of the charge electrode 148 with respect to the chamber housing 162 by allowing a degree of movement of the charge electrode 148 with respect to the chamber housing 162.

The charge electrode 148 is provided in communication with the chamber 164 by a channel 189. In use, as indicated in FIG. 7, a stream of ink droplets 188 is generated and ejected by the nozzle 144 and travel through the chamber 164 via the charge electrode 148 and the first channel 189. Having passed through the charge electrode 148 the stream of ink droplets 188 has a charge applied to them. The selectively charged stream of ink droplets 188 can be selectively deflected by the deflection electrode 168 for printing. A stream of ink droplets which has been deflected for printing by the deflection electrode 168 is labelled 190 in FIG. 7. A stream of ink droplets which are not used for printing, and which have therefore not been deflected by the deflection electrode 168, is labelled 194. The stream of ink droplets 194 not used for printing are received by a gutter aperture 183 of the gutter block 182. Part of a gutter conduit 196, defined by the gutter aperture 183, is also visible in FIG. 7. This is the conduit through which the droplets of ink 194 which are not used for printing, and which are received by the gutter aperture 183, travel.

For completeness, in FIG. 7 the rotatable body 122 of the sealing mechanism 124 is shown in the second, closed configuration. As such, none of the streams of ink droplets 188, 190, 194 would be present when the sealing mechanism 124 is in the configuration shown in FIG. 7. FIG. 7 indicates that the gutter block 182 is at least partially received by the casing 170 and, although not visible in FIG. 7, the chamber 164 also extends behind the gutter block 182 as shown in FIG. 7 (e.g. into the plane of the page). This is, however, visible in FIG. 8 and will be described in connection with the same.

Returning to FIG. 7, the sealing mechanism 124 comprising the rotatable body 122 rotatably coupled to the gear 134 is also shown. A shaft 198 of the rotatable body 122 is also visible. It is about the shaft 198 that the rotatable body 122 rotates about the axis of rotation 126 in use. The shaft 198 is received by a recess 199 of the cap 172 to constrain and locate the rotatable body 122.

An ink aperture 171 defined by the casing 170 is also visible in FIG. 7. The rotatable body 122 effectively closes the ink aperture 171 in the configuration shown in FIG. 7. In a first, open configuration, in which the rotatable body 122 is rotated relative to the position shown in FIG. 7, the ink aperture 171 is effectively opened such that the stream of ink droplets 190 can pass across the rotatable body 122, through the ink aperture 171, via an ink path 190. As the stream of ink droplets 188 passes across the chamber 164, the phase detector forming part of the low voltage electrode 166 also operates to detect the phase of the ink particles. Of note, as shown in FIG. 2 the end cap 104 defines the ink aperture 106. The ink aperture 171 shown in FIG. 7 overlaps the ink aperture 106 defined by the end cap 104, and the ink aperture 106 can therefore also be considered to be opened/closed by the rotatable body 104 (at least by virtue of being downstream of the ink aperture 171).

Finally, also shown in FIG. 7 is the recess 200 defined in the gutter block 182. As described in connection with FIG. 6, the recess 200 partly defines the port 202 which is used for cleaning and draining.

From FIG. 7 it will be appreciated that the rotatable body 122, and sealing mechanism 124 more generally, does not affect a fluid communication pathway between the nozzle 144 and the chamber 164. Put another way, the nozzle 144 remains in fluid communication with the chamber 164 independent of the configuration of the rotatable body 122.

Turning to FIG. 8, an alternative cross-section view to that shown in FIG. 7 is provided. In FIG. 8 the subassembly of FIGS. 6 and 7 is shown by way of a cross-section view as indicated by the annotations 186 in FIG. 6. FIG. 8 may therefore be described as a cross-section plan view of the subassembly.

As described in connection with FIG. 7, FIG. 8 also shows the nozzle body 143, guide 150, charge electrode 148 and grommet 151. FIG. 8 also shows the low voltage electrode 166 being located within the chamber 164. Also visible in FIG. 8 is a phase detector electrode 166b (which may be referred to as a phase pickup electrode) and a velocity detector electrode 166c. The electrodes 166b, 166c (and low voltage electrode 166) are etched into the PCB (e.g. a rear of the PCB, in the illustrated embodiment) which defines the low voltage electrode 166. The combination of the electrodes 166, 166b, 166c may be referred to as a phase detector assembly. The phase detector electrode 166b is configured to determine a magnitude of charge applied to the droplets of ink as they move past the phase detector electrode 166b. Measurements from the phase detector electrode 166b are used to determine when to apply a voltage to the charge electrode 148. The velocity detector electrode 166c is configured to determine the velocity of the droplets of ink as they move past the electrode 166b. The velocity is determined by measuring the time between the charge ‘pulse’ being detected by the phase detector electrode 166b and subsequently by the velocity detector electrode 166c, and dividing the distance between the electrodes 166b, 166c by that time. The low voltage electrode 166 takes the form of an Electroless Nickel Immersion Gold (ENIG) coated copper ground plate in the illustrated embodiment. The low voltage electrode 166 acts as the OV plate for the deflection electrode, which establishes the EHT field that deflects the stream of ink droplets in use. The phase detector electrode 166b and velocity detector electrode 166c are covered by an insulator (e.g. a solder resist in the illustrated embodiment). This prevents ink and/or solvent shorting the electrodes 166b, 166c to the low voltage electrode 166.

Owing to each of the: phase detector electrode 166b, velocity detector electrode 166c, low voltage electrode 166 and deflection electrode 168 (not shown in FIG. 8) being disposed in the chamber 164, all of these components can be cleaned during a cleaning cycle. Similarly, the charge electrode 148, although located outside of the chamber 164, can also be cleaned in a cleaning cycle by virtue of a third port (not visible in FIG. 8, but will be described in detail below).

FIG. 8 does show that in the illustrated embodiment the chamber 164 comprises first and second chamber portions 164g, 164h. The first chamber portion 164g is defined by the chamber housing 162. The second chamber portion 164h is defined by the casing 170. As such, the chamber 164 may be said to be at least partially defined by the casing 170 in the illustrated embodiment. In other embodiments it will be appreciated that the chamber housing 162 could be integral with the casing 170 such that the chamber 164 be defined entirely by the casing 170.

FIG. 8 also shows the chamber housing 162 comprises a (first) conduit 204 which extends partly through the chamber housing 162 and is in communication with the chamber 164 via a port 206. The port 206 may therefore be said to at least partly define the chamber 164. The conduit 204 is multipurpose in that it can be used to either supply the chamber 164 with cleaning fluid or to drain used cleaning fluid from the chamber 164. The conduit 204 may therefore be described as a chamber cleaning and draining channel. The conduit 204 may specifically be described as an upstream chamber cleaning/draining channel, owing to it being disposed proximate the channel 190 through which ink droplets are ejected into the chamber 164.

FIG. 8 also shows more features of the gutter block 182. As mentioned in connection with FIG. 7, the gutter block 182 comprises the gutter aperture 183 through which ink droplets which are not to be used for printing are received/collected. The gutter aperture 183 defines an upstream end of the gutter conduit 196 which extends through the gutter block 182. At a point downstream, the gutter conduit 196 appears to branch off to a recess 210. The recess 210 is sealed in use, and is only to facilitate manufacture of the gutter conduit 196 through the gutter block 182. Further downstream of the gutter conduit 196 is a return conduit 212 defined at least partly by the chamber housing 162. The return conduit 212 is provided in fluid communication with the gutter conduit 196, and so the gutter aperture 183. Ink droplets which are not used for printing are thus received by the gutter aperture 183 and are drawn through the gutter conduit 196 and the return conduit 212 by suction. The unused ink droplets are then returned to the mixer tank. For completeness, the gutter block 182 is sealed against the chamber housing 162 by seal 213.

In the illustrated embodiment the gutter block 182 forms a separate component which is fixedly coupled to the chamber housing 162. In other embodiments (e.g. FIGS. 17, 18), at least part of the gutter may rotatably coupled to the rotatable body 122, and may be integral with the rotatable body 122. Partially shown in FIG. 8 is a recess 123 of the rotatable body 122.

When the rotatable body 122 is in the second configuration as shown in FIG. 8, in which the rotatable body 122 closes the ink aperture 171, the gutter block 182 is partially received by a recess 123 of the rotatable body 122. When the rotatable body 122 is in a first configuration, in which an ink path is defined across the rotatable body 122 and through the ink aperture 171, the rotatable body 122 is effectively rotated counter clockwise by around 90° such that the gutter block 182 is still partially received by the recess 123 but in a different orientation. This will be described in greater detail in connection with FIGS. 10 and 11.

Referring now to FIG. 9, a schematic diagram of a fluid system for the printer of FIG. 1, incorporating the print head 3, is shown. The ink jet printer 1 comprises the ink system 5 which is contained within the main printer body 2. The ink system 5 comprises at least the components that form part of a main ink block 11. The ink system may further comprise a cartridge module 12 and a cleaning module 13 (which may be referred to as a cleaning fluid circuit). Components of the print head are schematically indicated 3. In some embodiments the cleaning module may be a generally separate module to the rest of the ink system. The cleaning module may therefore be connected to the ink system of a printer at the point of assembly. The cleaning module 13 can thus be factory fitted to printers. Alternatively, the cleaning module may be integral with the ink system to reduce component count.

Beginning with the main ink block 11, the main ink block 11 comprises a mixer tank 17 (which may also be referred to as an ink feed, or ink supply, tank) configured to supply ink along a main supply line 19. The ink is drawn from the mixer tank 17 by an ink pump 21. Ink also passes through a first filter 23, downstream of the ink pump 21, disposed along the main supply line 19. The first filter 23 removes any particles (e.g. sediment) contained within the mixer tank 17. The first filter 23 is a 100 micron filter in the illustrated embodiment, but it will be appreciated other sizes of filter could otherwise be used. A Venturi line 24 is connected to the main supply line 19 downstream of the first filter 23. Provided along the Venturi line 24 is a Venturi 24a (e.g. a restriction). In operation, fluid (e.g. an ink mixture) is continuously circulated from the mixer tank 17, through the main supply line 19, through the Venturi line 24, and so through the Venturi 24a, before being returned to the mixer tank 17. This continuous circulation, combined with the Venturi 24a, creates suction to draw fluids into the mixer tank 17 via a refill line 25, which extends between the cartridge module 12 and the Venturi 24a. Fluids are drawn into the mixer tank 17 through the Venturi 24a and a downstream portion 24b of the Venturi line 24.

The ink pump 21 may be operated as a pressure controlled pump, meaning that the ink flow rate through the pump 21 will be adapted as necessary to maintain a target pressure downstream of the ink pump 21 (e.g. as monitored by a pressure sensor 33). The ink pump 21 may be configured to supply ink to the print head 3 at a predetermined system operating pressure, which may be determined based upon the printer configuration (e.g. nozzle geometry). For example, a nozzle having a diameter of 75 μm may require a lower operating pressure than a nozzle having a diameter of 62 μm to achieve a similar jetting performance (e.g. ink droplet breakup location, or flight time to breakup). The system operating pressure may also be varied in dependence upon other system parameters (e.g. ink type, viscosity).

A second filter 26, having a filtration size of 5 microns, is provided downstream of the first filter 23 along the main supply line 19. A damper 27 is provided downstream of the ink pump 21, and downstream of the second filter 26, to reduce fluctuations in ink pressure within the ink supply. Downstream of the damper 27, a load line 28 branches off the main supply line 19. The load line 28 comprises a restriction 29. The load line 28 is configured to maintain a near-constant load on the main supply line 19, avoiding pressure spikes in the print head 3 due to load spikes of the ink pump 21 (e.g. due to activation of the ink pump 21). A viscometer valve 30 is disposed along the load line 28. The viscometer valve 30 can selectively place the load line 28 in fluid communication with either the mixer tank 17, via a tank line 31, or a viscometer 32. The viscometer valve's 30 default configuration is to place the load line 28 in fluid communication with the mixer tank 17. This creates a circular fluid flow path. When it is desired to ascertain the viscosity of the ink mixture in the main supply line 19, and so the load line 28, the viscometer valve 30 is energised to direct the flow into the viscometer 32. Initially the viscometer 32 is empty. By monitoring the time taken to fill and/or empty the viscometer 32, and based upon a known volume of fluid in the viscometer 32, the viscosity of the ink mixture can be ascertained.

Downstream of the damper 27 and the load line 28, a pressure sensor 33 is connected to the main supply line 19 and is configured to monitor the pressure downstream of the ink pump 21. The ink pump 21 may be operated as a constant pressure pump (i.e. the pump is controlled to maintain a constant output pressure). A third filter 34, having a filtration size of 15 microns, is provided downstream of the pressure sensor 33.

The main supply line 19 is configured to carry ink from the ink mixer tank 17, along the umbilical 4, to the print head 3. The main supply line 19 is connected to the print head 3 via a feed valve 35. The feed valve 35 is configured to control the ink supply to the print head 3. Downstream of the feed valve 35 a heater 36 is provided. The heater 36 is used to control the temperature of the ink mixture. Controlling the temperature of the ink mixture reduces the effect that temperature fluctuations could otherwise have on the viscosity of the ink mixture. For example, activation of the heater 36 provides a heating effect which reduces the viscosity of the ink mixture. A temperature sensor 37 is provided downstream of the heater 36. The heater 36 is provided in fluid communication with the nozzle body 143, and so nozzle 144, via a nozzle line 38. The heater 36 preferably maintains the ink mixture at a temperature of at least around 308° K (e.g. ~35° C.).

As described above, ink is fed along the main supply line 19 to the print head 3 via the umbilical 4. Within the print head 3 the ink is provided to the nozzle 144. The ink is provided to the nozzle 144 under pressure (under the influence of the ink pump 21) and forms an ink jet. The ink jet begins as a constant stream of ink and, under the influence of surface tension and vibrations applied in the nozzle body 143 (e.g. by a piezoelectric oscillator), gradually separates into a series of ink droplets 188 which continue to travel in the direction of the ink jet 57.

Shortly after emerging from the nozzle 144 of the nozzle body 143, the ink jet is passed through a charge electrode (not shown in FIG. 9, but labelled 148 in FIG. 3). The point at which the continuous ink jet separates into droplets 188 is arranged to occur within the charge electrode. The ink is an electrically conductive liquid, and the nozzle body 143 is conventionally held at a fixed (e.g. ground) potential. A variable voltage is applied to the charge electrode (not shown in FIG. 9, but labelled 148 in FIG. 3) causing charge to be induced on the continuous stream of ink droplets extending from the nozzle body 143 towards the charge electrode. As the continuous stream of ink (i.e. ink jet) separates into droplets 188, any charge induced on the ink within the droplet becomes trapped at the moment the individual droplet “snaps” off from the main stream of ink. In this way, a variable charge can be applied to each of the ink droplets within in the stream of ink droplets 188.

The stream of ink droplets 188 then continues to pass from the charge electrode between further electrodes (not shown in FIG. 9, but labelled 166, 168 in FIG. 3). A first electrode (e.g. a low voltage electrode) is held at a first voltage, whereas the second electrode (e.g. deflection electrode) is held at second voltage, with a large potential difference (e.g. 8-10 kilovolts) established between the electrodes. In some systems, one electrode may be maintained at a ground potential while the other electrode is held at a high (positive or negative) voltage (with respect to ground). In other systems, one electrode is held at a negative voltage (with respect to ground) and the other electrode is held at a positive voltage (with respect to ground). The electric field established between the electrodes causes any charged droplets (i.e. those that have been charged by the charge electrode) to be deflected. In this way, based upon the variable charge applied by charge electrode, the droplets 188 can be selectively (and variably) steered from the path along which they are emitted from the nozzle 144.

Droplets which pass through the deflection field and which are deflected by the electrodes are not shown in FIG. 9, but are labelled 190 in FIG. 7. The stream of droplets 190 are used for printing. The stream of ink droplets 190 may be described as defining an ink path across the rotatable body (of the sealing mechanism) and through the ink aperture.

Returning to FIG. 9, droplets which pass through the deflection field without being deflected (i.e. droplets which are not used for printing) travel to a gutter 40 (e.g. the gutter block 182 of the earlier Figures). The gutter 40 comprises an orifice 183 (e.g. gutter aperture 183 of the earlier Figures) into which the droplets enter. The gutter 40 is connected to a gutter line 42 which extends from the gutter 40 back to the main ink block 11 (e.g. the gutter line 42 extends between at least the gutter 40 and the gutter pump 46). A gutter valve 44 is optionally provided within the gutter line 42 enabling the gutter line 42 to be opened and closed. A suction force is applied to the gutter line 42 by a gutter pump 46 to draw ink along the line from the gutter 40 back towards the main ink block 11. In other embodiments the suction may be provided by a Venturi in communication with the ink pump 21.

Downstream of the gutter pump 46 a tank valve 48 is provided. The tank valve 48 selectively places the gutter pump 46 in fluid communication with either the mixer tank 17 or a solvent tank 50. The solvent tank 50 may be described as a ‘used’ solvent reservoir insofar as it contains solvent which is not fresh. In the illustrated embodiment, the solvent tank 50 is provided adjacent the mixer tank 17. The solvent tank 40 and mixer tank 17 are shown as different compartments within an overall tank in the illustrated embodiment, but in other embodiments the mixer and solvent tanks 17, 40 could be physically separate tanks. During printing operations, the tank valve 48 places the gutter pump 46 in fluid communication with the mixer tank 17. The ink mixture (e.g. the stream of ink droplets 188) received by the gutter 40 is thus returned to the mixer tank 17 and can be recirculated/reused at a later time. During non-printing operations (e.g. such as priming, cleaning operations etc.), the tank valve 48 may place the gutter pump 46 in fluid communication with the solvent tank 50. This is to avoid cleaning fluid, such as ‘used’ solvent, undesirably contaminating (e.g. altering the viscosity of) the ink mixture in the mixer tank 17.

In addition to unprinted droplets of ink being recirculated via the gutter 40, any air which is sucked into the gutter 40 will also be delivered to the mixer tank 17 or solvent tank 50. The mixer tank 17 and solvent tank 50 are in communication with one another via a condenser 52 (which also acts as a vent). Solvent in the ink mixture in the mixer tank 17 tends to evaporate as solvent vapour in the mixer tank 17. Saturated solvent vapour is therefore present in the mixer tank 17 during use. As said vapour passes over the condenser 52, the comparatively cool surfaces of the condenser 52 result in the solvent, contained in the vapour, condensing. The solvent vapour thus returns to liquid, and is deposited back into the solvent tank 50. This advantageously avoids undue loss of solvent from within the system (which would otherwise occur if both tanks were vented directly to atmosphere). Furthermore, the mixer tank 17 is effectively vented by the condenser 52, preventing excess pressure building up within the mixer tank 17. Gases vented from the mixer tank 17 thus travel into the solvent tank 50. In turn, the solvent tank 50 is vented by a solvent tank vent line 54 provided in fluid communication with the solvent tank 50. Through solvent tank vent line 54 gases can be vented, preferably to outside of the printer cabinet (in which the ink system is contained).

The ink system, specifically the cartridge module 12 thereof, comprises an ink cartridge connection 56 which may be connected to the associated ink cartridge 8 and a solvent cartridge connection 58 which may be connected to the associated solvent cartridge 10. The ink cartridge 56 and ink cartridge connection 58 are connected to the refill line 25, allowing ink or solvent to be drawn, by the Venturi line 24, into the mixer tank 17. In other embodiments, a dedicated transfer pump may be used instead of the Venturi line 24.

By using a Venturi in this way (i.e. as a jet pump), a system can be designed in which the main system ink pump 21 can generate both positive pressures (e.g. to supply ink to the print head 3) and negative vacuum pressure (e.g. to draw ink or solvent into the mixer tank 17 via the refill line 25).

The feed valve 35, provided along main supply line 19, is configured to prevent the main supply line 19 from being continuously open. However, since the feed valve 35 is provided downstream of the Venturi line 24, even when the feed valve 35 is closed, when the ink pump 21 is operating, a flow of ink will flow along Venturi line 24 through the Venturi 24a, resulting in suction being applied to the refill line 25. In this way, the suction can be applied even when ink is not being supplied to the print head 3. Of course, a second valve 61 may also be operated to block the refill line 25, meaning that the refill line suction can be controlled independently of the Venturi 24a.

It will be appreciated that by selectively activating one or more of four cartridge valves 60, 61, 62, 63, the ink cartridge 56 can be placed in fluid communication with the refill line 25. For example, opening only first and second valves 60, 61 (and closing third and fourth valves 62, 63) places the ink cartridge 8 in fluid communication with the refill line 25 via an ink refill line 59. Ink can thus be drawn into the mixer tank 17, via the ink refill line 59 and refill line 25, to add ink to the mixer tank 17.

Solvent can be directed to the solvent tank 50, directly from the solvent cartridge 58, by the solvent refill line 64 and a solvent tank line 65. Closing the first and second valves 60, 61, and opening third and fourth valves 62, 63, places the solvent cartridge 10 in fluid communication with the solvent tank 50 via the solvent tank line 65 and the solvent refill line 64. Solvent can also be drawn from the solvent tank 50, through the solvent tank line 65 and into the cleaning module inlet line 72 (which will be described below). A solvent tank refill line filter 66 is provided along the solvent tank refill line 64. The solvent tank 50 and the solvent cartridge 10 are examples of a cleaning fluid supply. The cleaning fluid may be fresh cleaning fluid (e.g. solvent which has not been used before, from the solvent cartridge 10) or used cleaning fluid (e.g. solvent which has been used before, from the solvent tank 50).

A solvent pump 67 is provided downstream of the solvent cartridge 10 along the solvent refill line 64. Activation of the solvent pump 67 can be used to pump solvent from the solvent cartridge 10 into the solvent tank 50. Advantageously, the amount of solvent added to the solvent tank 50 can be measured by determining the fluid level within the solvent tank 50. This volume can then be subtracted from a remaining solvent cartridge volume held on a smart chip on the solvent cartridge 10. The remaining volume of solvent in the solvent cartridge 10 can thus be ascertained. This has been found to be more accurate than measuring the volume of solvent drawn out of the solvent cartridge 10 under a negative pressure (owing to the vacuum level within a cartridge generally changing as the cartridge is evacuated of fluid). In the illustrated embodiment, solvent is pumped out of the solvent cartridge 10 under action of the solvent pump 67. In embodiments where solvent is drawn directly from the solvent cartridge 10 (e.g. for cleaning), the above-described method can also be used to ascertain the remaining volume of solvent in the solvent cartridge 10 with the difference that the solvent take a different fluid path. For example, rather than being drawn into the solvent tank 50 via a solvent tank line 65, solvent is drawn into the solvent tank 50 via the print head 3 (e.g. via a flush line 70, cleaning module inlet line 72, first or second conduits 204, 214, the chamber 164, the gutter line 42 or purge line 74).

When it is desired to add solvent to the mixer tank 17, second and fourth valves 61, 63 are opened, and first and third valves 60, 62 closed. Solvent is then drawn from the solvent reservoir 50, via solvent tank line 65 and refill line 25, by Venturi 24a, into the mixer tank 17.

Activation of the solvent pump 67 can also be used to pump solvent from the solvent cartridge 10, along the solvent refill line 64, for some non-printing operations, such as priming the fluid circuit. This will be described below. The solvent pump 67 is not used to actively pump pressurised cleaning fluid (e.g. solvent) into the chamber 164, via the cleaning module inlet line 72, for cleaning in the illustrated embodiment. Instead, cleaning fluid is preferably drawn into the chamber 164 under vacuum for cleaning. This provides failsafe operation, should the sealing mechanism fail, in that the cleaning fluid will just not be drawn into the chamber 164. Were the cleaning fluid pumped into the chamber 164 under pressure (e.g. under action of an upstream pump), failure of the sealing mechanism risks cleaning fluid being ejected from the print head 3 (e.g. via the ink aperture) onto the printing line. This risks undesirable contamination. That said, cleaning fluid could equally be pumped into the chamber in some embodiments.

A non-return valve 68 is provided downstream of the solvent pump 66, along the solvent refill line 64, to prevent fluid travelling past the non-return valve 68 towards the solvent pump 66. A further non-return valve 69 is provided in a branch line which extends around the solvent pump 67. The non-return valve 69 is an overpressure valve for the solvent pump 67. The non-return valve 69 is a pressure relief valve which determines a maximum solvent pressure from the solvent pump 67. For completeness, the cartridge valves 60-63 can also be selectively activated to provide other configurations for, for example, priming of the fluid system and for draining the mixer tank 17 and/or solvent tank 50 (e.g. during maintenance).

A flush line 70 is connected between the third valve 62 and the non-return valve 68. The flush line 70 directly connects the cartridge module 12 to the print head 3 via the umbilical 4. A flush filter 71 is provided along the flush line 70, upstream of a cleaning module inlet line 72 which branches off the flush line 70. The flush line 70 extends to the print head 3 via a flush valve 73 disposed along the flush line 70. The flush line 70 is used to route solvent from the solvent cartridge 58 into the nozzle body 143. Solvent can thus be forced through the nozzle 144 to clean the nozzle. This is by way of activating the solvent pump 67, which provides pressurised solvent to the nozzle 144 for nozzle cleaning. The flush valve 73 is closed by default (e.g. during printing operations) and is only opened during non-printing operations (e.g. priming). Solvent can be prevented from being pumped into the chamber 164 via the cleaning module inlet line 72 by selective activation of valves in the cleaning module 13. Put another way, the cleaning module inlet line 72 can effectively be closed, so that solvent flows through the flush line 70 to the flush valve 73, by selective activation of valves in the cleaning module 13. In other embodiments the cleaning module inlet line 72 may branch off of the solvent refill line 64 (e.g. between the solvent cartridge 10 and the solvent pump 67). In such embodiments, the non-return valve 68 may be omitted.

A purge line 74 is connected to the nozzle body 143. The purge line 74 is connected to a purge port 74a of the nozzle body 143. The nozzle body 143 may be provided as part of a nozzle assembly, which includes the nozzle body 143 having known acoustic properties, and a piezoelectric oscillator. The purge port may be provided by the body, or by a separate part connected to the body. The purge line 74 allows ink (and/or air and/or debris) to flow (or pass) out of the nozzle body 143 via a purge aperture 74a (e.g. a purge port) without passing through the nozzle 144, and allows the nozzle body 143 to be cleaned. The purge line 74 extends from the nozzle body 143, along the umbilical 4, and returns ink (or solvent), depending upon the phase of operation, to the mixer tank 17. The purge line 74 is provided in selective fluid communication with the gutter pump 46, via purge valve 75. Fluid is drawn through the purge line 74 by suction of the downstream gutter pump 46. A purge valve 75 is provided along the purge line 74. It will be understood that the purge line is not essential, and may be omitted in some printers. The incorporation of the purge line 74 is advantageous for a number of reasons. The purge line 74 can be used to remove air from the nozzle body 143 (e.g. from within a chamber of the nozzle body 143). Removal of air from the nozzle body 143 is desirable because the presence of air can negatively impact the acoustic performance of the nozzle body 143. The purge line 74 can also be used to remove debris that may become trapped in the nozzle chamber when a backflush is carried out. A backflush refers to a process in which solvent is applied to a front face of the nozzle 144 whilst a vacuum is generated in the nozzle body. The purge line 74 also allows ink to be removed/drained from the interior of the nozzle body 144, and the interior of the nozzle body 144 washed, more effectively.

The main supply line 19, purge line 74, gutter line 42, and flush line 70 thus connect the ink system (e.g. the main ink block 11 and cartridge block 12) to the print head 3. Additional fluid connections housed within the umbilical 4 may connect the ink system 5 to the print head 3. For example, an air recirculation line may be provided to provide solvent saturated air to the gutter line 42 close to the gutter entrance.

The chamber 164 is also schematically indicated in FIG. 9. As indicated in FIG. 9, the gutter 40 is disposed in the chamber 164 in the illustrated embodiment. The nozzle body 143 is outside of the chamber 164 in the illustrated embodiment. Two conduits 204, 214 are shown connected to the chamber 164. The first conduit 204 is also shown in FIG. 8. The first conduit 204 is in fluid communication with the chamber 164 via the first port 206. The first port 206 is disposed proximate the charge electrode and nozzle body 144(e.g. at an upstream location within the chamber 164). The second conduit 214 is in fluid communication with the chamber 164 via the second port 202. The second port 202 is disposed proximate the gutter 40 (e.g. the gutter block 183 in FIG. 6). The second port 202 is disposed at a downstream location within the chamber 164. The first and second conduits 204, 214, and so first and second ports 206, 202, can be used to supply the chamber 164 with cleaning fluid or to drain used cleaning fluid from the chamber 164. The first and second conduits 204, 214, and so first and second ports 206, 202, can be used to supply the chamber 164 with air (e.g. for drying the chamber or for pressure balancing during printing). Each of the first and second conduits 204, 214 can be selectively opened/closed by action of corresponding valves of the cleaning module 13. Of note, the pressure balancing mentioned above also encompasses supplying air at a higher flowrate (e.g. >1 litre/min) than the gutter consumes (~200 cc/min). As described elsewhere, this reduces the risk of dust/contamination ingress into the print head when located in situ on a production line.

Also shown in FIG. 9 is a third conduit 216 which extends from the first conduit 204 to, and partway through, the nozzle body 143. The third conduit 216 may therefore be described as a branch of the first conduit 204. The third conduit 216 terminates at a third port 217. The third port 217 is defined in a front face of the nozzle body 143. The third conduit 216 and third port 217 are optional features of the illustrated embodiment, and may be omitted in other embodiments. The third conduit 216, and corresponding third port 217, is used to supply at least part of the charge electrode, and so downstream chamber, with cleaning fluid or to drain used cleaning fluid from the at least part of the charge electrode and chamber 164 (or provide a supply of air). By virtue of being a branch of the first conduit 204, the third conduit 216 is not independently controllable of the first conduit 204 in the illustrated embodiment. Described another way, in the illustrated embodiment, when cleaning fluid is supplied through the first conduit 204, cleaning fluid is ejected from both the first port 206 (into the chamber 164) and the third port 217 (into at least part of the charge electrode). Similarly, where used cleaning fluid is drained through the first conduit 204, cleaning fluid is drained from the chamber 164 (through the first port 206) and from at least part of the charge electrode (via the third port 217). In some orientations (e.g. vertically upwards) of the print head 3, and so chamber 164, used cleaning fluid can be drained through both the first and third ports 206, 217. Advantageously, the first port 206 drains fluid from the chamber 164, whilst the third port 217 drains fluid from the charge electrode. Incorporation of the third port 217 thus avoids an accumulation of used cleaning fluid outside of the chamber 164 which could otherwise undesirably increase the drying time of the print head 3 following cleaning. However, in other embodiments one or more valves may be incorporated along the first and/or third conduits 204, 216 to provide independent control.

Turning to describe components of the cleaning module 13, first to fourth control valves 80, 81, 82, 83 are provided. Also extending at least partway through the cleaning module 13 is an air line 84, with an air pump 85 provided along the air line 84. The air line 84 is connected to atmosphere in the illustrated embodiment. The air line is therefore an example of an air supply. A pressure release valve 86 is also provided downstream of the air pump 85. The air line 84 is connected to atmosphere and can be used to selectively supply the chamber 164 with air. This can be used for either positive pressure drying of the chamber 164 (e.g. after cleaning) or to provide a supply of air to within the chamber 164 during printing. This is to avoid an excessive negative pressure being generated within the chamber 164 due to the suction of the gutter pump 46 via the gutter 40, which could otherwise result in debris being drawn into the print head 3 from the printing line. Advantageously the single air pump 85 provides both functionalities. The air pump 85 is preferably a variable speed air pump. Advantageously, the flow rate of air pumped into the print head, optionally the chamber 164, during printing operations can be comparatively lower than the flow rate of air pumped into the cleaning chamber during cleaning. This provides a swift cleaning time without unduly disrupting the ink droplets ejected by the nozzle during printing operations. Put another way, the flow rate of the positive air pump can be reduced to reduce the risk of disturbing the stream of ink droplets in flight due to excess turbulence.

A downstream portion of the cleaning module inlet line 72, which may be referred to as an inlet line 72 for brevity, is also shown. The break in the inlet line 72 between the left hand side of the Figure (i.e. above the filter 71) and the right hand side of the Figure (i.e. above the air pump 85) is simply included to improve the clarity of the Figure, and to avoid the line extending across the various other components of the fluid circuit. A draw line 87 is also shown. The draw line 87 extends to the gutter pump 46 via part of the gutter line 42. Fluid can therefore be drawn through the draw line 87 by operation of the gutter pump 46. For completeness, the tank valve 48 also forms part of the cleaning module 13 in the illustrated embodiment. However, in other embodiments the gutter valve 48 could form part of the main ink block 11.

The first control valve 80 can selectively place the first conduit 204 (via a second control valve 81) in fluid communication with the inlet line 72 or the air line 84. The other of the inlet line 72 and the air line 84 can be selectively closed by the first control valve 80.

The second control valve 81 can selectively place the first conduit 204 in fluid communication with the draw line 87 or the inlet line 72 (via the first control valve 80) or the air line 84 (via the first control valve 80). In the configuration shown in FIG. 9, the second control valve 81 places the first conduit 204 in fluid communication with the draw line 87. Activation of the gutter pump 46 thus applies suction through the draw line 87 and through the first conduit 204. In this configuration, fluid would be drawn from the chamber 164 through the first conduit 204 and draw line 87. In the configuration shown in FIG. 9, the first conduit 204 is not provided in fluid communication with either of the inlet line 72 and the air line 84.

The third control valve 82 can selectively place the second conduit 214 in fluid communication with the draw line 87 or the inlet line 72 (via the fourth control valve 83) or the air line 84 (via the fourth control valve 83). In the configuration shown in FIG. 9, the third control valve 82 places the second conduit 214 in fluid communication with the draw line 87. Activation of the gutter pump 46 thus applies suction through the draw line 87 and through the second conduit 214. In this configuration, fluid would be drawn from the chamber 164 through the second conduit 214 and draw line 87. In the configuration shown in FIG. 9, the second conduit 214 is not provided in fluid communication with either of the inlet line 72 and the air line 84.

The fourth control valve 83 can selectively place the second conduit 214 (via the third control valve 82) in fluid communication with the inlet line 72 or the air line 84. The other of the inlet line 72 and the air line 84 can be selectively closed by the fourth control valve 83.

By selective operation of the control valves 80-83, different conduits/ports can be placed in fluid communication with the inlet line 72, air line 84 and draw line 87. When connected to the inlet line 72, cleaning fluid can be directed through the conduits/ports into the chamber 164. When connected to the air line 84, air can be pumped through the conduits/ports, by the air pump 85, into the chamber 164. When connected to the draw line 87, fluid (e.g. used cleaning fluid) can be drawn from the chamber 164, through the conduits/ports, through the draw line 87 by gutter pump 46. The air line 84 can be used to pump air into the chamber 164 to dry the chamber 164 after cleaning fluid has been drawn into, and drawn out of, the chamber 164. The air line 84 can also be used to pump air into the print head 3 (e.g. into the chamber 164) to replenish the air removed from the chamber 164 under action of the gutter 40 (e.g. during printing operations). This advantageously reduces the risk that the pressure within the print head 3 reduces to such a level that debris is drawn into the print head 3 from outside the print head 3.

In preferred embodiments, one of the first and second conduits 204, 214 is placed in fluid communication with the inlet line 72, and the other of the first and second conduits 204, 214 is placed in fluid communication with the draw line 87. Activation of the gutter pump 46 then draws cleaning fluid through the inlet line 72, into the chamber 164 via the conduit connected to the inlet line 72. The cleaning fluid is then drawn back out of the chamber 164, via the other conduit (e.g. whichever of the first or second conduits 204, 214 is not connected to the inlet line 72), under suction of the gutter pump 46 via the draw line 87. The cleaning fluid is preferably drawn back out of the chamber 164, via the same conduit (e.g. whichever of the first or second conduits 204, 214 was connected to the inlet line 72), under suction of the gutter pump 46 via the draw line 87. The selection of which port is a fill port, and which port is a drain port, can be based upon the orientation of the print head 3, and so chamber 164.

In preferred embodiments cleaning fluid is left in/resides in the chamber 164 for a dwell time before subsequently being drawn out/drained. Air may be bubbled through the chamber 164, whilst it is at least partly filled with cleaning fluid, to agitate the cleaning fluid and dislodge debris within the chamber 164. The chamber 164 may be only partially filled with cleaning fluid (e.g. around half full). The chamber 164 may be majority filled with cleaning fluid (e.g. at least around 80% of the chamber 164 volume filled with cleaning fluid). The chamber 164 may be partly filled with cleaning fluid in combination with, or in isolation of, air being bubbled through the chamber 164.

Turning to FIG. 10, a perspective view of the sealing mechanism 124 with the rotatable body in the second, closed configuration is provided.

FIG. 10 shows the rotatable body 122 rotatably mounted within the casing 170 and rotatable about the axis of rotation 126. As mentioned, in FIG. 10 the rotatable body 122 is shown in the second, sealed configuration. In the second configuration the rotatable body 122 closes the ink aperture 171 of the casing 170. Rotation of the rotatable body 122 is driven by the motor (not shown in FIG. 10) via the worm gear 130 comprising the worm 132 coupled to the shaft (not shown in FIG. 10) and the gear 134 rotatably coupled to the rotatable body 122. FIG. 10 also shows a shaft adapter 218 which is rotatably coupled to the worm 132 at one end and is coupled to the shaft (again, not shown in FIG. 10) at the other end. The worm 132 and shaft adapter 128 are rotatable about the axis of rotation 129.

FIG. 10 also shows the cap 172 which is coupled to, and forms part of, the casing 170, with the rotatable body 122 and gear 134 in situ, to axially constrain the rotatable body 122 and gear 134 about the axis 126.

FIG. 10 also shows the gutter block 182. As previously described, the gutter block 182 is fixedly attached to the chamber housing 162 (not shown in FIG. 10) and does not rotate with the rotatable body 122. The sealing mechanism 124 can be removed from the overall print head assembly whilst the gutter block 182 remains in situ, coupled to the chamber housing. The relationship (e.g. alignment) between the gutter block 182 (e.g. aperture 183), the nozzle 144 and the stream of ink droplets can thus be maintained despite removal of the sealing mechanism 124 (e.g. despite disassembly and subsequent reassembly). The gutter block 182 comprises the gutter aperture 183. The gutter aperture 183 is defined on a gutter arm 185. The gutter arm 185 projects from a main body of the gutter block 182. By providing the gutter aperture 183 on the gutter arm 185, a bulk of the gutter block 182 can be positioned away from the rotatable body 122 whilst the gutter aperture 183 (by virtue of the gutter arm 185) is still disposed within the recess 123 of the rotatable body 122. This means that when the rotatable body 122 is in the open configuration, an ink path can still be defined across the rotatable body 122 in a region which is not obscured by the gutter arm 185. Owing to the geometry of the recess 123, and rotatable body 122 more generally, the rotatable body 122 may be described as a half-shaft. The rotatable body 122 may be said to swing under a transverse gutter (e.g. specifically under gutter arm 185). Dowels 187a, 187b are received in corresponding recesses of the gutter block 182 to facilitate locating the gutter block 182 with respect to the casing 170. The dowels 187a, 187b also assist with aligning the gutter aperture 183 with the stream of ink droplets (which are not used for printing) in use.

Seals 213, 220 (which take the form of O-rings in the illustrated embodiment) are seated within recesses in the gutter block 182. The seal 213 corresponds to that shown in FIG. 8 and seals a connection between the gutter conduit 196 defined in the gutter block 182 and the return conduit 212 defined in the chamber housing 162.

Returning to FIG. 10, the seal 220 surrounds an aperture 222 which is configured to receive a fastener to couple the gutter block 182 to the chamber housing. FIG. 10 also shows part of the recess 200 defined in an effective underside of the gutter block 182 as oriented in FIG. 10. As partly described in connection with FIG. 6, the recess 200 leads into the port 202 (not shown in FIG. 10) which, in turn, defines the second conduit 214 shown in FIG. 9. It will be appreciated that, owing to the presence of the recess 200, the second conduit 214 is still provided in fluid communication with the chamber even when the rotatable body 122 is in the second, closed configuration as shown in FIG. 10. Cleaning fluid can therefore be pumped or drawn into the chamber via the second conduit, or used (e.g. dirty) cleaning fluid be pumped or drawn out of the chamber via the second conduit 214. Described another way, the second conduit 214 defines part of a pathway for supplying cleaning fluid or draining used cleaning fluid from the chamber. The casing 170 of FIGS. 10 and 11 is shown in a partially cutaway view in that various components (e.g. the ink aperture 171 and gear 134) which would normally be obscured in these views are visible.

Turning to FIG. 11, a perspective view of the sealing mechanism 124 shown in FIG. 10 is provided with the rotatable body 122 in a first configuration. Some components shown in FIG. 10 (e.g. dowels 187a, 187b) are omitted in FIG. 11. In contrast to the position of the rotatable body 122 in FIG. 10, in FIG. 11 the rotatable body 122 is rotated by around 90° about the axis of rotation 126 in a generally anti-clockwise direction from the FIG. 11 perspective. As such, an abutment surface 123a of the rotatable body 122 is disposed along an extent of the gutter arm 183 in FIG. 11. Given this rotational position of the rotatable body 122, an ink path is defined across the rotatable body 122 and through the ink aperture 171. Described another way, the chamber is provided in communication with atmosphere via the ink aperture 171. A stream of ink droplets for printing can therefore be ejected from the print head 3 and applied to a substrate moving past the print head 3. This is in contrast to the FIG. 10 configuration in which the chamber is sealed so that cleaning fluid can be pumped or drawn through the chamber to clean it.

Using the sealing mechanism 124 of FIGS. 10 and 11, the chamber can be selectively sealed to carry out methods associated with the print head 3 and printer 1 more generally.

Although the rotatable body 122 is rotated by around 90° about the axis of rotation 126 between the first and second configurations, this range of motion may be different in other embodiments. To place the rotatable body 122 in the second configuration, the rotatable body 122 only need be rotated far enough to cover the ink aperture 171. It will be appreciated that this rotational movement is influenced by a diameter of the rotatable body 122 and a width of the ink aperture 171.

A method of sealing the print head 3 comprises rotating the rotatable body 122 from a first configuration (e.g. as shown in FIG. 11), in which the chamber is in communication with atmosphere via at least the ink aperture 171, to a second configuration in which the chamber is sealed by the rotatable body 122 (e.g. as shown in FIG. 12). Even when sealed, with reference to FIG. 9, the chamber 164 may be in communication with conduits such as the first and second conduits 204, 214.

A method of cleaning the print head comprises sealing the print head as set out above, and directing (e.g. pumping or drawing) cleaning fluid into the chamber to clean the chamber. Cleaning fluid, which may be solvent, is preferably drawn into the chamber 164 via the first or second conduits 204, 214. Used cleaning fluid is preferably drained from the chamber 164 via the same one of the first and second conduits 204, 214, preferably after a short dwell period (e.g. 5 seconds). Cleaning fluid may be actively pumped or drawn through the chamber 164 (e.g. simultaneous, or contemporaneous, filling and draining), or cleaning fluid may be retained in the chamber 164, in a stagnant manner, for a period of time. Each of first and second conduits 204, 214 is preferably bidirectional insofar as cleaning fluid can be pumped or drawn through them, into the chamber 164, and/or used cleaning fluid can be drained from the chamber 164 through the conduits 204, 214. In other embodiments cleaning fluid may be drained from the chamber 164 via multiple conduits. It is desirable that air be fed into the chamber 164 as fluid/air is removed/drained from the chamber 164.

By filing the chamber 164 with cleaning fluid, ink particles and other debris, which otherwise risk clogging the chamber 164 and associated components, are removed and transported out of the chamber 164 upon draining. The chamber 164 is thus cleaned, along with any components of the print head which reside within the chamber 164. Such components include the electrodes 166, 168. The chamber 164 may only be part-filled with cleaning fluid.

With reference to FIG. 9, cleaning fluid drained from the chamber 164 is returned to the solvent tank 50. The used cleaning fluid is therefore kept separate from the mixer tank 17 until such a time that the cleaning fluid is used to adjust the viscosity of the ink mixture in the mixer tank 17.

Turning to FIG. 12, a perspective cross-section view of the sealing mechanism 124 is provided as indicated by a cross-section marker 122 in FIG. 10.

FIG. 12 shows the rotatable body 122 in the second, closed configuration. As such, the second portion 164b of the chamber, indeed along with the rest of the chamber (although not shown in FIG. 12), is not in communication with atmosphere via the ink aperture 171. Described another way, no ink path is defined across the rotatable body 122 and through the ink aperture 171. The second portion of the chamber 164b, again with the rest of the chamber, is therefore sealed so that the chamber can be cleaned.

FIG. 12 shows the gutter block 182 received in the recess which defines the second portion 164b of the chamber, and also shows the spatial relationship between the gutter arm 185 and the abutment surface 123a of the rotatable body 122.

With the rotatable body 122 in the second, closed configuration as shown in FIG. 12, it will be appreciated that any surface upstream of (e.g. above, as oriented in FIG. 12) the abutment surface 123a of the rotatable body 122 can be cleaned. Described another way, the abutment surface 123a defines a distal cleaning surface of the print head 3. Of note, with the rotatable body 122 in the second, closed configuration as shown in FIG. 12, walls 224, 226, which at least partly define the ink aperture 171, which are disposed downstream of the rotatable body 122 will not be cleaned in practice.

Turning to FIG. 13, the cross-section view shown in FIG. 12 is shown from a different perspective, with the gutter block 182 omitted, and with the rotatable body 122 in a first, open configuration. An ink path 228 which is defined across the rotatable body 122 and through the ink aperture 171 is also schematically indicated in FIG. 13.

FIG. 13 also shows first and second sealing surfaces 230, 232 of the casing 170 in which the rotatable body 122 is seated in the closed configuration shown in FIG. 12. FIG. 13 also indicates that the rotatable body 122 remains seated at the second sealing surface 232 even in the first configuration. Advantageously, this means that the second sealing surface 232, of the casing 170, is protected from the build-up of ink fur and similar debris even when the ink path 228 is defined across the rotatable body 122 in use. Conversely, the first sealing surface 230 is exposed to the ink path 228 when the rotatable body 122 is in the first configuration shown in FIG. 13. However, the actuation of the rotatable body 122 between the second and first configurations has been found to displace any ink fur build up and effectively swipe clean the first sealing surface 230. Both first and second sealing surfaces 230, 232 are therefore either shielded in operation or are cleaned by swiping action of the rotatable body 122 despite being downstream of the surface 123a of the rotatable body 122 in a second configuration. This is desirable for at least the reason that the first and second sealing surfaces 230, 232 are cleaned, or remain clean, in use.

Turning to FIG. 14, a cross-section side view of the FIG. 13 arrangement is provided. The geometry of the second portion of the chamber 164b is more clearly visible, and the ink path 228 defined across the rotatable body 122 and through the ink aperture 171 is also shown. The arcuate nature of the first and second sealing surfaces 230, 232 is visible in FIG. 14, and the rotatable body 122 is shown to cooperate with these surfaces given the arcuate geometry of the rotatable body 122. First and second walls 224, 226 which define the ink aperture 171 are also labelled, and may be said to define a recessed ink slot 234 in practice. The recessed ink slot 234, owing to being defined downstream of the rotatable body 122 with respect to the ink path 228, is not washed during a cleaning cycle. See, for example, FIG. 12.

As will be appreciated from FIGS. 13 and 14, in the first configuration the recess 123 of the rotatable body 122 overlaps the ink aperture 171 to define the ink path 228 thereacross. Furthermore, the axis of rotation of the rotatable body 122 is generally perpendicular to the ink path 228. This advantageously means that the sealing mechanism 124 does not add an unduly long axial extent to an end of the print head 3 (e.g. does not reduce the throw distance).

Turning to FIG. 15, a perspective view of a sealing mechanism 300, in isolation, according to another embodiment is provided. The sealing mechanism 300 comprises a casing 302 and a rotatable body 304. The rotatable body 304 is rotatable about an axis of rotation 306 between first and second configurations. The rotatable body 304 is shown in a first (open) configuration in FIG. 15.

The casing 302 defines an ink aperture 308. The ink aperture 308 is selectively closeable by the rotatable body 304. The casing 304 also defines an ink channel 309 upstream of the rotatable body 304. FIG. 15 also shows a gutter 310 which defines a gutter aperture 312. In the illustrated embodiment the gutter 310 takes the form of a conduit which terminates at the gutter aperture 312. The gutter 310 is still independent of the rotatable body 304 in this embodiment. The gutter 310 is fixedly coupled with respect to the casing 302, and therefore does not rotate with the rotatable body 122. The gutter 310 extends partway through the ink channel 309.

The rotatable body 304 comprises a recess in the form of an ink slot 314. The ink slot 314 extends through the rotatable body 304 and generally extends in the axial direction with respect to the axis of rotation 306. In communication with the ink slot 314 the rotatable body 304 further comprises a gutter recess 316. As will be appreciated from FIG. 16, the gutter recess 316 is sized to receive the gutter 310, at least partly, when the rotatable body 304 is in a second, closed configuration.

An advantage of the embodiment shown in FIG. 15 is that no sealing surface of the casing 302 is exposed to the ink path whilst the rotatable body 304 is in a first configuration. That is to say, there is no sealing surface forming part of the casing 302 which is exposed to the ink path in use. This is achieved, at least in part, by incorporation of the surface 318 on the rotatable body 304 which extends along an axial extent labelled 320.

A further advantage of the illustrated embodiment is that the rotatable body 304 defines a downstream-most end of the ink path. Described another way, there is no surface of the casing 302 past which the ink path travels once the ink path has travelled through the rotatable body 304. This is advantageous in that more surfaces across which the ink path passes can be cleaned by virtue of the cleaning operation described in this document.

A further advantage is that the gutter 310 is independent of the rotatable body 304. The important alignment of the gutter 310 with respect to the stream of ink droplets is therefore not affected by the position/wear of the rotatable body 304.

Although an optional feature of the illustrated embodiment, the sealing mechanism 300 further comprises rotation limiting features in the form of a pin 322 and slot 324 arrangement. In the illustrated embodiment, the pin 322 is fixed with respect to the casing 302. The slot 324 is defined in the rotatable body 304. The pin 322 is received in the slot 324 such that the rotatable body 304 can rotate about the axis of rotation 306 by a rotational extent defined by the travel of the pin 322 within the slot 324. Advantageously, incorporating such rotational limiting features can be used to reduce the risk that the rotatable body 304 contact, and displace, the gutter 310, and more specifically the gutter aperture 312. In preferred embodiments, the rotation limiting feature may also be an electromechanical feature in that engagement of the pin 322 with an end of the slot 324 (for example) produces a signal indicative of the rotational position of the rotatable body 304. In the illustrated embodiment this is achieved by way of the pin 322 being an electrical contact pin to indicate the position of the rotatable body 304. In other embodiments the pin 322 may act as an electrode and be pulled to ground by the grounded rotatable body 304. Either arrangement can thus provide closed loop feedback for the motor, and improved usability and safety of the overall print head. It will be appreciated that a variety of other rotation limiting features and/or mechanisms may otherwise be used, and various other options of sensing of the rotatable body 304 position may otherwise be employed. It will also be appreciated that rotation limiting features and/or position sensing arrangements may be incorporated in any of the sealing mechanisms disclosed herein.

FIG. 16 shows the sealing mechanism 300 with the rotatable body 304 in the second, closed configuration. In this configuration the rotatable body 304, and the sealing mechanism 300 more generally, seals the ink aperture 308 such that the chamber can be cleaned. The ink channel 309 can also advantageously be cleaned when the ink aperture 308 is sealed. One side of the rotatable body 304 can also be cleaned.

Turning to FIG. 17, a perspective view of a sealing mechanism 400 according to another embodiment is provided. The sealing mechanism 400 shares a number of features in common with the sealing mechanism 300, and only the differences will be described in detail.

The sealing mechanism 400 comprises a casing 402 and a rotatable body 404. Of note, the rotatable body 404 does differ from the rotatable body 300 for reasons which will be described below. The rotatable body 404 is rotatable about the axis of rotation 406 between a first and second configuration. In FIG. 17 the rotatable body 404 is shown in a first configuration in which an ink path is defined across the rotatable body 404 through an ink aperture 408 defined in the casing 402. The casing 402 thus defines the ink aperture 408, selectively sealable by the rotatable body 404, and an ink channel 409 upstream of the rotatable body 404.

A notable difference between the sealing mechanism 400 and the sealing mechanism 300 is that the rotatable body 404 comprises an integral gutter 410. The integral gutter 410 comprises a gutter aperture 412 which is defined in the rotatable body 404 itself. The gutter aperture 412 is recessed with respect to the surrounding surface of the rotatable body 404. This is to protect the gutter 410 from damage as the rotatable body 404 is rotated in use. The recessed nature of the gutter aperture 412 also means that a gap is defined through which fluids can pass (e.g. cleaning fluids or dirty cleaning fluids) such that the gutter aperture 412 can be used as a port to drain the chamber or fill the chamber with cleaning fluid during a cleaning cycle. The gutter aperture 412 can thus function as a drain/filling port for the chamber. The gutter aperture 412 can thus replace the (second) port 202 (see FIG. 9) defined in the chamber. Alternatively, the gutter aperture 412 could provide an additional drain/filling port, for the chamber, in addition to the second port 202. Where the gutter aperture 412 provides an additional drain/filing port, the second port 202 is preferably provided in a different location to the gutter aperture 412. For example, if the gutter aperture 412 were provided proximate a lower side of the chamber 162 shown in FIG. 7, the second port 202 may be provided proximate an upper side of the chamber 162 (but still at the same end of the chamber 162). It will be appreciated that it may be necessary to selectively place the gutter aperture 412 in fluid communication with the solvent tank to avoid the used cleaning fluid being returned to the mixer tank 17.

The rotatable body 404 further comprises an engagement feature 416. In the illustrated embodiment the engagement feature 416 takes the form of a slot. The engagement feature can advantageously be used to unstick the rotatable body 404 if it becomes stuck in use. In other embodiments an alternative engagement feature to the slot, such as a hexalobular slot or a hexagonal recess, could otherwise be used. Alternatively, the engagement feature 416 may be omitted. It will also be appreciated that an engagement feature as described above may be incorporated in any of the rotatable body embodiments described in this document.

The rotatable body 404 further comprises a domed end 418. Domed end 418 opposes the engagement feature 416 in the illustrated embodiment. The domed end 418 tapers into the rest of the rotatable body 404. That is to say, the end of the rotatable body 404 may be described as being defined by a combination of a taper and a dome. Although not visible in FIG. 17, but as will be described in connection with FIG. 19, a gutter conduit extends from the gutter aperture 412 through the rotatable body 404 and through the domed end 418, terminating at an aperture defined in the domed end 418. This defines a fluid pathway by which the gutter aperture 412 can be selectively provided in fluid communication with the rest of the ink system, whether for printing in normal use (e.g. for transporting ink droplets not used for printing back to the mixer tank) or for cleaning or draining. The domed end 418 can advantageously be used to define a sealing interface with a corresponding cooperating surface in, for example, a cap of the casing 402.

Turning to FIG. 18, the sealing mechanism 400 is shown with the rotatable body 404 in a second, closed configuration. In the second configuration shown in FIG. 18 the rotatable body 404 thus closes the ink aperture 408 of the casing 402. FIG. 18 shows the rotatable body 404 further comprises a utility slot 420. The utility slot 420 is in communication with the ink slot 414, the ink slot 414 extending through an entirety of the rotatable body 404. Unlike the ink slot 414, the utility slot 420 does not extend through the entirety of the rotatable body 404. Instead, the utility slot 420 extends only partway through. As indicated by the arrows 422, 424, the combination of the ink slot 414 and the utility slot 420 defines a fluid pathway through which cleaning fluid can be pumped or drawn into the chamber or used cleaning fluid be pumped or drawn out of the chamber via the gutter aperture 412. The utility slot 420 thus allows the gutter 410 to be used as a lowest cleaning/draining port. The gutter 410 can thus also serve as a drain port, draining the chamber through the utility slot 420 even when the rotatable body 404 is in the second configuration. Owing to the gutter aperture 412 being recessed relative to the surrounding surface of the rotatable body 404, the rotatable body 404 can still seal the ink aperture 408 of the casing 402, such that cleaning fluid does not escape from the casing 402 (e.g. around the rotatable body 404) but can still travel through the rotatable body 402.

Turning to FIG. 19, a cross-section side view of the sealing mechanism 400 as shown in FIG. 17 is provided in accordance with the annotated cross-section markers 426 in FIG. 17.

FIG. 19 thus shows a cross-section side view of the sealing mechanism 400 with the rotatable body 404 in a first, open configuration. The ink channel 409 of the casing 402 is thus shown in communication with the ink slot 414 of the rotatable body 404. The ink aperture of the casing 402 is thus opened by the rotatable body 404.

FIG. 19 also shows the utility slot 420 of the rotatable body 404. The gutter 410 is also visible, showing the recessed gutter aperture 412 and gutter conduit 428 extending through the rotatable body 404. The gutter conduit 428 extends from the gutter aperture 412 and through the domed tip 418. The gutter conduit 428 extends between the gutter aperture 412 and a dome aperture 430. The domed tip 418 is incorporated to aid in the sealing of the rotatable body 404 against a corresponding surface which also defines the downstream portion of the gutter conduit 428. For completeness, the gutter conduit 428 may replace the second conduit 214 shown in FIG. 9, or may be retained in addition to the second conduit 214.

For completeness, also annotated on FIG. 19 is a stream of ink droplets 432 which are not used for printing and which are received by the gutter aperture 418. The stream of ink droplets 432 are thus recirculated back to the mixer tank. Also shown is a stream of ink droplets 434 for printing which have been deflected by the deflection electrode and thus pass through the ink slot 414 of the rotatable body 404, and the ink aperture of the casing 402, to be applied to an external substrate. The streams of droplets 432, 434 correspond to the streams 194, 190 respectively as shown in FIG. 7.

Turning to FIG. 20, a perspective view of a sealing mechanism 500 according to another embodiment is provided. The sealing mechanism 500 comprises a casing 502 which shares many of the features in common with the casings 302, 402 shown in FIGS. 15 to 18. The rotatable body 504 is rotatable about the axis of rotation 506. In this embodiment the rotational body 504 is a generally cylindrical rotatable body. The rotatable body 504 comprises an ink slot 510. As shown in FIG. 20, the rotatable body 504 is in a first configuration in which an ink path is defined through the ink channel 509 of the casing 502, across the rotatable body 504 and through the ink aperture 508 of the casing 502. In a second configuration (not shown in FIG. 20) the rotatable body 504 is rotated about axis 506 by around 90° such that the ink slot 510 does not overlap the ink aperture 508 of the casing 502. An ink path is thus not defined across the rotatable body 504 and through the ink aperture 508 in the second configuration, the ink aperture 508 is closed.

The rotatable body 504 shown in FIG. 20 may be described as being based upon a ball valve with a cylindrical stem.

Turning to FIG. 21, a cross-section plan view of the sealing mechanism 500 shown in FIG. 20 is provided about the cross section marker labelled 512 in FIG. 20. FIG. 21 thus shows the alignment of the ink slot 510 of the rotatable body 504 with the ink channel 509 of the casing 502 and the ink aperture 508 of the casing 502 to define an ink path 514 thereacross. When disposed downstream of a chamber, the chamber is in communication with atmosphere via the ink path 514 when the rotatable body 504 is in the first configuration shown in FIG. 21. The axis of rotation 506 of the rotatable body 504 is also labelled in FIG. 21.

Turning to FIG. 22, the cross-section view of FIG. 21 is shown but with the rotatable body 504 in a second configuration. In the second configuration the rotatable body 504 is rotated about the axis of rotation 506 by around 90° in either a clockwise or anti-clockwise direction. As such, the ink slot 510 of the rotatable body 504 therefore does not align, or overlap, with the ink aperture 508 of the casing 502. The ink aperture 508 of the casing 502 can therefore be said to be closed. The ink channel 509 of the casing 502 can be considered to terminate at the rotatable body 504, as indicated by the path 516, when the rotatable body 504 is in the second, closed configuration. By virtue of the arcuate surface 518 of the rotatable body 504 sealing the ink aperture 508, an upstream chamber can therefore be sealed for cleaning and draining.

An advantage of the sealing mechanism 500 is that the rotatable body 504 defines a downstream-most end of the ink path 514. That is to say, the rotatable body 504 is the last component which ink droplets passing along the ink path 514 pass through before they have left the print head. Described another way, the rotatable body 504 projects from an outermost point of the casing 502 by an extent labelled 520 in FIG. 21 (e.g. projects from an end of the print head by extent 520). By virtue of being able to rotate the rotatable body 504 between the first and second configurations shown in FIGS. 21 and 22 respectively, the portion 522 of the ink path 514, which is defined by the rotatable body 504, can also be cleaned as part of the cleaning process. Either an entirety, or almost an entirety, of the ink path can therefore be cleaned when the sealing mechanism 500 is in the second configuration and cleaning fluid is flushed through the chamber. All contamination that may impinge along the flight path of the ink droplets can therefore be removed during a cleaning cycle. For completeness, the ink slot 510 could be accessed, by cleaning fluid, by virtue of: a utility slot like that labelled 420 in FIG. 18, a channel in the casing 502, or by a gap provided by a reduced diameter of the rotatable body 504 when the ink slot 510 is machined.

All of the sealing mechanisms described above may have the casing, rotatable body, and possibly other components, manufactured from a range of different materials. For example, one or more of the casing and rotatable body may be manufactured from stainless steel. One or more of the casing and rotatable body may be manufactured from a polymer such as PTFE or PCTFE.

The sealing mechanisms described above generally utilise an interference fit, such as by around 100 microns, between the casing and the rotatable body to achieve a seal. In preferred embodiments, an interference fit is between a stainless steel rotatable body and a PTFE bore in the casing in which the rotatable body is received. It will be appreciated that as the interference is increased, the sealing pressure which can be achieved within the chamber is also increased but the torque needed to drive the sealing mechanism is increased. A further problem identified with using dissimilar materials is that there may be differences between the coefficients of thermal expansion which, for example, could cause the seal to relax across the temperature range or for the actuation torque to increase (e.g. in cold temperatures). This could be overcome by manufacturing the rotatable body and the casing from identical materials (e.g. such as zirconia/zirconia) with strict tolerancing (e.g. a 1 micron clearance). However, initial testing has indicated that such tight tolerancing can lead to occasional jamming of the sealing mechanism.

PTFE being a comparatively low coefficient of friction material assists with the easy running of the rotatable body in at least dry conditions. Furthermore, when wet (e.g. such as during cleaning) the PTFE interference fit can also serve to wipe off/prevent ink penetrating a sealing surface which can otherwise cause issues with actuation of the mechanism.

In preferred embodiments both the rotatable body and casing are manufactured from the same material. However, testing has indicated there may be a build-up of charge on an inner surface of a plastic rotatable body, and that incorporation of the ink slot in the rotatable body may lead to a rotatable body which is not sufficiently robust if manufactured from plastic. Issues such as this could be overcome by incorporation of a valve with a PTFE body and a PCTFE shaft which have a similar interference and are rated to sealing pressure. However, it may be difficult to incorporate an ink slot as needed. A solution is therefore to manufacture the casing and rotatable body from stainless steel, and incorporate a PTFE sealing interface therebetween. This may otherwise be described as a sealing layer. An example of this is shown in FIG. 23 for a sealing mechanism 600 which combines a casing 602, a rotatable body 604 and a PTFE sealing interface 605. As the rotatable body 604 rotates about an axis of rotation 606, the PTFE sealing interface 605 provides lower coefficient of friction operation whilst the stainless steel rotatable body and casing 604, 602 maintain robustness and avoid build-up of charge.

A further design modification which can be incorporated to reduce the risk of sealing mechanism stiction, and avoid strict tolerancing requirements, is the incorporation of a tapered rotatable body. This is shown in FIG. 24, which shows a sealing mechanism 700 according to another embodiment. The sealing mechanism 700 is shown normal to a major face of a casing 702 in FIG. 20. The sealing mechanism 700 further comprises a tapered rotatable body 704 which is rotatable about axis of rotation 706. The rotatable body 704 comprises an ink slot 708 which extends therethrough. A sealing interface 705, preferably a PTFE sealing interface, also forms part of the sealing mechanism 700 and is disposed between the casing 702 and the rotatable body 704. As will be appreciated from FIG. 24, the rotatable body 704 is tapered in that a first diameter 710 at one end of the rotatable body is greater than a second diameter 712 at a different position of the rotatable body 704 along the axis of rotation 706. Although the tapering shown in FIG. 24 is linear, the rotatable body may taper in a non-linear manner.

Advantageously, incorporation of the tapered rotatable body 704 and corresponding casing 702 allows for dissimilar expansion of the rotatable body 704 and casing 702, meaning that the casing and rotatable body need not be manufactured from the same materials and tolerances can be relaxed. It has also been found that the tapered mechanism provides a convenient way of unsticking the sealing mechanism 700 should the rotatable body 704 become stuck in use.

Turning to FIG. 25, a perspective view of a print head 800 according to another embodiment is provided. For completeness, the print head 800 shares various features in common with the print head 3 shown in FIGS. 2 to 8, and only the differences relative to the print head 3 will be described in detail. The print head 800 can also be used in the printer 1 of FIG. 1 and in the fluid system shown in FIG. 9 (albeit with a change of location of the heater 36, as will be described below). Equally, the description provided in connection with FIGS. 10 to 24 also applies, where appropriate, to the print head 800. The print head 800 is thus also a self-cleaning print head.

At a first end 802 the print head 800 comprises a connector 804 by which the print head 800 is connectable to the umbilical. At a second end 806 of the print head 800 an end cap 808 is provided. There are a number of differences between the end cap 808 of the print head 800 and the earlier embodiment, which will be described in detail below. However, an ink aperture 810, through which deflected ink is ejected in operation, is still defined through the end cap 808. An outer shell 812 is generally cylindrical and extends along a majority of the print head 800. A sealing cover 814 extends adjacent the outer shell 812, proximate the second end 806 of the print head, and extends around, and slightly beyond, the end cap 808. The combination of the outer shell 812 and sealing cover 814 define an outer cover of the print head 800, the outer cover being removable for maintenance.

Turning to FIG. 26, a perspective view of the print head 800 is provided with the outer shell 812 omitted. As will be appreciated by comparing FIG. 26 with FIG. 3, there are various similarities between the print head 800 and print head 3. Again, only the differences will be described in detail.

Briefly, the print head 800 comprises a chassis 816 to which various other components are mounted. A motor 817, a brushless DC motor in this embodiment, is also mounted to the chassis 816 and drives rotation of a rotatable body as will be described in detail below. In other embodiments an actuator that drives rotation of the rotatable body may otherwise comprise a stepper motor, a linear motor, a solenoid or other suitable actuator. A solenoid valve 818 and valve block 820 are also mounted to the chassis 816. A chamber housing 822 is connected to the chassis 816 and, at the other end, is coupled to a sealing mechanism 824. The sealing mechanism 824 may be described as an example of a cap assembly. Other examples of cap assemblies may not be sealing mechanisms. For example, a non-self-cleaning print head may comprise a cap assembly, but not use a sealing mechanism.

One difference between the print head 800 and the print head 3 can be observed by comparing FIG. 26 with FIG. 5. Unlike the print head 3, in the print head 800 the chamber housing 822 is connected to the chassis 816 and the sealing mechanism 824. That is to say, multiple housing components are eliminated by using the single chamber housing 822. Furthermore, the chamber housing 822 can be detached from the chassis 816, and moved away therefrom, by removing four fasteners, two of which are visible in FIG. 26 and labelled 826, 828 respectively. This is advantageous for at least the reason that various components for which servicing may be of interest (e.g. parts of the sealing mechanism 824) are mounted to the chamber housing 822. These components can also be readily detached from the chassis 816 to facilitate servicing.

Turning to FIG. 27, an alternative perspective view of the print head 800 is provided with the chamber housing 822 also omitted. Various components already described are visible in FIG. 27, along with some further components. A nozzle cradle 830, to which a nozzle body 832 is coupled, is visible in FIG. 27. The nozzle cradle 830 and nozzle body 832 form part of a nozzle assembly 834 (which further comprises a nozzle, not visible in FIG. 27). Part of a charge electrode 860 is also visible in FIG. 27. As will be described in connection with FIG. 29, the charge electrode 860 is coupled to the nozzle assembly 834 (specifically the nozzle body 832 thereof). For reasons which will be described below, in some embodiments the nozzle cradle 830 may be omitted.

The print head 800 further comprises a socket plate 836. The socket plate 836 is coupled to the chamber housing 822, and defines part of a ball joint by which a combined charge electrode and nozzle assembly can be adjusted to align an ink jet with a gutter (the gutter not being visible in FIG. 27, but shown labelled 844 in FIG. 28). The adjustment takes place by way of the nozzle body 832 being adjusted with respect to the (fixed) nozzle cradle 830 (the nozzle cradle 830 being coupled to the chamber housing 822). One such cam fastener is shown in FIG. 28 labelled 833. A second cam fastener is obscured from view in FIG. 28 but is generally located in the underside of the nozzle cradle 830. The combination of the two cam fasteners provides X-Y adjustment of the nozzle body 832, and any coupled components (e.g. the charge electrode), with respect to the nozzle cradle 830. The combined charge electrode and nozzle assembly is also constrained by the ball joint defined by the socket plate 836 (and the charge electrode 860-see FIG. 29).

Returning to FIG. 27, the socket plate 836 also effectively caps one end of a (cleaning) chamber defined by the chamber housing (visible in FIG. 29). Although the socket plate 836 is coupled to the chamber housing 822 by fasteners in the illustrated embodiment, it could otherwise be coupled to the chamber housing 822 using an alternative coupling, such as by ultrasonic welding. In further alternative embodiments, the socket plate 836 may effectively be merged with the chamber housing 822 (e.g. by way of a single-piece moulding). In such embodiments, a combined charge electrode and nozzle assembly is coupled directly to the chamber housing.

Although an adjustment mechanism is shown in the illustrated embodiment, in other embodiments the adjustment mechanism (e.g. the ball joint, the cam fasteners, nozzle cradle etc.) may be omitted. Instead, the alignment of the nozzle, with respect to the gutter, may be set in-factory (e.g. using a jig) and then (permanently) fixed in place (e.g. permanently aligned). This advantageously eliminates the need for the adjustment mechanism whilst still permanently providing alignment of the nozzle (and so jet) and gutter.

Turning to FIG. 28, an alternative perspective view of (part of) the print head 800, in the configuration shown in FIG. 27 (i.e. with some components omitted) is provided. FIG. 28 shows the components located between the socket plate 836 and the sealing mechanism 824 in more detail.

Briefly, FIG. 28 shows a nozzle heater assembly 838 which is coupled to the nozzle body 832. The nozzle body assembly 838 comprises a PCB, thermal fuse and a resistive heater. Advantageously, the nozzle heater assembly 838 can selectively heat ink in the nozzle body 832 (which may be described as a close coupled nozzle heater). Put another way, ink in the nozzle body 832 can be directly heated, in contrast to heating the ink further upstream of the nozzle body 832. This is primarily to improve the control of the viscosity of the ink ejected from the nozzle. Ink viscosity reduces with temperature, so if the ink in the nozzle is colder than expected, it is also thicker than expected. An incorrect viscosity corrective action may be applied (e.g. heating the ink) if the system detects the viscosity is lower than expected. Heating ink in the nozzle body 832 reduces the risk, as has been observed in other implementations, that the ink temperature decreases, between a point of heating and the point of ejection by the nozzle, in certain ambient conditions (owing to the ink being heated at a point further away from the nozzle itself). Improved control of the ink temperature thus results.

The nozzle heater assembly 838, specifically the heater thereof, replaces the heater 36 shown in the fluid circuit of FIG. 9. As such, in contrast to the fluid circuit shown in FIG. 9, for the fluid circuit of the print head of the present embodiment there is no nozzle line between the heater and the nozzle body. Instead, the heater is directly mounted to the nozzle body itself.

FIG. 28 shows a deflection electrode 840 (e.g. a high voltage electrode) and a corresponding low voltage electrode 842 (e.g. a grounded electrode). A combination of the electrodes 840, 842 may be referred to as a pair of deflection electrodes. The gutter 844 is also visible in FIG. 28, the gutter 844 being provided downstream of the pair of deflection electrodes. Of note, the gutter 844 is not coupled to the sealing mechanism 824. As such, the sealing mechanism 824 can be removed whilst leaving the gutter 844 in position (e.g. see FIG. 43).

Also partly visible in FIG. 28 is shaft 846. Shaft 846 is driven by the motor 817, albeit by a gearing arrangement (not visible in FIG. 28). An end of the shaft 846 proximate sealing mechanism 824 comprises a domed tip (e.g. a hex-ball style arrangement in the illustrated embodiment) as shown in isolation in FIG. 42 (labelled 848). Returning to FIG. 28, the domed tip is received by a corresponding socket 850 which forms part of the sealing mechanism 824. The socket 850, in turn, drives a rotatable body to selectively open and close an ink aperture defined by the sealing mechanism 824. Advantageously, the incorporation of the domed tip of the shaft 846 provides a greater alignment tolerance between the sealing mechanism 824 and the shaft 846. This is of particular benefit where the sealing mechanism 824 is detached for servicing, and is then reattached to the rest of the print head 800 following servicing.

Also visible in FIG. 28 is connector block 852. The connector block 852 is coupled to the nozzle body 832 by a fastener 854. The connector block 852 comprises three barbs (one of which is labelled 853). Each barb is connectable to a different fluid line (although in FIG. 28 the barbs are shown without a fluid line connected thereto, for ease of visibility) and provides a different functionality. One barb provides an ink supply to the nozzle body 832, another barb provides a connection to a purge port in the nozzle body 832, and a third barb provides further communication to a third port. The third port is in fluid communication with the chamber, and is incorporated to facilitate draining cleaning fluid from, supplying cleaning fluid to, and providing air to, an internal chamber of the charge electrode. The connector block 852 defines a plurality of channels internally (e.g. one for each barb). Advantageously, by removal of the fastener 854, the connector block 852, with barbs and fluid lines attached, can be decoupled from the nozzle body 832. This is advantageous for reasons of being able to more readily service components of the print head 800 without having to destructibly detach the barbs and fluid lines. Instead, the connector block 852, and connected fluid lines, can be detached from the nozzle body 832 and then re-attached thereto (e.g. in a non-destructible [i.e. modular] manner).

Turning to FIG. 29, a cross-section side view of the print head 800 in the configuration shown in FIG. 26 (i.e. with the outer shell admitted) is provided. The cross-section is taken about the plane 859 schematically indicated in FIG. 26. FIG. 9 shows a (cleaning) chamber 856 within the print head 800.

Beginning from the right hand side of FIG. 29, the nozzle body 832 is shown, as is the nozzle cradle 830. A nozzle 858 is also labelled, the nozzle 858 being defined by a nozzle plate 835. The nozzle plate 835 is, in turn, coupled to the nozzle body 832 by a retaining ring 839. The charge electrode 860 is also visible, the charge electrode 860 being received by a charge electrode mount 862. The charge electrode mount 862 is coupled to the nozzle body 832 by locking ring 864. By virtue of the locking ring 864, the nozzle body 832 and charge electrode 860 are (adjustably) coupled to one another (via the charge electrode mount 862). The coupled charge electrode and nozzle assembly is then received by the socket plate 836. As labelled 866, a ball joint is defined between the charge electrode 860 and the socket plate 836. This provides a degree of adjustment of the (combined) charge electrode and nozzle assembly with respect to the socket plate 836 (to facilitate alignment of the ink jet with gutter 844). For completeness, part of an ink jet is schematically indicated in FIG. 29 and labelled 837.

Of note, a particular advantage is that the nozzle 858 and gutter 844 are both coupled to the chamber housing 822. Put another way, the nozzle 858 and gutter 848 are fixed to the same substructure within the overall print head (the nozzle 858 via the nozzle body 832). The alignment of the nozzle 858 with respect to the gutter 844 can therefore be adjusted (e.g. to align the jet produced by the nozzle 858 with the gutter 844) and these components then fixed in place, without needing further adjustment in the future. Put another way, a single adjustment to align the nozzle 858 with the gutter 848 provides a permanent alignment therebetween. This could be factory-set, whilst still allowing servicing of other components (e.g. the sealing mechanism 824) around the nozzle 858 and gutter 844). As mentioned above, the ball joint 866 defined between the charge electrode 860 and the socket plate 836 provides the aforementioned adjustment of the (combined) charge electrode and nozzle assembly with respect to the gutter 844.

Turning to discuss the chamber 856, like in the previous embodiment the electrodes 840, 842 are disposed in the chamber 856. By virtue of sealing the chamber 856, and at least partially filling the chamber 856 with cleaning fluid, these components can thus be cleaned. Other components which may be cleaned as part of a cleaning cycle include the gutter 844 and rotatable body 844.

A first portion 856a of the chamber 856 is defined by the chamber housing 822. A second portion 856b of the housing 856 is defined by a casing 870. The casing 870 forms part of the sealing mechanism 824. It is with respect to the casing 870 that the rotatable body 864 can rotate to selectively seal the chamber 856 (e.g. by closing an ink aperture defined by the casing 870). The endcap 808 is shown disposed over the casing 870. This will be described in detail in connection with the later figures. The rotatable body 868 is actuated, by shaft 846, via a gearing arrangement generally labelled 872. Again, this will be described in further detail below.

Turning briefly to describe the ports of the chamber 856: the chamber 856 comprises a first port 876 and a second port 874.

The second port 874 is defined by the casing 870. As shown in FIG. 29 the second port 874 is provided in a top left-hand corner of the chamber 856. Part of the first port 876 of the chamber 876 is visible in FIG. 29. The first port 876 comprises a plurality of subports (e.g. 876a, 876b etc.) and is defined by a combination of the chamber housing 822 and the socket plate 836. Specifically, the subports which form the first port 876 (and so the first port 876 more generally) are partly defined by castellations on the socket plate 836. Castellations is intended to mean recesses, or grooves, disposed about a perimeter (e.g. circumferential rim 878). A combination of the castellations, and a frustoconical surface 823 of the chamber housing 822, define the first port 876 (or, put another way, define the plurality of subports). The subports extend in a circular manner (e.g. generally around the nozzle 858, and so ink jet ejected therefrom). The subports are in fluid communication with an annular channel 877. The annular channel 877 is effectively disposed behind the subports in the orientation shown in FIG. 29 (e.g. towards the nozzle 858). The annular channel 877 is also defined by a combination of the socket plate 836 and the chamber housing 822 (specifically the frustoconical surface 823 thereof). The annular channel 877 is, in turn, in fluid communication with a conduit 879 (e.g. corresponding to the first conduit 204 in FIG. 9).

The subports advantageously provide multi-directional drainage and filling of the chamber 856 (e.g. cleaning fluid can be drained from the chamber 856, via the first port 876, with the print head 800 in a wider variety of orientations). A further advantage is that when air is pumped into the print head 800 during operation, to balance a pressure reduction due to the gutter 844 drawing air from within the chamber 856, the annular arrangement of subports reduces disruption to the ink jet by virtue of diffusing air around the jet. This is in contrast to the first port consisting of a single aperture. As will be appreciated from FIG. 29, the first port 876 is (partly) provided at a lower right-hand corner of the chamber 856. The first and second ports 876, 874 are thus diagonally opposed with respect to one another, by virtue of at least one of the subports of the second port 874 diagonally opposing the second port 874. This advantageously provides desirable draining capability, irrespective of the orientation of the print head 800. That said, owing to the first port 876 defining the plurality of subports 876a, 876b etc., providing a wider range of drainage directionality, in some embodiments the first and second ports 876, 874 may not be diametrically opposed with respect to one another.

Like in the print head 3 of the earlier embodiment, a third port is also provided, in fluid communication with the chamber 856 but not in the chamber per se, between the nozzle body 832 and the charge electrode 860. Although not visible in FIG. 29, the third port is defined in an outer face 880 of the nozzle body 832. The third port allows cleaning fluid to drain from within the charge electrode 860 when the print head 800 is in a generally upwards orientation. Fluid within a cavity generally defined between the charge electrode 860 and nozzle body 832 would otherwise remain, owing to the fluid level being vertically beneath the first port 870 (e.g. said fluid could not be drained via the first port 870). That said, like the first embodiment, incorporation of the third port is optional. Also like the first embodiment, the third port is preferably provided in fluid communication with the first port 870 such that the third port drainage/filling functionality mirrors that of the first port 870. Put another way, the first port 870 and third port are preferably provided in fluid communication with a (common) first conduit such that cleaning fluid is contemporaneously filled through, or drained via, the first port 870 and third port. However, again, this is an optional feature and the first and third ports may be independently controllable (e.g. by virtue of connection to separate conduits).

The third port is provided in fluid communication with the charge electrode 860, specifically cavity 861 thereof, via a plurality of castellations 882 defined by the charge electrode mount 862. Only one castellation is labelled 882 in FIG. 29, but the castellations extend in an annular manner around the nozzle 858. The combination of the castellations 882 and the charge electrode mount 862 define a plurality of channels, which generally extend in an axial direction and are distributed in an annular manner. Two such channels are labelled 877a, 877b. These castellations 882, and corresponding plurality of channels 877a, 877b, provide similar advantages to the subports defined by the first port 876, as well as further advantages. For example, solvent exits the plurality of channels generally perpendicularly to the ink jet and can therefore wash the front face of the nozzle 858. Because solvent can be provided to the front face of the nozzle 858, the nozzle 858 can be back flushed to remove debris if a blockage occurs (e.g. solvent drawn from the front face of the nozzle 858 towards, and into, the nozzle body 832). Where air is provided through the third port (e.g. positive air, during printing), the air is diffused through the (downstream) plurality of channels at a lower velocity than it would be through a single port. The air is therefore less likely to influence the ink jet provided by the nozzle 858, and so less likely to affect drop position/print quality (which could otherwise result from undesirable interference with the ink jet). The plurality of channels improve the ability to drain solvent from a wider range of print head orientations/angles (e.g. in comparison to a single port location).

Turning to FIG. 30, a perspective view of the sealing mechanism 824 in isolation is provided. FIG. 30 shows the sealing cover 814, which may be considered to form part of the sealing mechanism 824 (but, equally, may be omitted in some embodiments). As a previously described, the rotatable body 868, only partially visible in FIG. 30, is rotatable with respect to the casing 870 to selectively open and close the ink aperture 810 (e.g. to selectively seal the chamber). A portion 884 of the casing 870 projects through an opening 886 defined by the endcap 808 (see also FIG. 35, in which the end cap 808 and sealing cover 814 are omitted). Returning to FIG. 30, the sealing cover 814 extends around the combination of the casing 817 and the end cap 808.

The casing 870 is manufactured from a polymer. Examples of suitable polymers include: PTFE, PCTFE, polyimide, acetal, nylon, HDPE, PEEK, PPS and other fillers and combinations of these examples. The endcap 808 is manufactured from conductive material (e.g. metal, or metal alloy, or a conductive plastic). Advantageously, the endcap 808 is grounded (e.g. earthed). In operation, the endcap 808 thus provides a dust steering and electrostatic discharge functionality.

Where the print head is used on a printing line and is used to print onto an insulating product (e.g. a PET or polypropylene bottle etc. ,), the products may contact (e.g. rub against) each other, and surrounding plastic guide rails/tracks, and become electrostatically charged. When an ink drop (e.g. from the ink jet) hits these relatively non-absorbent surfaces, charged microdroplets can be formed (e.g. by corona splash detachment) and these can become charged by the static on the surface of the product.

An electric field may be formed between a grounded end of the print head (e.g. manufactured from stainless steel) and the electrostatically charged products on the printing line. This electric field can become concentrated at sharp edges of the print head geometry, which can be particularly detrimental because it can drive contamination to one of the most crucial areas to keep clear (e.g. the ink aperture).

By careful selection of the conductivities of materials used to manufacture the endcap 808 and surrounding components, and by controlling the position of any comparatively sharp edges, the risk of contamination interfering with the ink jet droplets can be reduced or eliminated altogether. In particular, by moving any sharp edges, defined in conductive materials, away from the ink aperture (e.g. 810 in FIG. 30), the field concentration in this region, and so the location that any charged microdroplets are driven to, can be distanced from the ink aperture 810.

By providing the grounded, conductive endcap 808, electrostatic discharge can occur, and dust be steered away from, the ink aperture 810 to reduce the risk of charged microdroplets interfering with the ink jet droplets and/or damage occurring to the gutter. In preferred embodiments, although not shown in FIG. 30, a projecting lip (e.g. a coined periphery) is provided around the opening 886 defined by the endcap 808. The projecting lip is preferably provided with a sharpened edge. This has been found to increase the electrostatic field concentration in the region, and improves the dust steering functionality for the reasons described above.

The endcap 808 may be grounded by connection to another electrically conductive component in the print head 800. For example, the endcap 808 may be grounded by the use of an earth wire, or tag, connected to one or more fasteners which couple the endcap 808 to the sealing mechanism 824. However, other ways of grounding the endcap 808 may otherwise be used.

For the avoidance of doubt, whilst the conductive end cap 808 forms part of the sealing mechanism 824, the use of a conductive end cap in combination with a polymer casing is applicable to a range of different cap assemblies (i.e. not just a sealing mechanism for a self-cleaning print head). For example, the conductive end cap could be used in conjunction with a print head which is not self-cleaning and still provide the above advantages re. dust steering and electrostatic discharge.

Turning to FIG. 31, an alternative perspective view of the sealing mechanism 824 shown in FIG. 30 is provided. FIG. 30 is generally from a chamber-side of the sealing mechanism 824.

Briefly, FIG. 31 shows the socket 850 which receives the shaft (specifically the domed tip thereof) to drive the rotatable body 868. Part of a housing 888 of a gearbox is also visible, and received by the casing 870. A cavity 890, which defines a second portion of the chamber 856, is also labelled. The second port 874 is shown in fluid communication with the cavity 890. Similarly, an aperture 892, in fluid communication with the second port 874 via an internal conduit, is also defined by the casing 870. Dowels which are used to align the casing 870 with respect to the chamber housing, and apertures through which fasteners are received to secure the casing 870 to the chamber housing, are also visible in FIG. 31.

Turning to FIG. 32, a perspective view of the sealing assembly 824 is provided, with the sealing cover 814 omitted. FIG. 32 thus shows more features of the end cap 808 than were previously visible.

The end cap 808 comprises an outer face 898 and a skirt 900. The outer face 898 is generally circular, and defines the opening 886. It will be recalled that it is through the opening 886 that a projecting portion 884 of the casing 870 projects. The skirt 900 is generally annular and extends from the face 898.

Turning to FIG. 33, the end cap 808 is shown in isolation and from a perspective view generally taken from an inner side of the end cap 808. FIG. 33 thus shows the circular face 898 and the annular skirt 900 which extends therefrom. The opening 886 is also visible. Four bosses which receive fasteners to secure the end cap 808 to the casing 870 are also shown.

Turning to FIG. 34, a cross-section side view of the sealing mechanism 824 is provided about a plane schematically labelled 832 in FIG. 32.

FIG. 34 shows the assembly of the casing 870, the end cap 808 and the sealing cover 814. Second port 874 and the cavity 890 defined by the casing 870 are also shown.

A further advantage provided by the metal end cap 808 is that the polymer casing 870 is supported by the end cap 808. The polymer casing 870 may otherwise be liable to creep, which can risk a lack of sealing between the casing 870 and the rotatable body 868. The supporting effect provided by the end cap 808 can be further accentuated by incorporating a projection on the inner surface of the face 898 (e.g. at positions labelled 902, 904, preferably extending in an annular manner). Alternatively, or in combination, an O-ring or other gasket may be incorporated at these same positions 902, 904, to again provide a greater supporting force to the casing 870. Also visible in FIG. 34 is a cap 906 which is coupled to the casing 870 to axially secure the rotatable body 868 to the casing 870. The cap 906 is also visible in FIGS. 35 and 36.

Turning to FIG. 35, a perspective view of the sealing mechanism 824 is provided with the end cap 808 omitted. FIG. 35 thus shows more details of the casing 870.

As previously described, the casing 870 comprises projecting portion 884 through which the ink aperture 810 is defined. The projecting portion 884 is raised with respect to a front face 908 of the casing 870. Four recesses are also provided around the casing 870 for passage of fasteners therethrough. As will be appreciated by comparing FIG. 35 with FIG. 33, the recesses are configured to receive the bosses of the end cap 808 for coupling the end cap 808 to the casing 870.

The cap 906 is coupled to the casing 870 to axially constrain the rotatable body 868 with respect to the casing 870. The cap 906 is coupled to the casing 870 by way of a fastener which is not visible in FIG. 35.

The casing 870 is generally cylindrical in shape. The casing 870 comprises a peripheral lip 910 which extends around the casing 870. The peripheral lip 910 defines a ledge 912 which receives the end cap when installed. See FIG. 32 for an indication of the relative position of the end cap 808 with respect to the casing 870.

Turning to FIG. 36, a perspective view of the sealing mechanism 824 is provided like that shown in FIG. 35, but with the casing 870 shown in a semi-transparent view.

FIG. 36 shows the position of the rotatable body 868 within the casing 870, the rotatable body 868 being rotatable about an axis 867. The rotatable body 868 comprises a recess 869 in a similar manner to the embodiment shown in FIGS. 10 and 11. The gearing arrangement 872 is also partially visible in FIG. 36. The gearing arrangement 872 comprises the gearbox housing 888, a worm 914 and a segmented gear 916. The gearbox housing 888 is receivable in a corresponding cavity of the casing 870. The worm 914 is coupled to the shaft 846 via the socket 850 shown in FIG. 31. The worm 914 is in driving communication with the segmented gear 916 such that the rotation of the worm 914 drives a corresponding, albeit directionally offset, rotation of the segmented gear 916. In turn, the segmented gear 916 is rotationally coupled to the rotatable body 868 such that rotation of the segmented gear 916 drives rotation of the rotatable body 868. As previously described, the cap 906 is also shown locating the rotatable body 868 in the axial direction. The cap 906 also constrains the gearing arrangement 872 by securing the gearbox housing 888 in a cavity of the casing 870 (via the rotatable body 868—see also FIG. 31). The worm 914 and segmented gear 916 are shown in detail in FIG. 37.

As described elsewhere in this document, one or more of the rotatable body 868 and casing 870 may comprise a sealing collar to aid the seal therebetween. For example, the rotatable body 868 may comprise a compliant material to aid the sealing when the rotatable body 868 is in a second, closed configuration.

Turning to FIG. 37, the gearing arrangement 872, along with some other components, are shown in isolation of the casing and the gearbox housing.

As previously described, the gearing arrangement 872 comprises worm 914 and segmented gear 916. The socket 850 is also visible, along with the cap 906. The segmented gear 916 is so called because the gear 916 does not comprise a repeating pattern of gear teeth (e.g. 918) around its entire periphery. Instead, a non-toothed portion 922 of the circumference of the segmented gear 916 does not comprise any teeth (e.g. at least the portion schematically indicated as quadrant 920). At either end of the non-toothed portion 922, first and second end stops 924, 926 are defined. The end stops 924, 926 are so called because they define limits of rotational travel of the segmented gear 916. The first and second end stops 924, 926 also define flat, linear extents of an otherwise annular circumference of the non-toothed portion 922 of the segmented gear 916.

As will be appreciated from FIG. 37 in combination with FIGS. 38 and 39, the segmented gear 916 rotates up until the point where the first or second end stops 924, 926 engage a wall 889 of the gearbox housing 888. At this point, the first or second end stops 924, 926 foul on, i.e. cannot rotate past, the wall 889, which prevents further rotation of the segmented gear 916. This interaction between the end stops 924, 926 and the wall 889 therefore defines a rotational limit of travel of the segmented gear 916, and also the rotatable body to which the segmented gear 916 is rotatably coupled.

An extent of the circumference along which teeth are provided is labelled 928 in FIG. 37. An extent of the circumference along which teeth are not provided is labelled 930. Whilst the non-toothed portion 930 can rotate past the wall 889, the toothed portion 928 cannot. The schematic marker 930 may therefore be considered to define an extent of rotational travel about which the segmented gear 916 can undergo.

Owing to the end stops 924, 926 and the wall 889 of the gearbox housing 888, the segmented gear 916, and rotatable body, can only rotate through part of the axis 867 labelled in FIG. 36. The segmented gear 916 is therefore an example of a rotation limiting feature.

The end stops 924, 926, and non-toothed portion 922 more generally, are advantageous in being able to determine the rotational position of the segmented gear 916 and so the rotatable body (from the perspective of the driving motor 817 in FIG. 26). For example, a number of scenarios exist in which it is difficult to otherwise ascertain the rotational position of the rotatable body and segmented gear 916. An unexpected power outage, potentially partway through a rotation of the rotatable body, is one such example. Another scenario, for which more details will be provided later in this document, is where the sealing mechanism is removed from the rest of the print head for servicing. Removal of the sealing mechanism is likely to lead to the relative rotational position of the socket 850, with respect to the shaft 846, changing (e.g. whilst the socket 850 and shaft 846 are disconnected, or rotationally decoupled).

Owing to the incorporation of the end stops 924, 926, the segmented gear 916 can be driven, by the worm 914, up until a point where the end stops 924, 926 foul on the wall 889. By monitoring the motor control signals, a current spike (to name one example of a motor control signal) is observed by the motor when (one of) the end stops 924, 926 fouls on the wall 889. At this point it can be determined that the segmented gear 916, and so rotatable body, is at one extreme of rotation defined by the toothed portion 928 (e.g. between the end stops 924, 926). It can therefore be determined that the segmented gear 916 is at a rotational position which corresponds to one of the end stops 924, 926 engaging the wall 889. When this deduction is combined with the direction of rotation (e.g. whether the segmented gear 916 was being rotated in a clockwise, or counter clockwise, direction), it is possible to determine which of the end stops 924, 926 are in engagement with the wall 889. Accordingly, the rotational position of the segmented gear 916, and so rotatable body, can be determined. The arrangement may be described as an example of a position sensing arrangement. An encoder may be used to ascertain the rotational position between the rotational limits defined by the end stops 924, 926. The encoder may be provided proximate the motor 217.

In operation, the print head can therefore effectively re-sync the position of the rotatable body using the above method, even if the sealing mechanism is removed for servicing or if power is lost mid-rotation (e.g. two scenarios in which the rotational position of the rotatable body is otherwise unknown). The method can be described as calibrating the rotational position of the segmented gear, rotatable body and ultimately the motor itself. By incorporation of the end stops 924, 926, the use of microswitches to determine the rotational position of the gear 916 and/or rotatable body can be mitigated.

In another embodiment (e.g. a pulse count embodiment), an encoder may be rotationally coupled to the motor (e.g. the encoder may be integral with the motor). A number of pulses counted to achieve a full swing of the rotatable body (e.g. a full rotation of the segmented gear 916, as determined by the extent 930) between the open/closed configurations can therefore be established using the encoder. This advantageously allows the print head to cater for different abnormal conditions.

For a first abnormal condition, the rotatable body is partway through closing when a power failure occurs. When reactivated, the controller can step the segmented gear in one rotational direction to attempt to fully open (or close) the rotatable body until the first or second end stops 924, 926 of the segmented gear 916 engage the wall 889. This end of travel position can be ascertained based on the rotational position, determined by the encoder, at the point of power failure, and the difference between the known number of pulses to achieve the full ‘swing’ and the number of pulses corresponding to the rotational position at the point of power failure. The controller may then reverse the rotation direction to fully close (or open) the rotatable body (e.g. such that the other of the first and second end stops 924, 926 then engages the wall 889). At the end of this cycle the controller can establish it was able to rotate the rotatable body through a ‘full’ stroke, and know which state it is in e.g. the open or closed configurations.

In a second abnormal condition, if the controller is unable to see any movement of the rotatable body (e.g. using the encoder) (or is able to see some movement, but less than the full ‘stroke’ of movement) the controller will know that the rotatable body is stuck, or partially obstructed.

The pulse counting embodiment described above is advantageously a low cost way of establishing rotational position. However, monitoring the current signal may be included also as an alternative, backup method of establishing the motor is in an abnormal state and/or trying to drive against a back stop. Alternatively, monitoring the current signal may be used in isolation of the pulse counting embodiment described above.

It can be deduced that the motor is spinning (e.g. that the rotatable body is not ‘stuck’) by counting phase switchings on the motor and/or using a Hall Effect sensor to determine the rotational position of the motor. Counting phase switchings can otherwise be used to determine the rotational position of the motor, and so rotatable body. Counting phase switchings may be used in combination with counting pulses (e.g. to verify a correct rotational position). Alternatively, counting phase switchings may be used in isolation of pulse counting (and vice versa).

The combination of the segmented gear 916, worm 914 and gearbox housing may be referred to as a segmented gearbox, or segmented gearing arrangement. Although the end stops 924, 926 engage the wall 889 of the gearbox housing 888 in the illustrated embodiment, it will be appreciated that the end stops 924, 926 could engage with other features of the print head to limit rotation of the segmented gear 916.

Turning to FIG. 40, a perspective view of part of the print head 800 is provided. With reference to FIG. 25, in FIG. 40 the outer shell 812 and sealing cover 814 are omitted.

From the perspective of FIG. 40, two fasteners 932, 934 are visible. The fasteners 932, 934, along with a corresponding two fasteners on the other side of the chamber housing 822, extend through bores in the chamber housing 822 to releasably couple the sealing mechanism 824 to the chamber housing 822. Described another way, the fasteners 932, 934 extend through bores in the chamber housing 822 and the casing 870, and are received by threaded bores in the end cap 808. Securing the fasteners 932, 934 places the sealing mechanism 824 in engagement with the chamber housing 822 and compresses a gasket 940 therebetween. An interface is defined between the sealing mechanism 824 and the chamber housing 822 (e.g. at face 942 as shown in FIG. 43). The interface is generally labelled 941 in FIG. 40. The chamber housing 822 and components coupled thereto, optionally including the chassis 816, may be referred to as a housing assembly.

Turning to FIG. 41, a perspective view of the print head 800 is provided from a different perspective to that shown in FIG. 40. FIG. 41 thus shows the two other fasteners 936, 938 which are used, in conjunction with fasteners 932, 934 shown in FIG. 40, to releasably couple the sealing mechanism 824 to the chamber housing 822. FIG. 41 also shows the shaft 846, which extends through part of the chamber housing 822 to drive the rotatable body. The combination of the shaft 846 and the socket 850 can be described as providing a mechanical coupling which extends across the interface 941.

FIG. 41 also shows a gutter connector block 1022. The gutter connector block 1022 is coupled to the chamber housing 822. The gutter connection block 1022 works in the same way as the connector block labelled 852 in FIG. 28. The gutter connector block 1022, even when coupled to the chamber housing 822, facilitates removal of the sealing mechanism 824 (by virtue of the gutter connector block 1022 only being in sealing engagement with the sealing mechanism 824). Put another way, the sealing mechanism 824 can be urged away from the chamber housing 822 when (only) fasteners 932, 934, 936, 938 are removed. The gutter connection block 1022 defines a fluid pathway which extends across the interface 941. When the sealing mechanism 824 is decoupled from the chamber housing 822, the fluid pathway is separated, and the mechanical coupling is decoupled also, across the interface.

FIG. 42 shows part of the shaft 846 in isolation. The shaft 846 comprises the domed tip 848 at one end. Advantageously, the domed tip 848 provides a greater alignment tolerance when rotationally coupling the shaft 846 and the socket 850 (see FIG. 41) if the sealing mechanism 824 is removed and is then reattached (e.g. following servicing). Put another way, the incorporation of the domed tip 848 provides some axial play between the axes of rotation of the shaft 846 and the socket 850 which receives the shaft 846. Rotational coupling features, in the form of a hex pattern in the illustrated embodiment, are labelled 849 and surround the domed tip 848. It is by the rotational coupling features 849 that the shaft 846 is rotationally coupled to the socket 850 (e.g. the socket 850 comprising a corresponding internal profile to the outer profile of the shaft 846). Similarly, the same rotational coupling features extend along the extent of the shaft 846, and provide a rotational coupling between the shaft 846 and the driving motor (optionally via a gearbox). A narrowed neck 851 is also defined proximate the domed tip 848. Like the domed tip 848, the neck 851 provides a greater (axial) alignment tolerance between the shaft 846 and the socket 850.

Turning to FIG. 43, a perspective view of the print head 800 is provided with the sealing mechanism 824 removed.

From the perspective of FIG. 43 an end face 942 of the chamber housing 822 is visible. The gasket 940 is shown seated on the chamber housing 822. A gasket 944 is also shown seated in the end face 942. The gasket 944 extends around the chamber 856, specifically the first portion 856a defined by the chamber housing 822. Part of the high voltage electrode 840 is also visible in FIG. 43 (albeit within the chamber 856). The gutter 844 can also be seen in FIG. 43. The gutter 844 comprises a gutter aperture defined at an end of gutter line 946. As will be appreciated from FIG. 43, the gutter 844 remains in-situ, positioned relative to the chamber housing 822, even when the sealing mechanism has been removed. Advantageously, this means the alignment of the nozzle and charge electrode assembly, with respect to the gutter 844, is maintained even if the sealing mechanism is removed for maintenance.

FIG. 43 also shows the domed tip 848 of the shaft 846 exposed through an aperture 948 defined in the end face 942. Recess 950 is also defined in the end face 942 and is configured to receive the gearbox housing of the sealing mechanism (e.g. 888 in FIG. 31).

Turning to FIG. 44, a cross-section view of the print head 800 is provided about a plane 837 schematically labelled on FIG. 40. FIG. 44 is therefore a cross-section view taken just beyond the socket plate.

FIG. 44 is taken facing towards the gutter 844. FIG. 44 thus shows a line of sight of the gutter 844 through the chamber 856 from the perspective of where the combined nozzle and charge electrode assembly is installed. Advantageously, by providing a line of sight through the chamber 856, so that the gutter 844, specifically gutter aperture thereof, is visible, the combined charge electrode and nozzle assembly can be readily aligned with the gutter 844 despite the chamber 856 being an enclosed, or semi-enclosed, geometry. The jet of ink produced by the nozzle can therefore be aligned so that non-deflected ink is received by the gutter aperture.

For completeness, the cross-section view of FIG. 44 also shows the shaft 846 received in socket 850. Part of a (first) conduit 952, defined through the chamber housing 822, is also visible. The conduit 952 is provided in fluid communication with the first port of the chamber 856 (see first port 876 labelled on FIG. 29).

As well as the multiple worm gear driving arrangement described earlier in this document, other actuation mechanisms for rotating the rotatable body disclosed herein are also contemplated. Other options include a by bistable solenoid, a pneumatically actuated rotatable body by way of a diaphragm, and a rotary worm gear. Any mechanism which provides desirable mechanical advantage, to drive rotation of the rotatable body, may be used. Any of the above-listed drive options may be coupled to a lever or linkage to increase the mechanical advantage to the rotatable body.

As well as the rotary position sensing arrangement described in connection with FIG. 16, there are a variety of other ways of determining the position of the rotatable body. These fall broadly into the categories of magnetic, optical, pressure sensing and potentiometer. Magnetic sensors include magnetic rotary shafting encoders, hall effect sensors, reed switches and ferritic pickups. Optical options include an optical shaft encoder, an optical end stop, beam breakers and grey code encoders. The pressure sensing option may comprise pressure sensing the chamber itself. This is desirable for the reason that it can detect whether the seal or the mechanism has failed. A final option is an integral potentiometer.

Hydraulic connections (e.g. of conduits to adjacent components) may be by way of barbs. Barbs may be press-fitted into the component. An end of the conduit may be pushed over the barb. The conduits may be tubes, such as PTFE tubes.

The term ‘drawn’ encompasses fluid being sucked by a downstream pump (e.g. under a negative [gauge] pressure). References to a negative pressure throughout this document may specifically be to a negative gauge pressure. References to vacuum may not refer to an absolute vacuum per se, but a negative gauge pressure.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

1. A sealing mechanism for sealing a print head of a continuous inkjet printer, comprising:
a rotatable body rotatable about an axis of rotation between a first configuration and a second configuration; and
a casing defining an ink aperture;
wherein:
in the first configuration, an ink path is defined across the rotatable body through the ink aperture; and
in the second configuration, the rotatable body closes the ink aperture.

2. The sealing mechanism according to claim 1, wherein the rotatable body comprises a recess which, in the first configuration, overlaps the ink aperture to define the ink path.

3. The sealing mechanism according to claim 2, wherein the recess is a slot which extends through the rotatable body.

4. The sealing mechanism according to claim 1, wherein in the second configuration the rotatable body seals the ink aperture.

5. The sealing mechanism according to claim 1, wherein the rotatable body is generally cylindrical.

6. (canceled)

7. The sealing mechanism according to claim 1, wherein the casing comprises a polymer casing, the sealing mechanism further comprising a conductive end cap receivable over at least part of the casing, the conductive end cap defining an aperture which extends around the ink aperture; and
wherein the conductive end cap is grounded.

8. The sealing mechanism according to claim 1, wherein the ink aperture is an ink slot.

9. The sealing mechanism according to claim 1, further comprising a sealing collar.

10. The sealing mechanism according to claim 1, wherein the axis of rotation is generally perpendicular to the ink path.

11. The sealing mechanism according to claim 1, wherein the rotatable body is rotatably coupled to a gear.

12. The sealing mechanism according to claim 11, wherein the rotatable body is rotatably coupled to a segmented gear, the segmented gear comprising a non-toothed portion extending between first and second end stops.

13. The sealing mechanism according to claim 1, further comprising a rotation limiting feature.

14. The sealing mechanism according to claim 1, further comprising a sensor.

15. A print head for a continuous inkjet printer and configured for sealing, the print head comprising:
a chamber selectively sealable by a rotatable body rotatable about an axis of rotation between a first configuration and a second configuration;
a casing defining an ink aperture, the casing at least partly defining the chamber;
a nozzle for generating and ejecting a stream of ink droplets for printing;
at least one electrode for guiding the stream of ink droplets; and
a gutter for receiving droplets of ink which are not used for printing;
wherein
the at least one electrode is disposed in the chamber; and
in the first configuration, an ink path for the stream of droplets for printing is defined through the chamber, across the rotatable body and through the ink aperture such that the chamber is in communication with atmosphere via at least the ink aperture; and
in the second configuration the rotatable body closes the ink aperture such that the chamber is sealed by the rotatable body.

16. The print head according to claim 15, further comprising a motor in power communication with the rotatable body.

17. The print head according to claim 16, wherein the motor is disposed outside of the chamber.

18. (canceled)

19. The print head according to claim 16, wherein the motor is in power communication with the rotatable body via a shaft that extends along an extent of the chamber outside of the chamber.

20. (canceled)

21. The print head according to claim 15, wherein the rotatable body defines a downstream-most end of the ink path.

22. The print head according to claim 15, wherein the print head extends in a longitudinal direction which corresponds, at least in part, to a direction which the ink path extends in; and
wherein the axis of rotation is substantially perpendicular to the longitudinal direction.

23. (canceled)

24. A method of sealing a print head for a continuous inkjet printer, the method comprising:
rotating a rotatable body of a sealing mechanism of the print head from a first configuration, in which a chamber of the print head is in communication with atmosphere via at least an ink aperture, to a second configuration in which the chamber is sealed by the rotatable body.

25-39. (canceled)
